(19) United States
(12) Patent Application Publication
(10) Pub. No.: US 2026/0197142 A1
(43) Pub. Date: Jul. 9, 2026

(54) METHODS AND APPARATUS FOR ELASTIC CELL CONFIGURATION IN A MULTI-BAND OR HET-NET WIRELESS SYSTEM

(71) Applicant: Charter Communications Operating, LLC, St. Louis, MO (US)

(72) Inventor: Pareshkumar Panchal, Highlands Ranch, CO (US)

(21) Appl. No.: 19/011,050

(22) Filed: Jan. 6, 2025

(51) Int. Cl. H04L 5/00; H04L 5/14

(52) U.S. Cl. CPC H04L 5/0053; H04L 5/0007; H04L 5/14

(57) ABSTRACT

The present invention relates to methods and apparatus for implementing elastic cell configuration in a multi-band or heterogeneous-network wireless system. In an exemplary embodiment, wireless base station cell configurations are dynamically modified in a Time-Division Duplex wireless system in which a plurality of the wireless base stations have a first cell operating using a first frequency range and a second cell operating using a second frequency range, the cell coverage area of cells operating in the second frequency range do not overlap while the cell coverage areas of cells operating in the first frequency range do overlap. The cell configurations of the cells operating using the second frequency range being changed dynamically based on conditions at the base station to which the cell belongs. The cell configuration changes including changing the configuration of symbols per time slot of a frame as being designated for downlink usage or uplink usage.

### FIELD OF INVENTION

The present invention relates to methods and apparatus for implementing elastic cell configuration in a multi-band or heterogeneous-network (HET-NET) wireless system.

### BACKGROUND

In a wireless communications environment, depending on the network requirements and spectrum availability, each of the base stations of a system may have various bandwidth configurations along with different spectrum sizes (such as up to 100 MHz in Frequency Range 1 (FR1) (<6 GHz) and up to 400 MHz in Frequency Range 2 (FR2)(>6 GHz)). Sub-6 GHz frequencies (low/mid-band) have been classified as Frequency Range 1 (FR1) and frequencies higher than 24 GHz (mmWave) are classified as Frequency Range 2 (FR2). In the European Telecommunications Standards Institute (ETSI) Technical Specification entitled 5G; NR; User Equipment (UE) radio transmission and reception; Part 1: Range 1 Standalone (3GPP TS 38.101-1 version 17.5.0 Release 17) (2022-05) table 5.1-1 defines Frequency Range 1 (FR 1) as including the frequencies 410 MHz-7125 MHz and Frequency Range 2 (FR 2) as including frequencies from 24.25 GHz to 52.6 GHz. Most of the time additional carriers are deployed to cater more capacity than coverage where the coverage layer will be configured with lower frequencies while higher frequencies are configured for capacity layer.

In a time division duplex (TDD) environment, static cell configuration is typically implemented to avoid interference which means that the maximum supported data rate for uplink and downlink will be limited irrespective of user behavior or signaling interference or type of activity users are pursuing. Often such configuration (defined in the standards) do not deliver effective required data rate at the time of change in user behavior and/or changes in conditions at base stations and compromise the network spectral efficiency.

From the foregoing, it should be understood that there is a need for new and/or improved methods and apparatus for dynamically modifying and/or changing base station cell configurations to adapt to changing conditions at base stations and achieve greater network spectral efficiency. From the foregoing it should further be understood that there is a need for new and/or improved methods and apparatus to more effectively and efficiently utilize wireless resources (e.g., spectrum) so that additional capacity and services can be provided to wireless users. From the foregoing, it should further be understood that there is a need for new and/or improved methods and apparatus that solve the technological problem of how to more effectively and efficiently utilize wireless resources (e.g., spectrum) of networks by changing base station cell configurations of base stations without introducing signaling interference to other base stations operating in the network.

### SUMMARY OF THE INVENTION

The present invention provides new and/or improved methods and apparatus for dynamically modifying and/or changing base station cell configurations to adapt to changing conditions at base stations and achieve greater network spectral efficiency. Various embodiments of the present invention provide new and/or improved methods and apparatus to more effectively and efficiently utilize wireless resources (e.g., spectrum) so that additional capacity and services can be provided to wireless users. Various embodiments of the present invention provide new and/or improved methods and apparatus that solve the technological problem of how to more effectively and efficiently utilize wireless resources (e.g., spectrum) of networks by changing base station cell configurations of base stations without introducing signaling interference to other base stations operating in the network. Various embodiments of the present invention solve one or more of the problems discussed above.

The present invention relates to methods and apparatus for implementing elastic cell configuration in a multi-band, millimeter-wave, or heterogeneous-network wireless system. In an exemplary embodiment, wireless base station cell configurations are dynamically modified in a Time-Division Duplex wireless system in which a plurality of the wireless base stations have a first cell operating using a first frequency range (e.g., Frequency Range 1) and a second cell operating using a second frequency range (e.g., Frequency Range 2), the cell coverage area of cells operating in the second frequency range do not overlap while the cell coverage areas of cells operating in the first frequency range do overlap. The cell configurations of the cells operating using the second frequency range being changed dynamically based on conditions at the base station to which the cell belongs. The cell configuration changes including changing the configuration of symbols per time slot of a frame as being designated for downlink usage or uplink usage. The user equipment devices are dual frequency devices that can operate in both the first frequency range and the second frequency range and can switch between the two frequency ranges through cell handoff's during an active call or session. The configuration of a base station's cell using the second frequency range is dynamically modified to increase spectral efficiency and traffic capacity at the base station. In various embodiments, this is achieved via the symbols per time slot of a frame being configured or formatted to match the conditions at the base station. This re-configuration of the symbols per time slot of a frame for a base station cell operating using the second frequency range allows for the adjustment of the symbols per time slot of a frame to be assigned so as to optimize and/or improve the capacity and spectral efficiency of the base station. For example, when the conditions at the base station indicate a 71% to 29% ratio of downlink to uplink traffic demand the symbols per a time slot of a frame can be modified to accommodate or support these conditions with the ratio of symbols per a time slot being designated approximately 71% for downlink usage and approximately 29% for uplink usage (e.g., 10 symbols out of 14 symbols of a time slot designated for downlink usage and 4 symbols out of the 14 symbols of the time slot designated for uplink usage).

An exemplary method embodiment of the present invention includes the steps of: receiving downlink and uplink data traffic information for a first wireless base station, said first wireless base station being one of a plurality of wireless base stations of a Time Division Duplex (TDD) wireless network, said first wireless base station including: a first wireless cell operating using a first frequency spectrum range (e.g., FR 1 frequency spectrum range) and a second wireless cell operating using a second frequency spectrum range (e.g., FR 2 frequency spectrum range), said plurality of wireless base stations of the wireless network including a second wireless base station, said second wireless base station having a third wireless cell operating using the first frequency spectrum range (e.g., FR 1 frequency spectrum range) and a fourth wireless cell operating using the second frequency spectrum range (e.g., FR 2 frequency spectrum range), said first wireless cell of the first wireless base station having a first wireless cell coverage area overlapping with a third wireless cell coverage area of the third wireless cell of the second wireless base station, said second wireless cell of the first wireless base station having a second wireless cell coverage area which does not overlap with a fourth cell coverage area of the fourth wireless cell of the second wireless base station; and determining a first base station configuration for the second cell of the first wireless base station based on the received downlink and uplink traffic information for the first wireless base station, said first base station configuration including a first set of frame configuration parameters.

In some embodiments, the first set of frame configuration parameters define how many orthogonal frequency-division multiplexing (OFDM) symbols of a time slot of a frame are configured for downlink usage and how many OFDM symbols of the time slot of the frame are configured for uplink usage.

In some embodiments, the first set of frame configuration parameters define how many orthogonal frequency-division multiplexing (OFDM) symbols of a time slot of a frame are configured for downlink usage, how many OFDM symbols of the time slot of the frame are configured for uplink usage, and how many OFDM symbols of the time slot of the frame are configured for flexible usage.

In some embodiments, the first set of frame configuration parameters define how many orthogonal frequency-division multiplexing (OFDM) symbols of a time slot of a frame are configured for downlink usage and how many OFDM symbols of the time slot of the frame are configured for uplink usage; and the ratio of the number of OFDM symbols of the time slot defined for downlink usage to the number of OFDM symbols of the time slot defined for uplink usage is equal to a ratio of downlink data traffic to uplink data traffic included in the downlink and uplink traffic information for the first base station.

In some embodiments, the first set of frame configuration parameters define how many orthogonal frequency-division multiplexing (OFDM) symbols of a time slot of a frame are configured for downlink usage and how many OFDM symbols of the time slot of the frame are configured for uplink usage; and the ratio of the number of OFDM symbols of the time slot defined for downlink usage to the number of OFDM symbols of the time slot defined for uplink usage is within a threshold percentage (e.g., X %, where X is value such as 2, 5, or 10) of a ratio of downlink data traffic to uplink data traffic included in the downlink and uplink traffic information for the first base station.

In some embodiments, the method further includes the additional steps of: receiving downlink and uplink data traffic information for the second wireless base station; and determining a second base station configuration for the fourth cell of the second wireless base station based on the received downlink and uplink traffic information for the second wireless base station, said second base station configuration including a second set of frame configuration parameters, said second set of frame configuration parameters being different than said first set of frame configuration parameters. In some such embodiments, the second set of frame configuration parameters define how many OFDM symbols of a time slot of a frame are configured for downlink usage and how many OFDM symbols of the time slot of the frame are configured for uplink usage; and the number of OFDM symbols defined for uplink usage in a time slot for the second set of frame configuration parameters is different than the number of OFDM symbols defined for uplink usage in a time slot for the first set of frame configuration parameters.

In some embodiments, the step of determining a first base station configuration for the second cell of the first wireless base station based on the received downlink and uplink traffic information includes: determining an estimated downlink traffic demand for the first wireless base station based on the received downlink and uplink traffic information for the first wireless base station; determining an estimated uplink traffic demand for the first wireless base station based on the received downlink and uplink traffic information for the first wireless base station; determining how many OFDM symbols of the time slot of the frame are to be configured for uplink usage based on the estimated uplink traffic demand for the first wireless base station; and determining how many OFDM symbols of the time slot of the frame are to be configured for downlink usage based on the estimated downlink traffic demand for the first wireless base station.

In some embodiments, the configuration of the second cell of the first wireless base station is dynamically updated based on: (i) received downlink and uplink data traffic information for the first base station for a second time interval, (ii) received signal strength coverage information for the first wireless base station for the second time interval, and (iii) received signal interference information for the first wireless base station for the second time interval.

In some embodiments, the second set of frame configuration parameters define how many OFDM symbols of a time slot of a frame are configured for downlink usage and how many OFDM symbols of the time slot of the frame are configured for uplink usage; and the number of OFDM symbols defined for downlink usage in a time slot for the second set of frame configuration parameters is different than the number of OFDM symbols defined for downlink usage in a time slot for the first set of frame configuration parameters.

In some embodiments, the step of determining a first base station configuration for the second cell of the first wireless base station based on the received downlink and uplink data traffic information for the first wireless base station includes: determining a first symbols per time slot format for time slots of frames used for wireless communications by the second cell of the first wireless base station; and the first symbols per time slot format is different than a second symbols per time slot format used by the fourth cell of the second wireless base station.

In some embodiments, the first cell of the first base station and the third cell of the second base station utilize a third symbols per time slot format. In some such embodiments, the third symbols per time slot format is different than the first symbols per time slot format; and the third symbols per time slot format is different than the second symbols per time slot format.

In some embodiments, each of the plurality of wireless base stations of the TDD wireless network include at least one wireless cell operating using the first frequency range, each of said wireless cells of the TDD wireless network utilizing a symbols per time slot format for time slots of frames which is the same; and two or more of the wireless base stations of the TDD wireless network include at least one wireless cell operating using the second frequency range, said wireless cells operating using the second frequency range having non-overlapping cell coverage.

In some embodiments, the method further includes the additional steps of determining a set of frame format base station configuration profiles, said set of frame format base station configuration profiles including a plurality of different frame format base station configuration profiles, each of said frame format base station configuration profiles having a different symbols per time slot uplink and downlink configuration; and determining which frame format base station configuration profile to utilize for each of the wireless cells of the wireless network operating using the second frequency range based on conditions at the wireless base station of the wireless cell operating in the second frequency range. In some such embodiments, the conditions at the wireless base station of the wireless cell operating in the second frequency range include: (i) determined or estimated downlink and uplink data traffic demand at the wireless base station, (ii) base station signal strength coverage levels, and (iii) base station signal interference levels.

The present invention is also applicable to apparatus and system embodiments wherein one or more devices implement the steps of the method embodiments. In some apparatus embodiments each of the wireless base station, user equipment devices, network equipment devices, Operations Support Systems, base station configuration management system, network monitoring server, demand data calculator server, configuration estimator server, user locations server, coverage and interference server, network instructor server, and configuration management server and each of the other apparatus/devices/nodes/servers of the system include one or more processors and/or hardware circuitry, input/output interfaces including receivers and transmitters, and a memory. The memory including instructions which when executed by one or more of the processors control the apparatus/device/node/server of the system to operate to perform the steps and/or functions of various method embodiments of the invention.

An exemplary base station configuration management system in accordance with one embodiment of the present invention includes: memory; and a first processor that controls the base station configuration management system to perform the following operations: receiving downlink and uplink data traffic information for a first wireless base station, said first wireless base station being one of a plurality of wireless base stations of a Time Division Duplex (TDD) wireless network, said first wireless base station including: a first wireless cell operating using a first frequency spectrum range (e.g., FR 1 frequency spectrum range) and a second wireless cell operating using a second frequency spectrum range (e.g., FR 2 frequency spectrum range), said plurality of wireless base stations of the wireless network including a second wireless base station, said second wireless base station having a third wireless cell operating using the first frequency spectrum range (e.g., FR 1 frequency spectrum range and a fourth wireless cell operating using the second frequency spectrum range (e.g., FR 2 frequency spectrum range, said first wireless cell of the first wireless base station having a first wireless cell coverage area overlapping with a third wireless cell coverage area of the third wireless cell of the second wireless base station, said second wireless cell of the first wireless base station having a second wireless cell coverage area which does not overlap with a fourth cell coverage area of the fourth wireless cell of the second wireless base station; and determining a first base station configuration for the second cell of the first wireless base station based on the received downlink and uplink data traffic information for the first wireless base station, said first base station configuration including a first set of frame configuration parameters.

While various embodiments have been discussed in the summary above, it should be appreciated that not necessarily all embodiments include the same features and some of the features described above are not necessary but can be desirable in some embodiments. Numerous additional features, embodiments and benefits of various embodiments are discussed in the detailed description which follows.

### BRIEF DESCRIPTION OF THE DRAWINGS

FIG. 1 illustrates an exemplary system in accordance with an embodiment of the present invention.

FIG. 2 illustrates a table showing 5G New Radio (NR) frame configuration information.

FIG. 3 illustrates a table showing 5G NR subcarrier spacing (SCS) configuration and slot duration information.

FIG. 4 illustrates a table showing exemplary slot formats and the corresponding configuration of each of the symbols.

FIG. 5 illustrates an exemplary 5G NR frame, subframe and slot configuration in accordance with an embodiment of the present invention.

FIG. 6 illustrates exemplary mapping of demand traffic estimated bins for a base station coverage area in accordance with an exemplary embodiment of the invention.

FIG. 7 illustrates an exemplary table 700 containing information monitored and collected from the base stations and user equipment devices of a wireless system in accordance with an embodiment of the present invention.

FIG. 8 illustrates two exemplary tables which provide exemplary signal strength measurements for the coverage area of two different base stations, each table providing information for a single base station in accordance with an embodiment of the present invention.

FIG. 9 illustrates an exemplary plot of the measured signal strength coverage distribution for a wireless system on a per base station basis in accordance with an embodiment of the present invention.

FIG. 10 illustrates two exemplary tables which provide exemplary signal interference measurements within the coverage area of two base stations, each table providing information for a different base station in accordance with an embodiment of the present invention.

FIG. 11 illustrates an exemplary plot of the measured interference (SINR) distribution for a wireless system on a per base station basis in accordance with an embodiment of the present invention.

FIG. 12 illustrates an exemplary table which contains information for allocating or determining a base station's FR 2 downlink/uplink configuration profile from a set of four different FR 2 downlink/uplink configuration profiles based on the conditions being experienced at the base station in accordance with an embodiment of the present invention.

FIG. 13 illustrates a network overview of wireless system base stations different FR2 cell configuration profiles which were determined based on downlink/uplink traffic demand, signal interference levels, and signal strength coverage patterns determined for each of the base stations in accordance with an embodiment of the present invention.

FIG. 14 illustrates details of an exemplary wireless base station in accordance with an embodiment of the present invention.

FIG. 15 illustrates details of an exemplary Dual Frequency (equipped to operate using two different frequency ranges (e.g., FR 1 and FR 2)) User Equipment (UE) device, e.g., a mobile device, cell phone, smartphone, wireless tablet, laptop, wireless notebook, in accordance with an embodiment of the present invention.

FIG. 16 illustrates details of an exemplary network equipment node/device/system/server (e.g., Operations Support System, network monitoring server, demand data calculator server, user locations server, coverage and interference review server, configuration estimator server, network instructor server, configuration management server) in accordance with one embodiment of the present invention.

FIG. 17 illustrates an exemplary assembly of components for a wireless base station in accordance with an embodiment of the present invention.

FIG. 18 illustrates an exemplary assembly of components for a user equipment device in accordance with an embodiment of the present invention.

FIG. 19 illustrates an exemplary assembly of components for a network equipment node/device/system/server in accordance with an embodiment of the present invention.

FIG. 20 illustrates an exemplary table which contains information for allocating or determining a base station's FR 2 downlink/uplink configuration profile from a set of four different FR 2 downlink/uplink configuration profiles based on the conditions being experienced at the base station in accordance with an embodiment of the present invention.

FIG. 21 illustrates an exemplary table which contains information for allocating or determining a base station's FR 2 downlink/uplink configuration profile from a set of four different FR 2 downlink/uplink configuration profiles based on the conditions being experienced at the base station in accordance with an embodiment of the present invention.

FIG. 22 comprises FIG. 22A, FIG. 22B, and FIG. 22C.

FIG. 22A is the first part of an exemplary method in accordance with an embodiment of the present invention.

FIG. 22B is the second part of an exemplary method in accordance with an embodiment of the present invention.

FIG. 22C is the third part of an exemplary method in accordance with an embodiment of the present invention.

FIG. 23 comprises FIG. 23A, FIG. 23B, FIG. 23C, and FIG. 23D.

FIG. 23A is the first part of an exemplary method in accordance with an embodiment of the present invention.

FIG. 23B is the second part of an exemplary method in accordance with an embodiment of the present invention.

FIG. 23C is the third part of an exemplary method in accordance with an embodiment of the present invention.

FIG. 23D is the fourth part of an exemplary method in accordance with an embodiment of the present invention.

FIG. 24 illustrates a table of exemplary symbols per slot downlink/uplink configuration profiles for use with a system that uses 14 symbols per time slot.

### DETAILED DESCRIPTION

Various embodiments of the present invention are applicable to multi-band or heterogeneous-network (HET-NET) wireless systems using a first frequency band in the Frequency Range 1 (FR 1) which includes the frequencies 410 MHz-7125 MHz and a second frequency band in Frequency Range 2 (FR 2) which includes frequencies from 24.25 GHz to 52.6 GHz sometimes referred to as mmWave spectrum range.

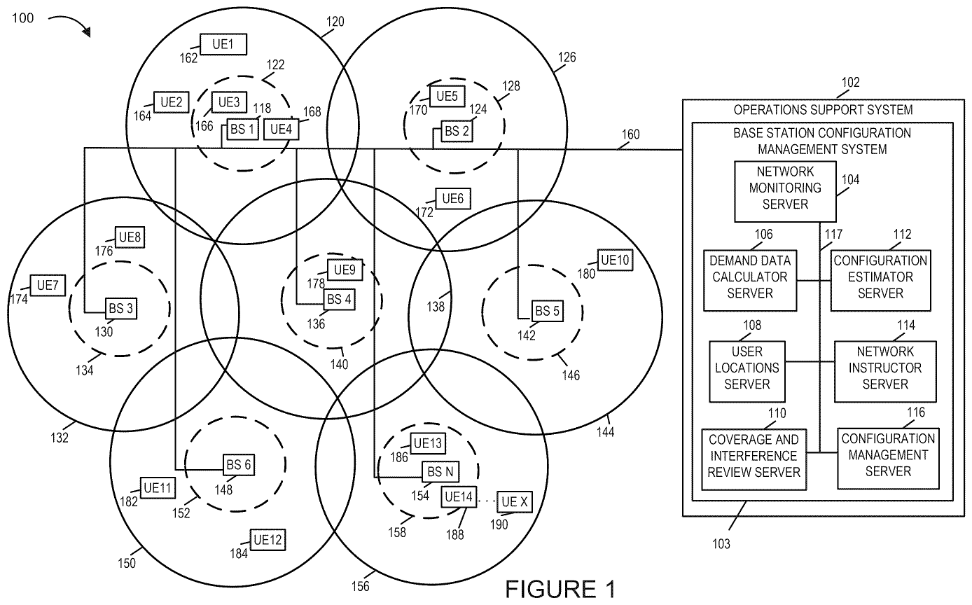

FIG. 1 illustrates elements of a wireless system 100 in accordance with an embodiment of the present invention. System 100 includes an operations support system 102, a plurality of wireless base stations (i.e., BS 1 118, BS 2 124, BS 3 130, BS 4 136, BS 5 142, BS 6 148, . . . , BS N 154 (N being an integer greater than 6), and a plurality of wireless devices (i.e. UE 1 162, UE 2 164, UE 3 166, UE 4 168, UE 5 170, UE 6, 172, UE 7, 174, UE 8 176, UE 9 178, UE 10 180, UE 11 182, UE 12 184, UE 13 186, UE 14 188, . . . , UE X 190, X being an integer greater than 14). The base stations (i.e., BS 1 118, BS 2 124, BS 3 130, BS 4 136, BS 5 142, BS 6 148, . . . , BS N 154) are connected and/or coupled to the operations support system 102 via communications link 160. While a single communications link 160 is shown, other network configurations can be implemented such as using a plurality of different communications links to connect and/or couple the wireless base stations to the operations support system 102. In some embodiments, each wireless base station is connected to the operations support system via a separate communications link. The communications link 160 is typically a wire cable or a fiber communications link which provide high speed communications between the base stations and the operations support system 102 though in some embodiments it is a wireless communications link. In some embodiments, such as where a plurality of different communications links are used to connect the wireless base stations of the system 100 to the operations support system 102, one or more of the plurality of different communications links are of different types (e.g., wire cable type, fiber cable type, wireless type, etc.). In some embodiments, a base station may be connected to the operations support system via multiple communications links which may be, and in some embodiments, are of different types. In some embodiments, the communications link 160 is a communications network comprising a plurality of communications link which may be of different types such as for example, wired cable type, fiber optic cable type, wireless type of communications link.

The operations support system 102 includes a base station configuration management system 103. The base station configuration management system 103 includes a network monitoring server 104, a demand data calculator server 106, a user locations server 108, a coverage and interference review server 110, a configuration estimator server 112, a network instructor server 114 and a configuration management server 116 which are coupled together via communications link 117 which allows them to share information, instructions, and data. In some embodiments, the operations support system (OSS) 102 and/or the base station configuration management system 103 is implemented in a cloud system or environment.

The wireless devices UE 1 162, UE 2 164, UE 3 166, UE 4 168, UE 5 170, UE 6 172, UE 7 174, UE 8 176, UE 9 178, UE 10 180, UE 11 182, UE 12 184, UE 13 186, UE 14 188, . . . , UE X 190 are coupled and/or connected to the wireless base stations of the system 100 via wireless communications links.

Base stations of the system 100 (e.g., BS 1 118, BS 2 124, BS 3 130, BS 4 136, BS 5 142, BS 6 148, . . . , BS N 154) have various bandwidth configurations along with different spectrum sizes (such as up to 100 MHz in Frequency Range 1 (FR1) and up to 400 MHz in Frequency Range 2 (FR2). Sub-6 GHz frequencies (low/mid-band) have been classified as Frequency Range 1 (FR1) and frequencies higher than 24 GHz (mmWave) are classified as Frequency Range 2 (FR2). Frequency Range 2 (FR 2) includes frequency bands from 24.25 GHz to 52.6 GHz. In this example, the base stations of system 1 supported two different bandwidths which comprise a coverage layer and a capacity layer. The base stations of the system 100 are configured to provide: (i) a coverage layer with lower frequencies in the Frequency Range 1 (FR 1) and (ii) a capacity layer using higher frequencies of Frequency Range 2 (FR 2). Each of the wireless base stations have two cells, a first cell also referred to as a primary cell operating using bandwidth in the Frequency Range 1 and a second cell also referred to as a secondary cell operating using bandwidth in the Frequency Range 2. While the base stations of system 100 are illustrated as having two cells each this is only exemplary and the base stations may additional cells operating in the FR 1 range and FR 2 range. The cells of a base station operating in the FR 2 range do not have coverage areas which overlap with other base stations cells of the system also operating in the FR 2 range. Additional FR 1 cells of a base station can and typically do have cell coverage areas which overlap with neighboring base station FR 1 cell coverage areas.

Wireless base station BS 1 118 has an FR 1 coverage area 120 and an FR 2 coverage area 122. Wireless base station BS 2 124 has an FR 1 coverage area 126 and a FR 2 coverage area 128. Wireless base station BS 3 130 has an FR 1 coverage area 132 and a FR 2 coverage area 134. Wireless base station BS 4 136 has an FR 1 coverage area 138 and a FR 2 coverage area 140. Wireless base station BS 5 142 has an FR 1 coverage area 144 and a FR 2 coverage area 146. Wireless base station BS 6 148 has an FR 1 coverage area 150 and a FR 2 coverage area 152. Wireless base station BS N 154 has an FR 1 coverage area 156 and a FR 2 coverage area 158.

System 100 is a time division duplex system. The configuration of base station carrier bandwidth adjustment for the FR 2 layer of the system 100 may be, and in some embodiments is, based on one or more of the following user activity, user behavior, use case, events, interference, demand and time of occurrence while the FR 1 layer will in many but not all embodiments have a static (ubiquitous) TDD configuration. In each specific frequency band (FR 1 and FR2), supported bandwidth, carrier frequency and aggregation of bandwidth may be, and in some embodiments, is implemented in accordance with defined industry standards such as the 5G New Radio standards including the 5G-NR 3GPP TS 38.213 V18.0.0 specification.

As per given slot formats for normal cyclic prefix, total 0-255, specific formats can be selected and/or configured on a per use case (for example Enhanced Mobile Broadband—Downlink (eMBB-DL), Enhanced Mobile Broadband-Uplink (eMBB-UL), Enhanced Mobile Broadband-Downlink-Upllink (eMBB-DL-UL, Enhanced Mobile Broadband-Downlink Only (eMBB-DLOnly), Enhanced Mobile Broadband-Uplink Only (eMBB-ULOnly), etc.) From a given supported slot format configuration, each slot can be either D-Downlink, U-Uplink, F-Flexible). While for various use cases, the slot format can be configured using given or pre-defined configuration settings. In 5G-New Radio (NR), bandwidth configuration can be in terms of slot format (time based), in TDD often the same frequency is divided among time slots. So at a specific time, a device can either operate to provide Uplink (UL) transmission or Downlink (DL) transmission but not both (unlike Frequency Division Duplexing (FDD)).

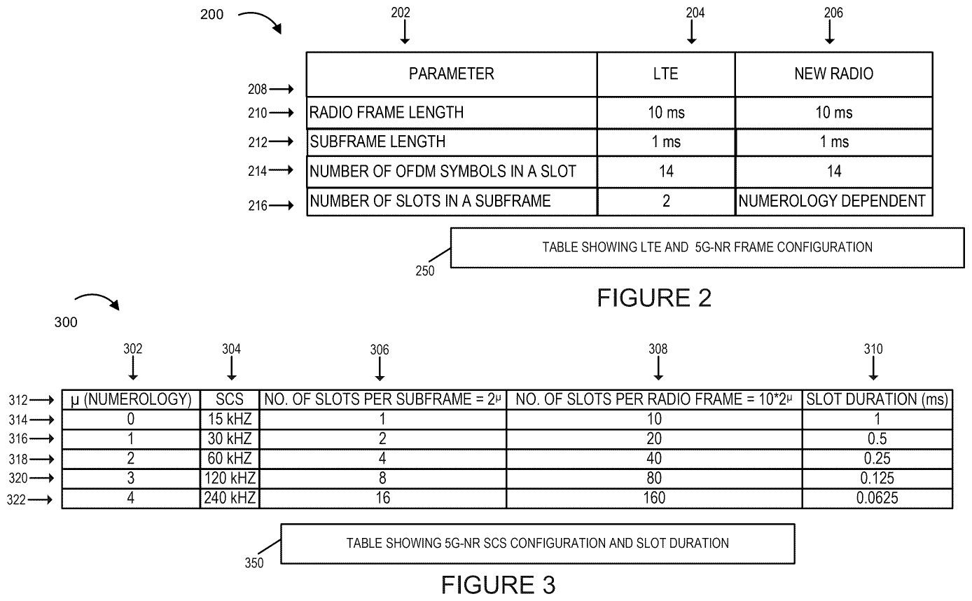

Timeslots and configurations for an exemplary 5G-NR cell/base station will now be discussed. FIG. 2 illustrates a table 200 showing LTE and 5G-NR Frame Configuration as described in the legend 250. Table 200 includes columns 202, 204, and 206 and rows 208, 210, 212, 214 and 216. The entries in row 208 are labels indicating the information contained in each column. Entries in column 202 identify the cell/base station configuration parameter (row 208, column 202 entry). The entries in column 204 are the LTE (row 208, column 204 entry) frame configuration values for the configuration parameter in the same row. The entries in column 206 are the New Radio (row 208, column 206 entry) frame configuration values for the configuration parameter in the same row. Entries in row 210 correspond to the Radio Frame Length configuration parameter (row 210, column 202 entry). The Radio Frame Length for LTE is 10 milliseconds (ms) (row 210, column 204 entry) and the Radio Frame Length for NR is 10 ms (row 210, column 206). Entries in row 212 correspond to the Subframe Length configuration parameter (row 212, column 202 entry). The Subframe Length for LTE is 1 ms (row 212, column 204 entry) and the Subframe Length for NR is 1 ms (row 212, column 206). Entries in row 214 correspond to the Number of Orthogonal Frequency-Division Multiplexing (OFDM) symbols in a slot configuration parameter (row 214, column 202 entry). The number of OFDM symbols in a slot for LTE is 14 (row 214, column 204 entry) and the number of OFDM symbols in a slot for NR is 14 (row 214, column 206). Entries in row 216 correspond to the Number of Slots in a Subframe configuration parameter (row 216, column 202 entry). The Number of Slots in a Subframe for LTE is 2 (row 216, column 204 entry) and the Number of Slots in a Subframe for NR is numerology dependent (row 216, column 206).

One radio frame is 10 ms with 10 subframes of 1 ms each. Each subframe has 1 or more slots as per the defined numbers in table 300 illustrated in FIG. 3. FIG. 3 illustrates a table 300 showing 5G-NR Subcarrier Spacing (SCS) Configuration and Slot Duration as indicated in table 3 legend 350. Table 300 includes columns 302, 304, 306, 308, 310 and rows 312, 314, 316, 318, 320, 322. The entries in row 312 are labels indicating the information contained in each column. Entries in column 302 identify a μ (numerology) (row 312, column 302 entry). Numerology refers to a physical waveform's characteristics in terms of subcarrier spacing and corresponding time domain length. The entries in column 304 are Subcarrier Spacing (SCS) (row 312, column 304 entry) value for the numerology identified in the same row. The entries in column 306 are the number of slots per subframe=2^{μ}(row 312, column 306 entry) for the numerology identified in the same row. Entries in column 308 are the number of slots per radio frame=20*2^{u} (row 312, column 308 entry) for the numerology identified in the same row. The entries in column 310 are the slot duration in milliseconds (row 312, column 310 entry) for the numerology identified in the same row. The table 300 contains information for the following numerologies: 0 (information in row 314), 1 (information in row 316), 2 (information in row 318), numerology 3 (information in row 320), and numerology 4 (information in row 322). From table 3 row 314, numerology 0 (entry row 314, column 302) has a Subscarrier spacing (SCS) of 15 kiloHertz (kHz) (entry row 314, column 304), with a number of slots per subframe of 1 (entry row 314, column 306), number of slots per radio frame of 10 (entry row 314, column 308), and a slot duration of 1 ms (entry row 314, column 310). From table 3 row 316, numerology 1 (entry row 316, column 302) has a Subscarrier spacing (SCS) of 30 kiloHertz (kHz) (entry row 316, column 304), with a number of slots per subframe of 2 (entry row 316, column 306), number of slots per radio frame of 20 (entry row 316, column 308), and a slot duration of 0.5 ms (entry row 316, column 310). From table 3 row 318, numerology 2 (entry row 318, column 302) has a Subscarrier spacing (SCS) of 60 kiloHertz (kHz) (entry row 318, column 304), with a number of slots per subframe of 4 (entry row 318, column 306), number of slots per radio frame of 40 (entry row 318, column 308), and a slot duration of 0.25 ms (entry row 318, column 310). From table 3 row 320, numerology 3 (entry row 320, column 302) has a Subscarrier spacing (SCS) of 120 kiloHertz (kHz) (entry row 320, column 304), with a number of slots per subframe of 8 (entry row 320, column 306), number of slots per radio frame of 80 (entry row 320, column 308), and a slot duration of 0.125 ms (entry row 320, column 310). From table 3 row 322, numerology 4 (entry row 322, column 302) has a Subscarrier spacing (SCS) of 240 kiloHertz (kHz) (entry row 322, column 304), with a number of slots per subframe of 16 (entry row 322, column 306), number of slots per radio frame of 160 (entry row 322, column 308), and a slot duration of 0.0625 ms (entry row 322, column 310).

In this example, the focus is on the calculation for the cell/base station's capacity layer. With the cell/base station FR2 frequency (e.g., 37GHz) layer being configured as the capacity layer. For numerology 2 (60 KHz SCS), 4 slots per subframe can be configured with each slot having 14 OFDM symbols. Each of these symbols can be configured as Downlink, Uplink, or Flexible. A flexible symbol can be configured for either uplink or downlink transmission. Configuring these symbols can widely impact the supported data rate capability of the cell carrier.

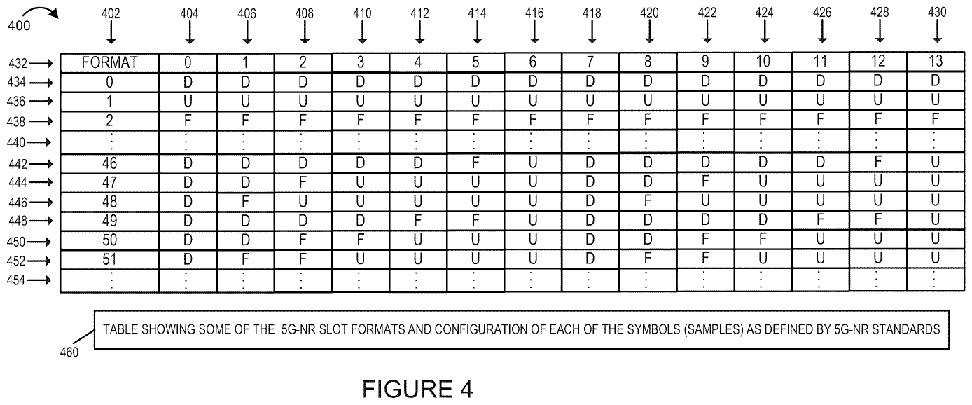

FIG. 4 illustrates table 400 which shows some of the 5G-NR slot formats for normal cyclic prefix and configurations of each of the 14 OFDM symbols (samples) in a time slot as defined by Table 11.1.1-1 of the 5G-NR 3GPP TS 38.213 V18.0.0 specification. The 5G-NR 3GPP TS 38.213 V18.0.0 entitled, “3rd Generation Partnership Project; Technical Specification Group Radio Access Network; NR; Physical layer procedures for control (Release 18)” dated September 2023 is incorporated herein by reference in its entirety. Table 400 includes columns 402, 404, 406, 408, 410, 412, 414, 416, 418, 420, 422, 424, 426, 428, 430 and rows 432, 434, 436, 438, 440, 442, 444, 446, 448, 450, 452, 454.

The entries in row 432 are labels indicating the information contained in each column. Entries in column 402 identify a format (row 432, column 402 entry) to which the symbol entries in the same row applies. Entries in column 404 identify the configuration of OFDM symbol 0 (row 432, column 404 entry). Entries in column 406 identify the configuration of OFDM symbol 1 (row 432, column 406 entry). Entries in column 408 identify the configuration of OFDM symbol 2 (row 432, column 408 entry). Entries in column 410 identify the configuration of OFDM symbol 3 (row 432, column 410 entry). Entries in column 412 identify the configuration of OFDM symbol 4 (row 432, column 412 entry). Entries in column 414 identify the configuration of OFDM symbol 5 (row 432, column 414 entry). Entries in column 416 identify the configuration of OFDM symbol 6 (row 432, column 416 entry). Entries in column 418 identify the configuration of OFDM symbol 7 (row 432, column 418 entry). Entries in column 420 identify the configuration of OFDM symbol 9 (row 432, column 420 entry). Entries in column 422 identify the configuration of OFDM symbol 9 (row 432, column 422 entry). Entries in column 424 identify the configuration of OFDM symbol 10 (row 432, column 424 entry). Entries in column 426 identify the configuration of OFDM symbol 11 (row 432, column 426 entry). Entries in column 428 identify the configuration of OFDM symbol 12 (row 432, column 428 entry). Entries in column 430 identify the configuration of OFDM symbol 13 (row 432, column 430 entry). Each of the 14 OFDM symbols 0, 1, 2, 3, 4, 5, 6, 7, 8, 9, 10, 11, 12, and 13 are defined as “D” for downlink usage, “U” for uplink usage, or “F” flexible uplink or downlink usage on a per format basis. Table 400 shows the designations for each of the 14 symbols of format 0 in row 434, format 1 in row 436, format 2 in row 438, format 46 in row 442, format 47 in row 444, format 48 in row 446, format 49 in row 448, format 50 in row 450, format 51 in row 452. The “. . . ” in rows 440 and 454 indicate that additional rows with additional information is contained in the table. In full table entries can be found in table 11.1.1-1 of the 5G-NR 3GPP TS 38.213 V18.0.0 specification. In this table formats 56-244 are marked as served. However, in connection with some embodiment of the present invention, these reserved formats are defined by the base station configuration management system or a system operator to match base station conditions including traffic load conditions for uplink or downlink or both. The symbol configuration is customized and defined in the format. For example, a format 56 which is currently reserved can be defined for a 50/50 downlink/uplink traffic demand profile where symbols 0, 1, 2, 3, 4, 6, 9 are configured D for downlink and 5, 7, 8, 10, 11, 12 and 13 are configured U for uplink traffic.

An example of how to read table 400 will now be provided. Row 442 includes the symbol configurations for format 46 (row 442, column 402 entry). Format 46 has the following symbol configurations: symbol 0 is D for downlink usage (row 442, column 404), symbol 1 is D for downlink usage (row 442, column 406), symbol 2 is D for downlink usage (row 442, column 408), symbol 3 is D for downlink usage (row 442, column 410), symbol 4 is D for downlink usage (row 442, column 412), symbol 5 is F for flexible usage (row 442, column 414), symbol 6 is U for uplink usage (row 442, column 416), symbol 7 is D for downlink usage (row 442, column 418), symbol 8 is D for downlink usage (row 442, column 420), symbol 9 is D for downlink usage (row 442, column 422), symbol 10 is D for downlink usage (row 442, column 424), symbol 11 is D for downlink usage (row 442, column 426), symbol 12 is F for flexible usage (row 442, column 428), symbol 13 is U for uplink usage (row 442, column 430).

In this exemplary use case, configuring all 14 symbols within a slot as “D” (downlink only) as shown in format 0 of table 400, can provide 100% downlink (DL) data rate at maximum capacity for the slot. If all 14 symbols within the slot are configured as “U” (uplink only) as shown as format 1 in table 400, it will provide an Uplink (UL) data rate for the slot at maximum capacity. If 7 symbols of a slot are configured as “D” and 7 symbols are configured as “U” for each of the slots, it will provide 50% downlink capacity and 50% uplink capacity for the slot from the maximum data rate for the slot as per the bandwidth configuration since the time is divided between UL (Uplink) and DL (downlink). When all 14 symbols of all slots of a frame are configured as downlink it will provide downlink data rate at the maximum capacity for the frame. When all 14 symbols of all slots of a frame are configured as uplink it will provide uplink data rate at maximum uplink capacity for the frame. When 7 symbols of every slot of a frame are configured as “D” and 7 symbols of every slot of frame are configured as “U” for each of the slots of the frame, it will provide 50% downlink capacity and 50% uplink capacity for the frame from the maximum data rate for the frame as per the bandwidth configuration since the time is divided between UL (Uplink) and DL (downlink).

When a cell/base station is not configured with the appropriate and/or proper settings for the symbols as per the data rate required to support offered service(s), user(s) and/or user equipment device(s) will experience throttled capacity in connection with the offered services as there is not enough uplink or downlink capacity available to support the offered service(s). Also, it should be noted that the requirement for uplink and/or downlink capacity is variable and keeps changing as a function of time (e.g., throughout the day, day of the week, week of the month, month of the year).

Maximum capacity can be defined as maximum bits/symbol which can be transmitted per second for a given radio condition. The maximum capacity depends on modulation rate such as Quadrature Phase Shift Keying (QPSK) (2 bits/symbol), 16 Quadrature Amplitude Modulation (QAM) (4 bits/symbol), 64 QAM (6 bits/symbol), 256 QAM (8 bits/symbol) and so on. The modulation rate depends on the interference environment of the wireless network. The lower the interference, the higher the modulation rate and effectively the higher the channel capacity.

The total number of symbols is derived based on bandwidth size, subcarrier spacing, frequency type (FR1 or FR2), etc. For example: 37 GHz (FR2) carrier with 100 MHz bandwidth calculation is provided below.

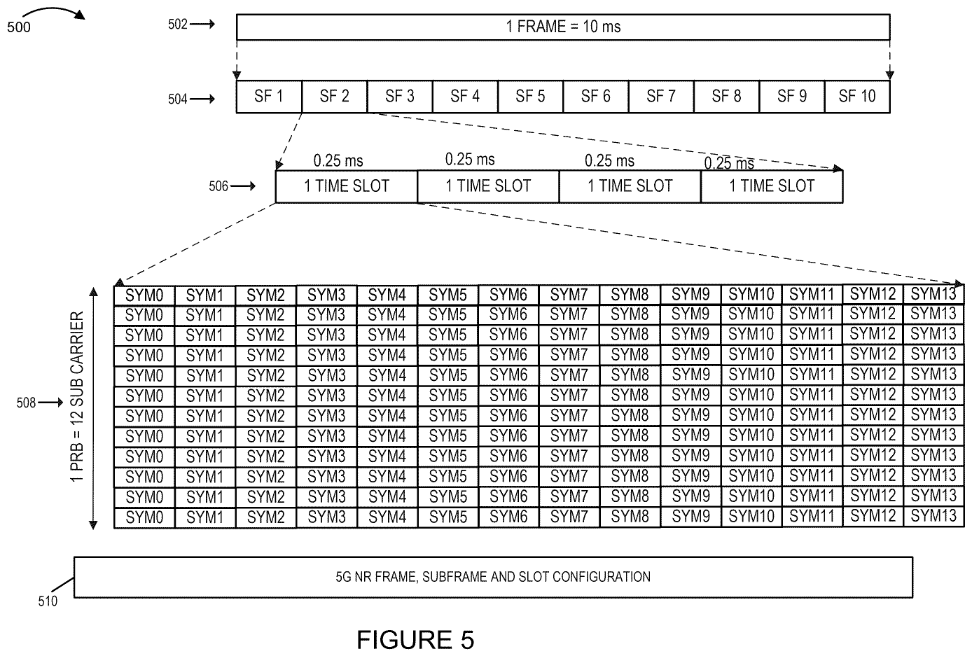

As per the specifications in 5G standards as discussed above, 1 frame will have 10 subframes of 1 ms each. For a given 37 GHz (FR2), 100 MHz bandwidth with 60 KHz subcarrier spacing (SCS) it will have 4 slots with each of the 4 slots having a 0.25 ms duration. Each slot will have 14 OFDM symbols per subcarrier. With 1 Physical Resource Block (PRB) having 12 subcarriers. FIG. 5 diagram 500 illustrates elements of the 5G NR frame, subframe and slot configuration discussed above. 1 Frame 502 has a duration of 10 ms. This frame includes 10 subframes (SF 1, SF 2, SF 3, SF 4, SF 5, SF 6, SF 7, SF 8, SF 9, SF 10) 504. Each of the 10 subframes has 4 time slots with each time slot having a duration of 0.25 ms. By way of example, the 4 time slots of subframe SF 2 506 are each shown as having a duration 0.25 ms. Each of the time slots of each of the 10 subframes has 14 OFDM symbols per subcarrier with 1 PRB having 12 subcarriers. For example, PRB 508 which corresponds to the first time slot of the SF 1 504 has 12 subcarriers each of the 12 subcarriers being shown as a separate row of PRB 508, with each subcarrier having 14 OFDM symbols (Symbol 0 (SYM0), Symbol 1 (SYM1), Symbol 2 (SYM2), Symbol 3 (SYM3), Symbol 4 (SYM4), Symbol 5 (SYM5), Symbol 6 (SYM6), Symbol 7 (SYM7), Symbol 8 (SYM8), Symbol 9 (SYM9), Symbol 10 (SYM10), Symbol 11 (SYM11), Symbol 12 (SYM12), Symbol 13 (SYM13)). Each of the other time slots of the SF 2 have 1 PRB with 12 subcarriers and 14 OFDM symbols. Legend 510 indicates that FIG. 5 illustrates an exemplary 5g NR Frame, subframe and slot configuration.

In this Bandwidth, the total number of symbols per second =((number of slots per ms=4)*(number of symbols per slot=14)*(number of PRBs in Bandwidth=132)*(number of subcarriers per PRB=12)*1000 ms/second))=4*14*132*12*1000=88704000 symbols/second. The European Telecommunications Standards Institute (ETSI) Technical Specification entitled 5G; NR; User Equipment (UE) radio transmission and reception; Part 1: Range 1 Standalone (3GPP TS 38.101-1 version 17.5.0 Release 17) (2022-05) provides supported PRBs with SCS size in the band from which it states 135 PRBs for 100 MHz channel with SCS of 60 KHz. Herein, for reference purposes, 132 PRBs are being used. Table 5.3.2-1: Maximum transmission bandwidth configuration NRB defined in the ETSI TS 138 101-1 V17.5.0 (2022-05) specification can be referred to for different combinations of PRB support and SCS configuration. NRB is defined as the transmission bandwidth configuration, expressed in units of resource blocks. The European Telecommunications Standards Institute (ETSI) Technical Specification entitled 5G; NR; User Equipment (UE) radio transmission and reception; Part 1: Range 1 Standalone (3GPP TS 38.101-1 version 17.5.0 Release 17) (2022-05) published in May 2022 by the European Telecommunications Standards Institute is hereby incorporated by reference in its entirety.

The number of bits per symbol can vary based on the given radio conditions. Minimum modulation of QPSK carries 2 bits/symbol while 1024 QAM may carry 10 bits/symbol. For QPSK, the total supported data rate will be ((2 bits/symbol)*(88704000 symbols/second))/(1024*1024)=169.2 Mbps with an average spectral efficiency of 1.7 bits/second/Hz. For 1024 QAM, the total supported data rate will be ((10 bits/symbol)*(88704000 symbols/second))/(1024*1024)=845.9 Mbps with an average spectral efficiency of 8.5 bits/second/Hz. These given numbers are the maximum supported data rate (calculated) where all the symbols are configured downlink (DL). Due to the nature of traffic, it is normal to have different data rates in different geographical areas where users need different data rates for downlink (DL) and uplink (UL) traffic. For example, in a first geographical area users may need higher data rates for uplink traffic than downlink traffic (e.g., uplink traffic dominated geographical area) while in a second geographical area users may need higher data rates for downlink traffic than uplink traffic (e.g., downlink dominated geographical area).

In the configuration of system 100 shown in FIG. 1, two carriers of FR 1 and FR2 each are deployed at each of the systems base stations (BS 1 118, BS 2 124, BS 3 130, BS 4 136, BS 5 142, BS 6 148, . . . , BS N 154). FR 1 coverage of a base station overlaps with neighbor base station FR 1 frequency coverage. For example, the FR 1 coverage 120 of base station 1 118 overlaps with the FR 1 base station coverage 126 of base station 2 124, the FR 1 base station coverage 132 of base station 3 130, the FR 1 base station coverage 138 of base station 4 136. Similarly, the FR 1 coverage 138 of base station 4 overlaps with the base station coverage 120 of base station 1 118, the FR 1 coverage 126 of base station 2 124, the FR 1 coverage 132 of base station 3 130, the FR 1 coverage 144 of base station 5 142, the FR 1 coverage 150 of base station 6 148, the FR 1 coverage 156 of base station N 154. FR 1 being used as the coverage layer for the system 100. However, the FR 2 coverage of each of the base stations in the system 100 do not overlap with neighbor base stations. FR 2 coverage for each base station has a higher frequency, lower coverage footprint than the FR 1 coverage for the base station. This can be seen on FIG. 1 where the system 100 FR 2 coverage provided by FR 2 coverage 122 for base station 1 118, FR 2 coverage 128 for base station 2 124, FR 2 coverage 134 for base station 3 130, FR 2 coverage 140 for base station 4 136, FR 2 coverage 146 for base station 5 142, FR 2 coverage 152 for base station 6 148, and FR 2 coverage for base station N do not overlap unlike the FR 1 coverage provided by the same base stations.

Given that the FR 2 carrier configuration is such that the base stations do not have overlapping coverage, the carrier bandwidth for the FR2 layer for each base station in the system 100 can and in various embodiments is adjusted independently based on user activity, behavior, use case, events, interference, demand and time of occurrence. The data collected and provided to the base station configuration system includes in some embodiments user activity information, user behavior information, use case information, events information, interference information, traffic demand information and time of occurrence information. The FR 1 layer configuration for base stations of system 100 can have a static TDD configuration providing coverage throughout the system 1 coverage area given the overlap in FR 1 layer coverage between base stations.

The collected data in some embodiments is used to dynamically determine when and how to adjust cell configurations for the FR 2 cells of the network to increase spectral efficiency of the network by changing cell configurations (e.g., symbols per slot configurations such as downlink and uplink symbol designations) to match actual or predicted conditions at the base station to which the cells belong based on analysis of past conditions at the base stations.

In an exemplary embodiment of the invention, the network monitoring server 104 of the base station configuration management system 103 monitors the traffic demand on defined interval bases (e.g., 1 minute, 15 minutes, 60 minutes) along with the interference conditions of the users within a base station's coverage area. The base stations of system 100 providing the traffic demand and interference conditions they are experiencing to the network monitoring server 104 via communications link 160. In some embodiments, this information is provided in response to one or more requests from the network monitoring system 104. For example, a request indicating the information to provided (e.g., traffic demand, interference, and timing information to which the information corresponds) and when the information is to be provided (e.g., a recurring time interval the expiration of which indicates when the information is to be provided and/or threshold values (interference threshold value and/or traffic demand threshold values which are used to determine when information is to be provided) to the network monitoring server. The network monitoring server 104 will provide base station information including traffic demand and interference information to the demand data calculator server 106 of the base station configuration management system 103 via communications link 117. The demand data calculator server 106 uses this information to estimate traffic demands for individual base stations and the system 100 as a whole and/or for geographical coverage areas based on the historical monitored information which is collected and projected algorithm inputs by machine learning models for Uplink and Downlink.

The network monitoring server 104 also obtains information about the average modulation per base station such as for example QPSK, 16 QAM, 64 QAM, 1024 QAM per interference scenario and/or condition. The interference situation and/or condition may vary depending on the traffic load of the base station on Uplink and Downlink traffic.

The demand data calculator server 106 will generate traffic bin estimations in terms of Uplink traffic and Downlink traffic by geographic coverage area. This information is used by the demand data calculator server 106 to map or generate data demand coverage footprint estimation(s) for the system 100's coverage area and on a per base station basis for both FR 1 and FR 2 carrier frequencies. In some embodiments, the map of the data demand coverage footprint estimation is for different time periods (e.g., a different data demand estimation coverage map for different intervals of time such as a different data demand estimation coverage map for each day of the week). Additionally, the demand data calculator server 106 generates traffic aggregation information for geographical coverage areas on a per base station basis and in terms of Uplink and Downlink traffic distribution. The demand data calculator server 106 will also have estimations. The traffic aggregation in various embodiments is down at per base station base and in terms of uplink and downlink traffic distribution for a coverage area.

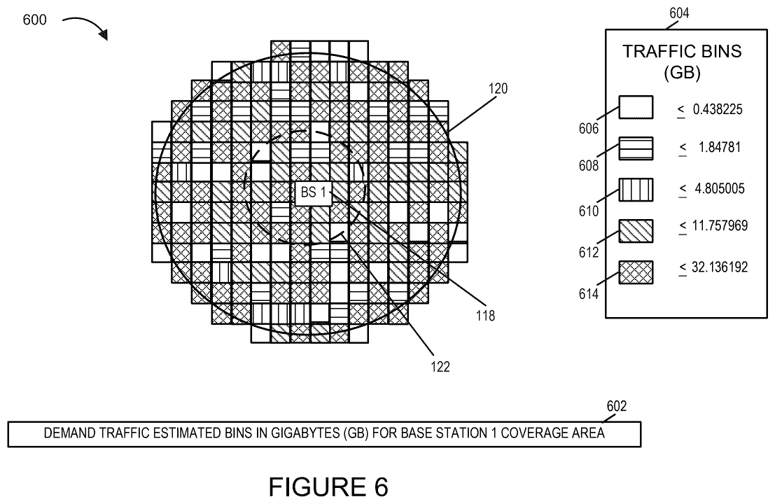

FIG. 6 diagram 600 illustrates an exemplary downlink data demand estimate coverage map for base station 1 118 for a first time period. Diagram 600 shows the mapping of estimated downlink traffic demand by bins in Gigabytes for the base station 1 118 coverage area including the base station 1 FR 2 coverage area 122 and base station FR 1 coverage area 120. The coverage area is divided up into geographic areas and the estimated downlink traffic demand is shown by the pattern illustrated in the geographic area. The traffic bins legend 604 provides information on the amount of estimated downlink traffic demand which corresponds to each of the 5 patterns utilized in diagram 600. Each of the 5 patterns 606, 608, 610, 612, and 614 represents a different traffic bin. A white pattern 606 indicates downlink traffic demand less than or equal to 0.438225 Gigabytes for the corresponding geographic area. Horizontal line pattern 608 indicates downlink traffic demand less than or equal to 1.84781 Gigabytes. A vertical line pattern 610 indicates downlink traffic demand less than or equal to 4.805005 Gigabytes. A slanted line pattern 612 indicates downlink traffic demand less than or equal to 11.757969 Gigabytes. A cross hatch pattern 614 indicates downlink traffic demand less than or equal to 32.136192 Gigabytes. In this example, the estimated traffic demand is for downlink traffic. A similar mapping is also performed for the estimated uplink traffic demand for the coverage area of base station 1 118 FR 2 coverage area 122 and FR 1 coverage area 120. The demand data calculator server 106 generates estimated traffic demand coverage maps for each of the base stations of system 100 with information for carrier frequencies FR 1 and FR 2. The demand data calculator server 106 also generates an aggregated estimated uplink and downlink traffic demand coverage area information for each of the base stations and the overall coverage area of system 100. In some embodiments, the uplink and downlink estimated traffic demand is maintained in tables in which a geographical area has table entries corresponding to one or more base stations identifiers, uplink traffic demand corresponding to the geographic area, downlink traffic demand corresponding to the geographic area.

The user location server 108 obtains and/or generates demand information for uplink and downlink traffic on a per device basis per traffic bin basis (e.g., user equipment device, mobile station, wireless device basis) and includes device location information. This uplink and downlink traffic per device per interval or period information is obtained from the base stations of system 100 via the network monitoring server 104. For example, in some embodiments the base stations of system 100 collects the uplink and downlink traffic for each the base station provides services along with the devices location for an interval or period of time and then reports this information to the monitoring server 104 which provides it to the user locations server 104 and/or the demand data calculator server 106. From the collected information a demand traffic map such as shown in diagram 600 of FIG. 6 can be generated (e.g., by the user locations server 108 and/or the demand data calculator server 106 for each of the base stations' coverage area as well as the overall coverage area of the system 100. Information on the demand per device bases per bin is useful in determining the distribution of the resource allocation. For example, it is important to understand how the traffic demand (uplink and downlink) corresponds to the data demand (e.g., via the bins) and whether the data demand (uplink and downlink) for a particular bin corresponds to one or a few devices in a particular location or the traffic demand is from across the entire coverage range of the FR 2 base station corresponding to a large number of devices.

The network monitoring server 104 also obtains radio coverage signal strength information (e.g., Reference Signal Reference Power (RSRP) and interference condition information (e.g., Signal to Interference Noise Ratio (SINR)) on a per base station basis from each of the base stations in the system 100. The information on the radio coverage signal strength and interference conditions is collected by the base stations from the wireless devices/mobile stations/user equipment devices connected to the base stations. These wireless devices/mobile stations/user equipment devices perform measurements and generate signal strength and interference information which they then report to the base stations to which they are connected. The base stations of system 100 in turn report/provide this information to the network monitoring server 104 which provides it to the coverage and interference review server 110. From the reported signal strength coverage information and interference conditions coverage information the distribution on a per base station and/or per cell basis is determined.

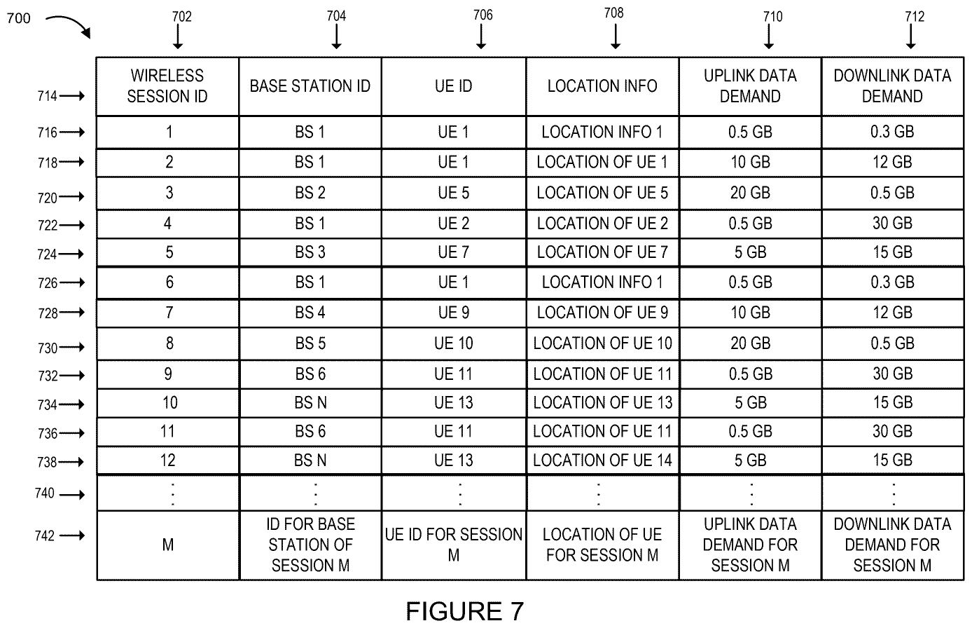

FIG. 7 illustrates an exemplary table 700 which includes exemplary information collected by network monitoring server 104 of the base station configuration management system 103 from the base stations and user equipment devices of system 100.

Table 700 includes columns 702, 704, 706, 710, 712, and rows 714, 716, 718, 720, 722, 724, 726, 728, 730, 732, 734, 736, 738, 740, and 742. The entries in row 714 are labels indicating the information contained in each column. Entries in column 702 identify a wireless session ID (row 714, column 702 entry) to which the data in same row corresponds. Entries in column 704 identify a base station Id (row 714, column 704 entry). In some embodiments, the base station ID includes a cell ID which identifies a particular base station cell (e.g., BS 1 cell 1 which identifies a FR 1 cell of the base station 1 or a BS 1 cell 2 which identifies a FR 2 cell of base station 1). Entries in column 706 are a user equipment device identifier (row 714, column 706 entry). Entries in column 708 include location information (row 714, column 708) for identifying a geographical location of a user equipment device (e.g., GPS coordinates at the time the corresponding session was initiated). Entries in column 710 are uplink data demand (row 714, column 710) in Gigabytes. The uplink data demand is the amount of data wireless transferred from the UE to the base station. Entries in column 712 are downlink data demand (row 714, column 712). The downlink data demand is the amount of data wirelessly transferred from the base station to the UE. The information in row 716 is for the wireless session 1. The information in row 718 is for the wireless session 2. The information in row 720 is for the wireless session 3. The information in row 722 is for the wireless session 4. The information in row 724 is for the wireless session 5. The information in row 726 is for the wireless session 6. The information in row 728 is for the wireless session 7. The information in row 730 is for the wireless session 9. The information in row 732 is for the wireless session 10. The information in row 736 is for the wireless session 11. The information in row 738 is for the wireless session 12. The entries in row 740 indicate that there are rows for additional sessions and corresponding information which are not shown. The information in row 742 is for wireless session M, M being an integer greater than 10.

How to read the table 700 is now discussed for row 716. The wireless session having wireless session ID=1 (row 716, column 702 entry) was serviced via the wireless base station having the base station ID=BS 1 (row 716, column 704 entry) which provided wireless services to the UE having a user equipment device identification of UE 1 (row 716, column 706 entry) which was at a geographical location in the BS 1 coverage area identified by location information 1 (row 716, column 708 entry) (e.g., GPS coordinates of UE 1 during the wireless session 1). During the wireless session 1, the UE 1 uplink data demand for the session was 0.5 Gigabytes (row 716, column 710 entry) which is the amount of uplink data sent from the UE 1 to the BS 1. During the wireless session 1, the UE 1 downlink data demand for the session was 0.3 Gigabytes (row 716, column 712 entry) which is the amount of downlink data sent from the BS 1 to the UE 1. In some embodiments, the base station ID includes the cell ID of the base station so as to provide information on the particular cell's uplink and downlink data demand as well as whether the cell is FR 1 cell utilizing FR 1 spectrum or a FR 2 cell utilizing FR 2 spectrum which will be maintained in a configuration information for the base station.

The table 700 includes information for a period or interval of time (such as for example a 15 minute, a 1 hour interval, a 24 hour interval, etc.) and provides an overview of the uplink and downlink data traffic demands of the wireless base stations (BS 1, BS 2, BS 3, BS 4, BS 5, BS 6, BS N) of system 100 for that time period or interval. The data in table 700 is only exemplary and used to convey some of the information being monitored and collected for use in determining dynamic FR 2 base station cell configurations. In some embodiments in which the UE's location information is not provided but the base station cell ID is provided the location at which the uplink and downlink data demand for the session is estimated from the base station cell ID which is mapped to a coverage area for the identified cell. The amount of uplink data demand for a base station for the interval or period of time is determined by aggregating the amounts of uplink data attributed to each base station in the entries of the table 700. For example, for BS 1 add up each of the uplink data demand entry amounts in column 710 which have BS 1 ID in the same row. For example, assume that all rows after row 738 did not include an BS 1 identifiers then rows 716, 718, 722, and 726 are the only rows having uplink data demand information for BS 1. To obtain the uplink data demand add the entries from column 710 for rows 716, 718, 722 and 726 which are 0.5 Gigabytes, 10 Gigabytes, 0.5 Gigabytes, and 0.5 Gigabytes respectively. The result is that base station 1 had an uplink data demand of 11.5 Gigabytes for the time period or interval represented by table 700. Similarly the downlink data demand for the time period or interval represented by table 700 can be calculated for BS 1 by aggregating or adding the downlink data demand amounts from column 712 entries for rows 716, 718, 722, and 726 which is 0.3 Gigabytes, 12 Gigabytes, 30 Gigabytes, 0.3 Gigabytes respectively. The result is that base station 1 had a downlink data demand of 42.6 Gigabytes for the time period or interval represented by table 700. When base station and cell IDs are used, the base station uplink data demand can be obtained for each cell of a base station by aggregating the uplink data demand for the individual cell by base station ID cell ID. The overall uplink data demand for a particular base station can be obtained by aggregating or adding the uplink data demand amounts for all cells of the particular base station. The overall downlink data demand for cell of a base station or an individual base station can be obtained in a similar manner wherein the downlink data amounts are being aggregated or added together. To determine the overall wireless system (e.g., system 100) uplink data demand for the time period or interval represented by table 700 all amounts in column 710 are aggregated or added. To determine the overall wireless system (e.g., system 100) downlink data demand for the time period or interval represented by table 700 all amounts in column 712 are aggregated or added. The information from table 700 can also be used to generate a heat map similar to the heat map 600 that shows the uplink and/or downlink data demand traffic by traffic bins for each base station of the system as well as the overall system using the location information from the table provided in column 708.

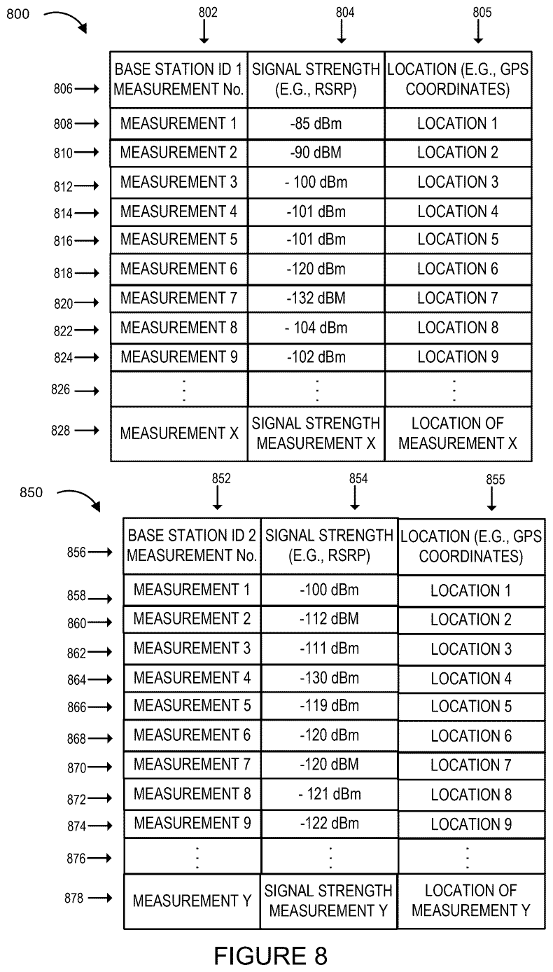

FIG. 8 illustrates exemplary tables 800 and 850 which provide exemplary signal strength measurements within the coverage area of base station 1 118 and base station 2 124 respectively. Table 800 includes exemplary signal strength measurements (e.g., Reference Signal Received Power (RSRP) measurements) in dBm reported to base station 1 118 from wireless devices (e.g., UEs) connected to the wireless base station 1 118. Table 850 includes exemplary signal strength measurements (e.g., Reference Signal Received Power (RSRP) measurements) in dBm reported to base station 2 124 from wireless devices (e.g., UEs) connected to the wireless base station 2 124.

Table 800 includes columns 802, 804, 805, and rows 806, 808, 810, 812, 814, 816, 818, 820, 822, 824, 826, 828. The entries in row 806 are labels indicating the information contained in each column. Entries in column 802 identify base station 1 118 measurement number (row 806, column 802 entry). The base station 1 measurement number identifies the signal strength measurement which was reported to base station 1. The entries in column 804 are the value of the signal strength measurement (row 806, column 804 entry) (e.g., RSRP measurement) for the measurement number identified in the same row. The entries in column 805 (row 806, column 805 entry) is the location (e.g., geographical coordinates (e.g., GPS coordinates) of the reporting device) from which the signal strength measurement corresponding to the signal strength measurement number identified in the same row was obtained. This location will be within the coverage area of base station 1 118. Row 808 includes the following information on signal strength measurement 1 for base station 1 118 and is read as follows: base station 1 signal strength measurement 1 (row 808, column 802 entry) had a signal strength value of −85 dBm (row 808, column 804 entry) and the measurement was obtained from location 1 (row 808, column 805 entry). Row 810 includes the following information on signal strength measurement 2 for base station 1 118 and is read as follows: base station 1 signal strength measurement 2 (row 810, column 802 entry) had a signal strength value of −90 dBm (row 810, column 804) and the measurement was obtained from location 2 (row 810, column 805). Row 812 includes base station 1 signal strength measurement 3 information. Row 814 includes base station 1 signal strength measurement 4 information. Row 816 includes base station 1 signal strength measurement 5 information. Row 818 includes base station 1 signal strength measurement 6 information. Row 820 includes base station 1 signal strength measurement 7 information. Row 822 includes base station 1 signal strength measurement 8 information. Row 824 includes base station 1 signal strength measurement 9 information. The. entries in row 826 indicate a continuation of the table with additional entries for additional measurements. Row 828 includes base station 1 signal strength measurement X information, where X is an integer greater than 9. While the locations in the table are identified as location 1, location 2, . . . , location of measurement X, the locations indicate the location at which measurement in the same row was made and may, and in some embodiments is, the same such as when the location of two different measurements is the same.

Table 850 includes columns 852, 854, 855, and rows 856, 858, 860, 862, 864, 866, 868, 870, 872, 874, 876, 878. The entries in row 856 are labels indicating the information contained in each column. Entries in column 852 identify base station 2 124 measurement number (row 856, column 852 entry). The base station 2 measurement number identifies the signal strength measurement which was reported to base station 2. The entries in column 854 are the value of the signal strength measurement (row 856, column 854 entry) (e.g., RSRP measurement) for the measurement number identified in the same row. The entries in column 855 (row 856, column 855 entry) is the location (e.g., geographical coordinates (e.g., GPS coordinates) of the reporting device) from which the signal strength measurement corresponding to the signal strength measurement number identified in the same row was obtained. This location will be within the coverage area of base station 2 124. Row 858 includes the following information on signal strength measurement 1 for base station 2 124 and is read as follows: base station 2 signal strength measurement 1 (row 858, column 852 entry) had a signal strength value of −100 dBm (row 858, column 854 entry) and the measurement was obtained from location 1 (row 858, column 855 entry). Row 860 includes the following information on signal strength measurement 2 for base station 2 124 and is read as follows: base station 2 signal strength measurement 2 (row 860, column 852 entry) had a signal strength value of −112 dBm (row 860, column 854) and the measurement was obtained from location 2 (row 860, column 855). Row 862 includes base station 2 signal strength measurement 3 information. Row 864 includes base station 2 signal strength measurement 4 information. Row 866 includes base station 2 signal strength measurement 5 information. Row 868 includes base station 2 signal strength measurement 6 information. Row 870 includes base station 2 signal strength measurement 7 information. Row 872 includes base station 2 signal strength measurement 8 information. Row 874 includes base station 2 signal strength measurement 9 information. The “. . . ” entries in row 876 indicate a continuation of the table with additional entries for additional measurements. Row 878 includes base station 2 signal strength measurement Y information, where Y is an integer greater than 9. While the locations in the table 850 are identified as location 1, location 2, . . . , location of measurement Y, the locations indicate the location at which the measurement in the same row was made and may, and in some embodiments is, the same such as when the location of two different measurements is the same.

In some embodiments, additional information is included about the signal strength measurement such as the time it was taken, the device (e.g., UE) which performed the measurement, and whether the signal strength measurement corresponded to FR 1 frequency or FR 2 frequency. In some embodiments, this information is included in additional columns of tables 800 and 850.

The same or similar coverage area signal strength information is also obtained for the other base stations of the system 100 (i.e., base station 3 130, base station 4 136, base station 5 142, base station 6 148, . . . , base station N 154). The coverage area signal strength information for the other base stations of system 100 may be, and in some embodiments is, included in separate tables corresponding to the base station such as shown in the exemplary tables 800 and 850. In some embodiments a single table or data structure is utilized in which records containing the signal strength measurement information with an additional identifier in the record of the measurement which identifies the base station to which the signal strength measurement record corresponds.

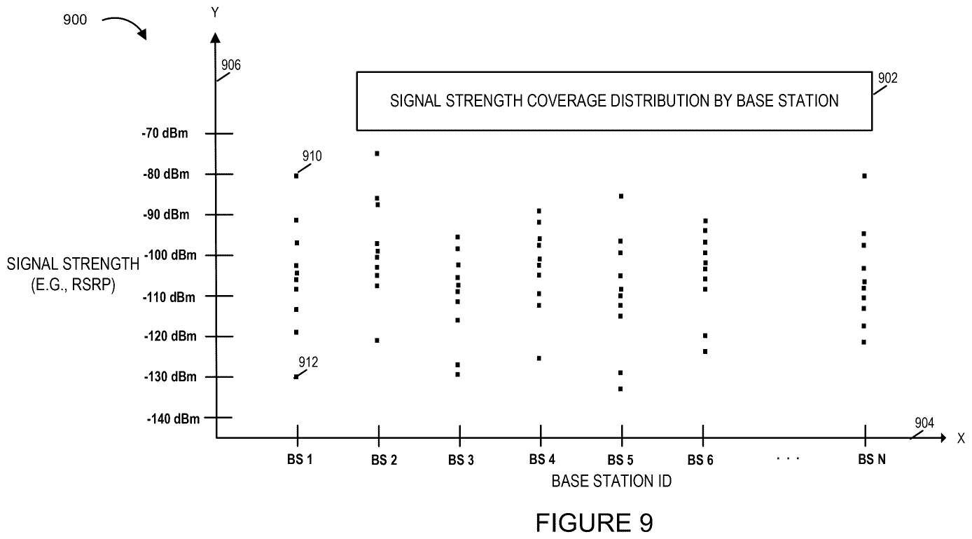

FIG. 9 illustrates an exemplary plot 900 of the measured signal strength coverage distribution for system 100 on a per base station basis as reported by wireless devices (e.g., UEs, mobile stations, etc.) connected to the base stations. These values are for different measurements than those discussed in connection with FIG. 8. The X axis 904 is the base station identifier and the Y axis 906 is the signal strength (e.g., RSRP) in dBm. The base stations include BS 1 118, BS 2 124, BS 3 130, BS 4, 136, BS 5 142, BS 6 148, . . . , BS N 154. The signal strength measurements for each base station are shown as dots. For example, dot 910 represents a base station 1 signal strength measurement of −80 dBm, dot 912 represents a base station 1 signal strength measurement of −130 dBm. The signal strength measurements corresponding to a base station show the distribution of the signal strength coverage for that base station as determined from the reported signal strength measurements. Legend 902 indicates that plot 900 shows the signal strength coverage distribution by base station.

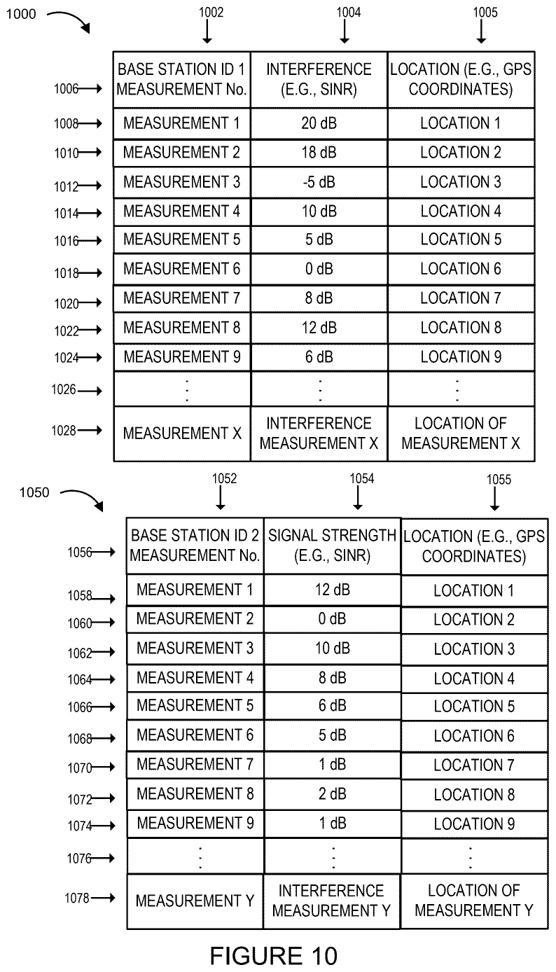

FIG. 10 illustrates exemplary tables 1000 and 1050 which provide exemplary signal interference measurements within the coverage area of base station 1 118 and base station 2 124 respectively. Table 1000 includes exemplary signal interference measurements (e.g., Signal Interference Noise Ratio (SINR) measurements) in dB reported to base station 1 118 from wireless devices (e.g., UEs) connected to the wireless base station 1 118. Table 1050 includes exemplary signal interference measurements (e.g., Signal Interference Noise Ratio (SINR) measurements) in dB reported to base station 2 124 from wireless devices (e.g., UEs) connected to the wireless base station 2 124.

Table 1000 includes columns 1002, 1004, 1005, and rows 1006, 1008, 1010, 1012, 1014, 1016, 1018, 1020, 1022, 1024, 1026, 1028. The entries in row 1006 are labels indicating the information contained in each column. Entries in column 1002 identify base station 1 118 measurement number (row 1006, column 1002 entry). The base station 1 measurement number identifies the signal interference measurement which was reported to base station 1. The entries in column 1004 are the value of the signal interference measurement (row 1006, column 1004 entry) (e.g., SINR measurement) for the measurement number identified in the same row. The entries in column 1005 (row 1006, column 1005 entry) is the location (e.g., geographical coordinates (e.g., GPS coordinates) of the reporting device) from which the signal interference measurement corresponding to the signal interference measurement number identified in the same row was obtained. This location will be within the coverage area of base station 1 118. Row 1008 includes the following information on signal interference measurement 1 for base station 1 118 and is read as follows: base station 1 signal interference measurement 1 (row 1008, column 1002 entry) had a signal interference value of 20 dB (row 1008, column 1004 entry) and the measurement was obtained from location 1 (row 1008, column 1005 entry). Row 1010 includes the following information on signal interference measurement 2 for base station 1 118 and is read as follows: base station 1 signal interference measurement 2 (row 1010, column 1002 entry) had a signal interference value of 18 dB (row 1010, column 1004) and the measurement was obtained from location 2 (row 1010, column 1005). Row 1012 includes base station 1 signal interference measurement 3 information. Row 1014 includes base station 1 signal interference measurement 4 information. Row 1016 includes base station 1 signal interference measurement 5 information. Row 1018 includes base station 1 signal interference measurement 6 information. Row 1020 includes base station 1 signal interference measurement 7 information. Row 1022 includes base station 1 signal interference measurement 8 information. Row 1024 includes base station 1 signal interference measurement 9 information. The “. . . ” entries in row 1026 indicate a continuation of the table with additional entries for additional measurements. Row 1028 includes base station 1 signal interference measurement X information, where X is an integer greater than 9. While the locations in the table are identified as location 1, location 2, . . . , location of measurement X, the locations indicate the location at which measurement in the same row was made and may, and in some embodiments is, the same such as when the location of two different measurements is the same.

Table 1050 includes columns 1052, 1054, 1055, and rows 1056, 1058, 1060, 1062, 1064, 1066, 1068, 1070, 1072, 1074, 1076, 1078. The entries in row 1056 are labels indicating the information contained in each column. Entries in column 1052 identify base station 2 124 measurement number (row 1056, column 1052 entry). The base station 2 measurement number identifies the signal interference measurement which was reported to base station 2. The entries in column 1054 are the value of the signal interference measurement (row 1056, column 1054 entry) (e.g., SINR measurement) for the measurement number identified in the same row. The entries in column 1055 (row 1056, column 1055 entry) is the location (e.g., geographical coordinates (e.g., GPS coordinates) of the reporting device) from which the signal interference measurement corresponding to the signal interference measurement number identified in the same row was obtained. This location will be within the coverage area of base station 2 124. Row 1058 includes the following information on signal strength measurement 1 for base station 2 124 and is read as follows: base station 2 signal interference measurement 1 (row 1058, column 1052 entry) had a signal interference value of 12 dB (row 1058, column 1054 entry) and the measurement was obtained from location 1 (row 1058, column 1055 entry). Row 1060 includes the following information on signal interference measurement 2 for base station 2 124 and is read as follows: base station 2 signal interference measurement 2 (row 1060, column 1052 entry) had a signal interference value of 0 dB (row 1060, column 1054) and the measurement was obtained from location 2 (row 1060, column 1055). Row 1062 includes base station 2 signal interference measurement 3 information. Row 1064 includes base station 2 signal interference measurement 4 information. Row 1066 includes base station 2 signal interference measurement 5 information. Row 1068 includes base station 2 signal interference measurement 6 information. Row 1070 includes base station 2 signal interference measurement 7 information. Row 1072 includes base station 2 signal interference measurement 8 information. Row 1074 includes base station 2 signal interference measurement 9 information. The “. . . ” entries in row 1076 indicate a continuation of the table with additional entries for additional measurements. Row 1078 includes base station 2 signal interference measurement Y information, where Y is an integer greater than 9. While the locations in the table 1050 are identified as location 1, location 2, . . . , location of measurement Y, the locations indicate the location at which the signal interference measurement in the same row was made and may, and in some embodiments is, the same such as when the location of two different measurements is the same.

In some embodiments, additional information is included about the signal interference measurement such as the time it was taken, the device (e.g., UE) which performed the measurement, and whether the signal strength measurement corresponded to FR 1 frequency or FR 2 frequency. In some embodiments, this information is included in additional columns of tables 1000 and 1050.

The same or similar coverage area signal strength information is also obtained for the other base stations of the system 100 (i.e., base station 3 130, base station 4 136, base station 5 142, base station 6 148, . . . , base station N 154). The coverage area signal strength information for the other base stations of system 100 may be, and in some embodiments is, included in separate tables corresponding to the base station such as shown in the exemplary tables 800 and 850. In some embodiments a single table or data structure is utilized in which records containing the signal strength measurement information with an additional identifier in the record of the measurement which identifies the base station to which the signal strength measurement record corresponds.

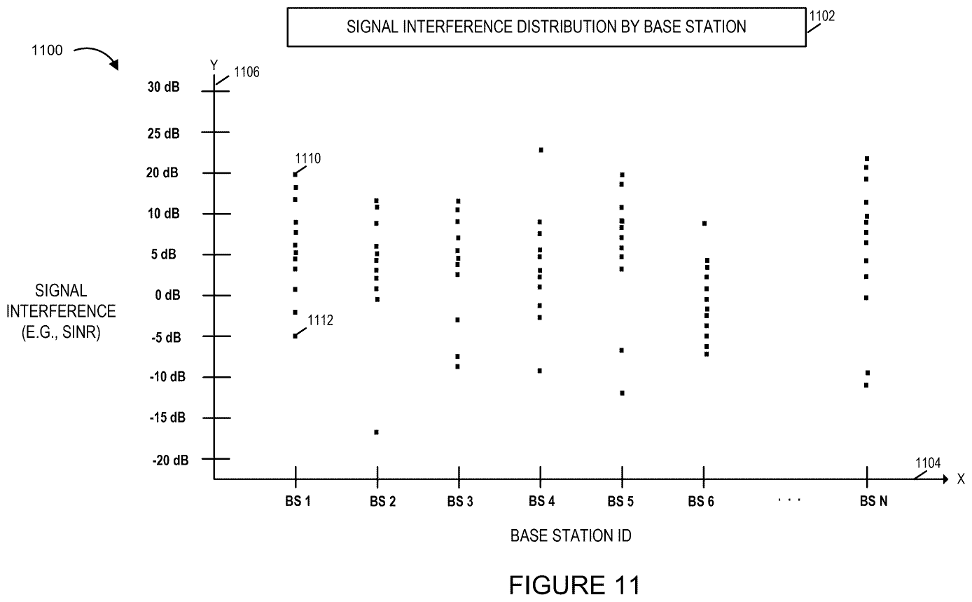

FIG. 11 illustrates an exemplary plot 1100 of the measured interference (SINR) distribution for system 100 on a per base station basis as reported by wireless devices (e.g., UEs, mobile stations, etc.) connected to the base stations. The X axis 1104 is the base station identifier and the Y axis 1106 is the signal interference level (e.g., SINR) in dB. The base stations include BS 1 118, BS 2 124, BS 3 130, BS 4, 136, BS 5 142, BS 6 148, . . . , BS N 154. The interference level measurements for each base station are shown as dots. For example, dot 1110 represents a base station 1 signal interference level measurement of 20 dB, dot 912 represents a base station 1 signal interference level measurement of −5 dB. The signal interference level measurements corresponding to a base station show the distribution of the signal interference for that base station as determined from the reported signal interference measurements. Legend 1102 indicates that plot 1100 shows the signal interference distribution by base station.

The information in tables 800, 850, 1000, 1050 and plots 900 and 1100 may be obtained based on information from a time interval or period such as for a 15 minute period or interval of the day, an hour interval or period of the day, or a full day and be updated after each time period or interval. For example, mapping out the signal strength distribution, signal interference distribution, uplink traffic demand, downlink traffic demand by base station for every 15 minutes of a day, every hour of the day, or every day of the week.

As per the estimated uplink and downlink traffic demand for each base station along with the supported modulation, the configuration estimator server 112 will calculate and/or determine the configuration for uplink and downlink symbols for FR 2 on a per base station basis. The configuration estimator server 112 will then send the calculated or determined FR 2 configuration information for the base station(s) to the network instructor 114 and the configuration management server 116. The network instructor 114 will generate instructions for modifying the current base station(s) FR 2 configurations (e.g., FR 2 symbol configuration) so as to conform with the calculated and/or determined symbol configuration (i.e., the specific symbol format to be used by a base station(s)). These instructions will be provided to the configuration management server which will send the instructions to the base station(s), confirm that the base station(s) configuration modifications were implemented by the base station(s) and provide acknowledgement to the network instructor server 114 that the base station(s) configurations were modified as instructed. The configuration instructions may, and in some embodiments do, include information on the FR 2 frame, sub-frame, and slot configurations including the symbols/slot UL/DL configurations (e.g., slot format symbol configuration).

The complete traffic flow management for the system 100 and its base stations (base station 1 118, base station 2 124, base station 3 130, base station 4 136, base station 5 142, base station 6 148, . . . , base station N 154) will be defined for given intervals or periods of time. The intervals or periods of time can be different for different base stations as the FR 1 configuration parameters will in most embodiments remain static and so the overlap of the coverage areas between base stations will not be affected when the FR 2 configuration parameters are changed as the FR 2 coverage area of the base stations of system 100 do not overlap as shown in FIG. 1. This allows for the configuration of each base station's FR 2 parameters to be different and independent from other base stations of the system 100. In some embodiments, a plurality of base station symbols/slot Uplink/Downlink configuration parameter profiles will be created and/or defined. In such embodiments, given a calculated uplink/downlink traffic demand estimation (e.g., determined by the demand data calculator server 106 based on reported past base station uplink/downlink data traffic information), the base station symbols/slot Uplink/Downlink configuration parameter profile can be determined from the plurality or set of base station symbols/slot Uplink/Downlink configuration parameter profiles created and/or defined. The symbols/slot Uplink/Downlink configuration parameters chosen or determined for a base station will be based on reported signal strength (e.g., 5G NR RSRP measurements) reported from the wireless devices (e.g., UEs, mobile stations, etc.) connected to a base station, signal interference (e.g., 5G SINR measurements) reported from the wireless devices (e.g., UEs, mobile stations, etc.) connected to the base station, and data demand at the base station for Uplink and Downlink data.

The FR 1 base station cells will have more interference due to overlapping coverage areas. For example, base station 1 120 FR 1 cell coverage 120 overlaps with base station 2 124 FR 1 cell coverage 126, base station 3 130 FR 1 cell coverage 132, and base station 4 136 FR 1 cell coverage 138. Interference on FR 1 carrier frequency may reduce the effective offered capacity of base stations. FR 1 base station cells will have consistent downlink/uplink configurations to avoid interfering downlink/uplink transmissions of other base stations in the same network. For example, the downlink/uplink configuration for FR1 can be assumed to be 50/50 downlink/uplink while the nature of the uplink/downlink could be different. Hence, the FR 2 base station cells which do not have overlapping cell coverage can be configured on a per base station basis for down/uplink traffic and can be used to offload the data within the coverage area of the FR 2 base station cell.

In various embodiments, the FR 1 base stations will be utilized for required data offered first until a threshold of resources (e.g., 75% of the available resources) are being utilized from FR 1 base station cells of the system. Then the configuration of FR 2 base station cells will be evaluated for re-configuration.

Higher data demand can be served by fewer symbols of a timeslot with lower interference while for the same higher data demand with higher interference more symbols are needed in a timeslot for Uplink and Downlink configuration.

Traffic demand can differ on several instances for the same base station depending on user movement, events, timing, use case and or application in demand along with weather conditions, etc.

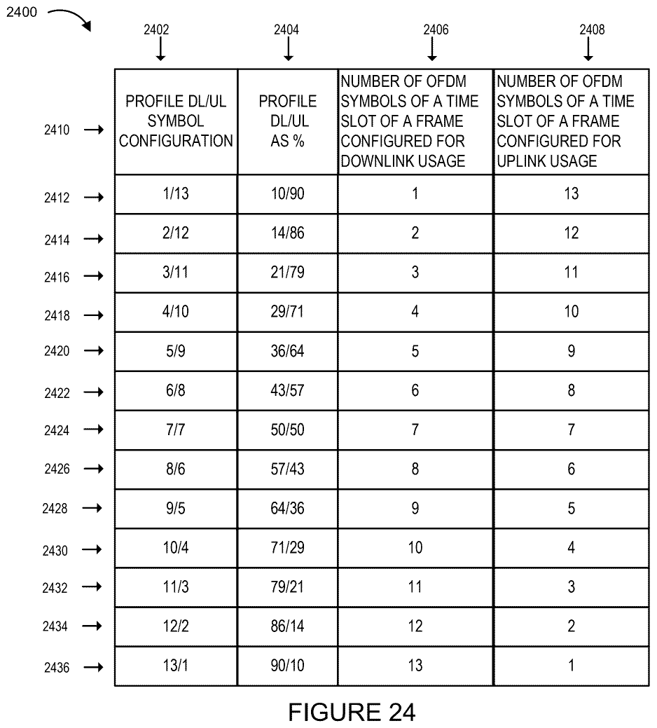

Discussed below are four examples of instances where data demand drifts or changes leading to the use of variable symbol configuration for a base station FR 2 cell(s).
Profile 1/Instance 1: requirement of 80 Gigabytes downlink data demand and 20 Gigabytes of Uplink data demand, with QPSK modulation being implemented, 80% of the symbols from the symbols of each timeslot will be configured as downlink and 20% of the symbols will be configured as uplink. When implementing a 5G-NR frame configuration which has 14 OFDM symbols per time slot, the closest to the 80/20 Downlink/Uplink Demand Ratio is 11 symbols of the 14 symbols per time slot being configured for downlink usage and 3 symbols of the 14 symbols per time slot being configured for uplink usage which provides approximately a 79/21 DL/UL ratio. Table 2400 row 2432 of FIG. 24 shows this Profile DL/UL symbol configuration.
Profile 2/Instance 2: requirement of 70 Gigabytes downlink data demand and 30 Gigabytes of Uplink data demand, with QPSK modulation being implemented, 70% of the symbols from the symbols of each timeslot will be configured as downlink and 30% of the symbols will be configured as uplink. When implementing a 5G-NR frame configuration which has 14 OFDM symbols per time slot, the closest to the 70/30 Downlink/Uplink Demand Ratio is 10 symbols of the 14 symbols per time slot being configured for downlink usage and 4 symbols of the 14 symbols per time slot being configured for uplink usage which provides approximately a 71/29 DL/UL ratio. Table 2400 row 2430 of FIG. 24 shows this Profile DL/UL symbol configuration.
Profile 3/Instance 3: requirement of 50 Gigabytes downlink data demand and 50 Gigabytes of Uplink data demand, with QPSK modulation being implemented, 50% of the symbols from the symbols of each timeslot will be configured as downlink and 50% of the symbols will be configured as uplink. When implementing a 5G-NR frame configuration which has 14 OFDM symbols per time slot, the 50/50 Downlink/Uplink Demand Ratio is 7 symbols of the 14 symbols per time slot being configured for downlink usage and 7 symbols of the 14 symbols per time slot being configured for uplink usage which provides a 50/50 DL/UL ratio. Table 2400 row 2424 of FIG. 24 shows this Profile DL/UL symbol configuration.
Profile 4/Instance 4: requirement of 10 Gigabytes downlink data demand and 90 Gigabytes of Uplink data demand, with QPSK modulation being implemented, 10% of the symbols from the symbols of each timeslot will be configured as downlink and 90% of the symbols will be configured as uplink. When implementing a 5G-NR frame configuration which has 14 OFDM symbols per time slot, the closest to the 10/90 Downlink/Uplink Demand Ratio is 1 symbol of the 14 symbols per time slot being configured for downlink usage and 13 symbols of the 14 symbols per time slot being configured for uplink usage which provides approximately a 10/90 DL/UL ratio. Table 2400 row 2432 of FIG. 24 shows this Profile DL/UL symbol configuration.

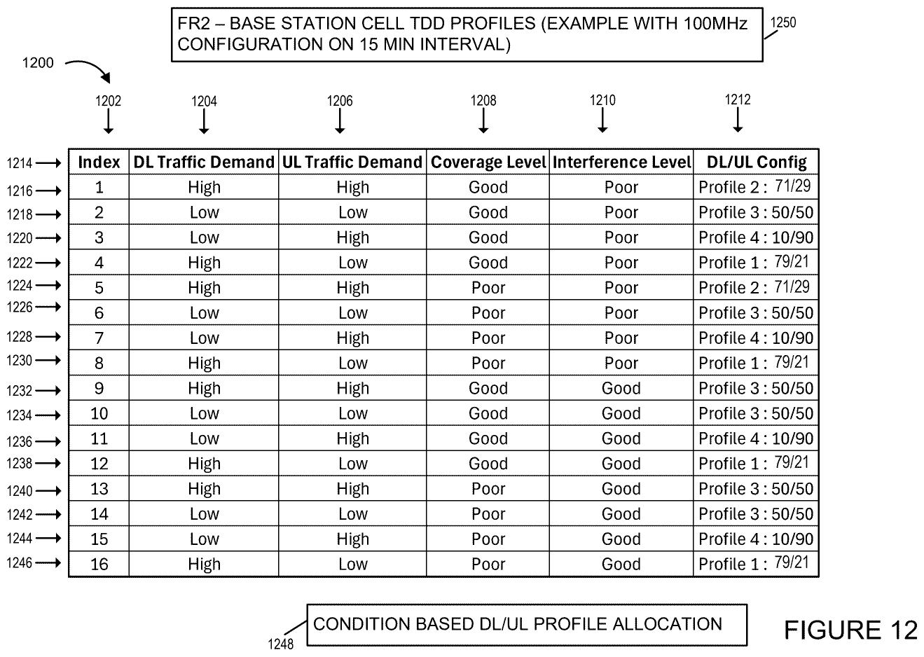

The configuration estimator server 112 uses table 1200 of FIG. 12 to allocate the downlink/uplink profile for base station FR 2 cells of the system. FIG. 12 illustrates an exemplary table which contains information for allocating or determining a base station's FR 2 downlink/uplink configuration profile from a set of four different FR 2 downlink/uplink configuration profiles based on the conditions being experienced at the base station. As the title 1250 of FIG. 12 states, the FIG. 12 illustrates FR 2—Base Station Cell TDD profiles for an example with 100 MHz Configuration on 15 minute interval. The table 1200 legend 1248 indicates the table 1200 provides information for condition based DL/UL profile allocation (i.e., FR 2 cell TDD profile configuration allocation).

Table 1200 is a condition based downlink/uplink profile allocation table in which a base station's conditions are used to determine the base station's FR 2 symbols/slot uplink/downlink parameter configuration from a set of four symbols/slot uplink/downlink parameter configuration profiles (i.e., the Profile 1: 79/21, Profile 2: 71/29, Profile 3: 50/50, and Profile 4: 10/90 discussed above). The base station's conditions including table 1200 are: (1) downlink traffic demand, (2) uplink traffic demand, (3) signal strength coverage level, and (4) signal interference level.

While the table 1200 only uses a set of four profiles, there can be a plurality of such profiles (e.g., N profiles where N is a number greater than 4) which can be implemented on a time interval or time period basis (e.g., on a 15 minute time interval or hourly time interval) effectively capturing the maximum amount of traffic in the wireless network. Also, FR 2 symbols/slot DL/UL configurations can determined and used on a per base station basis. This is useful where all the base stations in the network do not have similar demand for traffic in downlink and uplink as well as having different signal strength coverage level conditions and signal interference conditions. The implementation of different FR 2 base station symbols/slot DL/UL configurations on a per base station basis based on the individual base stations conditions provides the ability to provide maximum benefit and/or increased efficiency for each individual base station. Table 2400 of FIG. 24 illustrates additional symbols per time slot DL/UL configurations for systems (e.g., 5G-NR systems which use 14 symbols per time slot).

Timeslot configuration can be optimally managed by reviewing traffic and interference patterns and using the information obtained through the monitoring to predict and/or estimate conditions at a base station and the timeslot configuration (e.g., symbols/timeslot DL/UL configuration) which best matches the conditions (e.g., which provides a DL/UL traffic capacity matching or approximately matching the estimated DL/UL traffic demand). Various embodiments of the invention also improve the wireless network's spectral efficiency by managing the combined radio resources for the primary cell (FR 1 cell) of the base station which is used to provide the coverage layer of the network and the secondary cell (FR 2 cell) of the base station which is used to provide the capacity layer of the network. Base station secondary cells (FR 2 cells) being individually and independently configured to match the conditions being experienced at the base station to which the cell belongs while the base station primary cells (FR 1 cells) which have overlapping coverage areas having the same or consistent base station cell frame and symbols per time slot configuration (e.g., which remains static) so as to minimize interference.

The use of a plurality of symbols/slot DL/UL configuration profiles and their implementation by base stations of the wireless network will improve, increase and/or maximize the amount of revenue which can be obtained when applied to very high demand network scenarios as network congestion can be minimized by changing the downlink and uplink capacity to match the estimated demand. In various embodiments, the use of a plurality of base station FR 2 cell configuration profiles which can be implemented on different base stations of the wireless network increases and/or improves the amount of traffic which can be serviced by the network. Various embodiments of the present invention improve the effectiveness and efficiency of the amount of data and type of data (downlink vs uplink) that can be serviced by the base stations of the network by independently configurating each base station's FR 2 cell configuration (e.g., symbols/slot downlink/uplink configuration) to match the conditions (e.g., estimated downlink/uplink traffic, signal interference and signal strength coverage) for the base station being configured. In various embodiments, the FR 2 cell configurations of the base stations are dynamically changed in response to changing conditions at the base station as determined through monitoring the conditions of the base stations of the wireless network (e.g., on a recuring basis or time interval/period) thus allowing for improved and higher amounts of data to be transferred in the wireless system especially during high usage scenarios when network congestion at one or more base stations is high.

Table 1200 includes columns 1202, 1204, 1206, 1208, 1210, 1212, and rows 1214, 1216, 1218, 1220, 1222, 1224, 1226, 1228, 1230, 1234, 1236, 1238, 1240, 1242, 1244, and 1246. The table 1200 includes traffic index conditions determined from data for a 15 minute time interval.

The entries in row 1214 are labels indicating the information contained in each column. Entries in column 1202 identify a traffic condition index number (row 1214, column 1202 entry) to which the Downlink Traffic Demand, Uplink Traffic Demand, Signal Strength Coverage Level, Signal Interference Level and DL/UL Configuration entries in the same row apply. Entries in column 1204 identify the Downlink (DL) Traffic Demand (row 1214, column 1204 entry). Entries in column 1206 identify base station Uplink (UL) Traffic Demand (row 1214, column 1206 entry). Entries in column 1208 identify base station Signal Strength Coverage Level (row 1214, column 1208 entry). Entries in column 1210 identify base station Signal Interference Level (row 1214, column 1210 entry). Entries in column 1212 identify a Downlink/Uplink Configuration Profile to be used for a base station having the conditions identified in the same row (row 1214, column 1210 entry). Rows 1216, 1218, 1220, 1222, 1224, 1226, 1228, 1230, 1232, 1234, 1236, 1238, 1240, 1242, 1244, 1246 includes information for traffic condition index 1, 2, 3, 4, 5, 6, 7, 8, 9, 10, 11, 12, 13, 14, 15, and 16 respectively. Examples of how to read the table are now provided.

Row 1216 includes information for traffic condition index 1 (row 1216, column 1202 entry). The traffic condition index 1 is for a base station having the following conditions determined for example for a 15 minutes time interval: DL traffic demand is high (row 1216, column 1204) (e.g., amount of downlink traffic from the base station communicated to the UEs it was servicing is greater than a DL traffic demand high threshold level such as for example 12 Gigabytes); UL traffic demand is high (row 1216, column 1206) (e.g., amount of uplink traffic from the UEs to the base station is greater than a UL traffic demand high threshold such as for example 8 Gigabytes); signal strength coverage level for the base station is good (row 1216, column 1208 entry) (e.g., signal strength measurements indicate an RSRP value greater than a signal strength good threshold level such as for example −90 dBm); signal interference coverage level for the base station is good (row 1216, column 1210 entry) (e.g., signal strength measurements indicate an SINR value less than a signal interference level poor threshold level such as for example 5 dB). A base station having the traffic conditions of index 1 is to be allocated and/or re-configured to use DL/UL configuration profile 2 which has a 71/29 DL/UL symbols per time slot configuration (row 1216, column 1212 entry) indicating 10 of the 14 symbols per a time slot are to be configured for downlink and 4 symbols of the 14 symbols per a time slot are to be configured for uplink.

Row 1226 includes information for traffic condition index 6 (row 1226, column 1202 entry). The traffic condition index 6 is for a base station having the following conditions determined for example for a 15 minutes time interval: DL traffic demand is low (row 1226, column 1204) (e.g., amount of downlink traffic from the base station communicated to the UEs it was servicing is less than a DL traffic demand low threshold level such as for example 7 Gigabytes); UL traffic demand is low (row 1226, column 1206) (e.g., amount of uplink traffic from the UEs to the base station is less than an UL traffic demand low threshold level such as for example 3 Gigabytes); signal strength coverage level for the base station is poor (row 1226, column 1208 entry) (e.g., signal strength measurements indicate an RSRP value less than a signal strength poor threshold level such as for example −100 dBm); signal interference coverage level for the base station is poor (row 1226, column 1210 entry) (e.g., signal strength measurements indicate an SINR value less than a signal interference level poor threshold level such as for example 5 dB). A base station having the traffic conditions of index 6 is to be allocated and/or re-configured to use DL/UL configuration profile 3 which has a 50/50 DL/UL symbols per time slot configuration (row 1226, column 1212 entry) indicating 7 of the 14 symbols per a time slot are to be configured for downlink and 7 symbols of the 14 symbols per a time slot are to be configured for uplink.

Row 1242 includes information for traffic condition index 14 (row 1242, column 1202 entry). The traffic condition index 14 is for a base station having the following conditions determined for example for a 15 minutes time interval: DL traffic demand is low (row 1242, column 1204) (e.g., amount of downlink traffic from the base station communicated to the UEs it was servicing is less than a DL traffic demand low threshold level such as for example 7 Gigabytes); UL traffic demand is low (row 1242, column 1206) (e.g., amount of uplink traffic from the UEs to the base station is less than an UL traffic demand low threshold level such as for example 3 Gigabytes); signal strength coverage level for the base station is poor (row 1242, column 1208 entry) (e.g., signal strength measurements indicate an RSRP value less than a signal strength poor threshold level such as for example −100 dBm); signal interference coverage level for the base station is good (row 1242, column 1210 entry) (e.g., signal strength measurements indicate an SINR value greater than a signal interference level good threshold level such as for example 14 dB). A base station having the traffic conditions of index 14 is to be allocated and/or re-configured to use DL/UL configuration profile 3 which has a 50/50 DL/UL symbols per time slot configuration (row 1242, column 1212 entry) indicating 7 of the 14 symbols per a time slot are to be configured for downlink and 7 symbols of the 14 symbols per a time slot are to be configured for uplink.

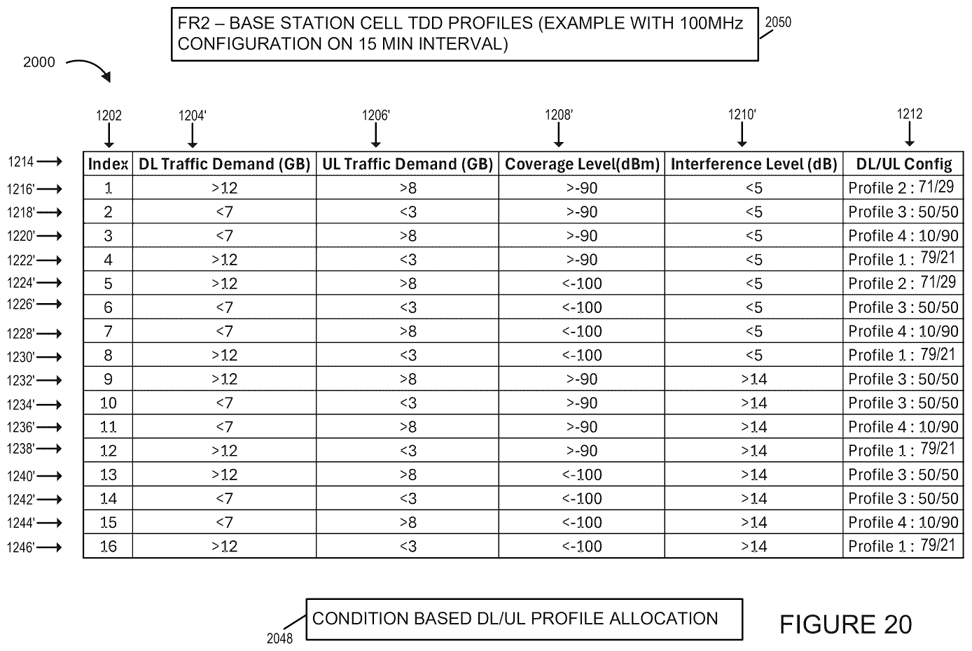

Table 2000 shown in FIG. 20 is a condition based downlink/uplink profile allocation table in which a base station's conditions are used to determine the base station's FR 2 symbols/slot uplink/downlink parameter configuration from a set of four symbols/slot uplink/downlink parameter configuration profiles (i.e., the Profile 1: 79/21, Profile 2: 71/29, Profile 3: 50/50, and Profile 4: 10/90 discussed above). The base station's conditions included in table 2000 are: (1) estimated downlink traffic demand in Gigabytes, (2) estimated uplink traffic demand in Gigabytes, (3) signal strength coverage level in dBm, and signal interference level in dB.

The table 2000 is for FR 2 Base Station Cell TDD Profiles for an example with 100 MHz bandwidth Configuration for a 15 minute interval as indicated in the title 2050. The legend 2048 indicates that the table provides condition based DL/UL profile allocations. The table 2000 is table 1200 wherein example threshold values have been included for High DL Traffic Demand, Low DL Traffic Demand, High UL Traffic Demand, Low UL Traffic Demand, Good Signal Strength Level, Poor Signal Strength Level, Good Signal Strength Level and Poor Signal Strength Level. A high downlink traffic demand is downlink traffic demand greater than 12 Gigabytes in 15 minutes. A low downlink traffic demand is downlink traffic demand that is less than 7 Gigabytes in 15 minutes. A high uplink traffic demand is an uplink traffic demand that is greater than 8 Gigabytes in 15 minutes. A low uplink traffic demand is an uplink traffic demand that is less than 3 Gigabytes in 15 minutes. A good signal strength coverage level is a signal strength coverage level greater than −90 dBm. A poor signal strength coverage level is a signal strength coverage level less than −100 dBm. A good signal interference level (e.g., SINR level) is a signal interference level greater than 14 dB. A poor signal interference level is signal interference level less than 5 dB. In some embodiments, the signal interference level is determined based on and/or using the signal interference level distributions for the base station over the 15 minute interval. In some embodiments, the signal strength coverage level is determined based on and/or using the signal strength coverage level distributions over the 15 minute interval.

Table 2000 includes rows 1214′, 1216′, 1218′, 1220′, 1222′, 1224′, 1226′, 1228′, 1230′, 1232′, 1234′, 1236′, 1238′, 1240′, 1242′, 1244′, 1246′ and columns 1202, 1204′, 1206′, 1208′, 1210′, and 1212. The information in the rows 1216′, 1218′, 1220′, 1222′, 1224′, 1226′, 1228′, 1230′, 1232′, 1234′, 1236′, 1238′, 1240′, 1242′, 1244′, 1246′ have been updated to reflect the exemplary threshold values for high DL traffic demand, low DL traffic demand, high UL traffic demand, low UL traffic demand, good signal strength coverage level, poor signal strength coverage level, good signal interference level, poor signal interference level.

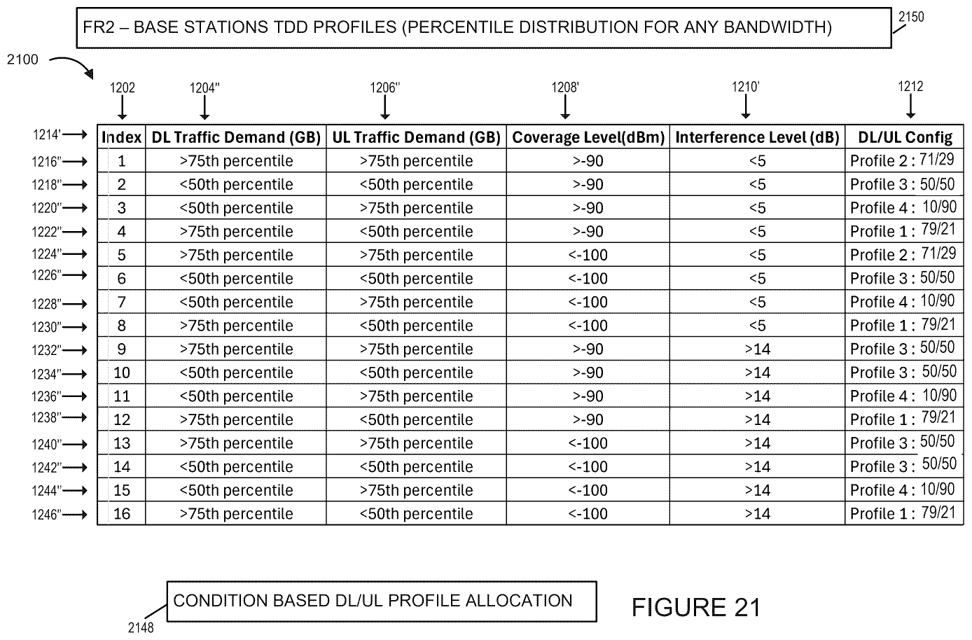

Table 2100 shown in FIG. 21 is another exemplary condition based downlink/uplink profile allocation table in which a base station's conditions are used to determine the base station's FR 2 symbols/slot uplink/downlink parameter configuration from a set of four symbols/slot uplink/downlink parameter configuration profiles (i.e., the Profile 1: 79/21, Profile 2: 71/29, Profile 3: 50/50, and Profile 4: 10/90 discussed above). The base station's conditions included in table 2100 are: (1) estimated downlink traffic demand, (2) estimated uplink traffic demand, (3) signal strength coverage level in dBm, and signal interference level in dB.

The table 2100 is for FR 2 Base Station Cell TDD Profiles (Percentile Distribution for any bandwidth) as indicated in the title 2150. The legend 2148 indicates that the table provides condition based DL/UL profile allocations. The table 2100 is table 2000 wherein DL Traffic Demand conditions and UL Traffic Demand conditions are percentile based and can be used for any bandwidth or time interval.

Table 2100 includes rows 1214′, 1216″, 1218″, 1220″, 1222″, 1224″, 1226″, 1228″, 1230″, 1232″, 1234″, 1236″, 1238″, 1240″, 1242″, 1244″, 1246″ and columns 1202, 1204″, 1206″, 1208′, 1210′, and 1212. The information in the rows 1216″, 1218″, 1220″, 1222″, 1224″, 1226″, 1228″, 1230″, 1232″, 1234″, 1236″, 1238″, 1240″, 1242″, 1244″, 1246″ have been updated to reflect the exemplary percentile values used for specifying DL traffic demand conditions and UL traffic demand conditions.

An example of how to read table 2100 is now provided. Row 1216″ includes information for traffic condition index 1 (row 1216″, column 1202 entry). The traffic condition index 1 is for a base station having the following conditions determined for example for an interval of time: DL traffic demand is greater than 75^{th} percentile (row 1216″, column 1204″); UL traffic demand is greater than 75^{th} percentile (row 1216″, column 1206″); signal strength coverage level for the base station is greater than −90 dBm (row 1216″, column 1208″ entry); signal interference coverage level for the base station is less than 5 dBm (row 1216″, column 1210″ entry). A base station having the traffic conditions of index 1 is to be allocated and/or re-configured to use DL/UL configuration profile 2 which has a 71/29 DL/UL symbols per time slot configuration (row 1216″, column 1212 entry) indicating 10 of the 14 symbols per a time slot are to be configured for downlink and 4 symbols of the 14 symbols per a time slot are to be configured for uplink.

With respect to exemplary tables 1200, 2000, and 2100 additional base station conditions can be added and mapped to the four DL/UL configuration profiles provided. Similarly, additional DL/UL configuration profiles can be included to further refine the configuration of symbols per slot. For example, additional DL/UL profiles are illustrated in table 2400 of FIG. 24.

Table 2400 shown on FIG. 24 illustrates exemplary downlink/uplink symbols per time slot configurations for a 14 symbol time slot (e.g., 5G-NR 14 symbol per time slot). The table 2400 includes rows 2410, 2412, 2414, 2416, 2418, 2420, 2422, 2424, 2426, 2428, 2430, 2432, 2434, 2436 and columns 2402, 2404, 2406, 2408.

The entries in row 2410 are labels indicating the information contained in each column. Entries in column 2402 identify a profile DL/UL symbol configuration which is the number of symbols of a 14 symbol time slot are designated for DL and number of symbols of the 14 symbol time slot that are designated for UL (row 2410, column 2402 entry). Entries in column 2404 specify the profile DL/UL as a percentage or an approximate percentage of the total symbols designated for downlink/uplink (i.e., rounding used when necessary) (row 2410, column 2404 entry). Entries in column 2406 specify the number of OFDM symbols of a time slot of a frame configured for downlink usage for the profile DL/UL symbol configuration specified in the same row. Entries in column 2408 specify the number of OFDM symbols of a time slot of a frame configured for downlink usage for the profile DL/UL symbol configuration specified in the same row. While the table uses OFDM symbols, the invention is not limited to the use of OFDM symbols. Row 2412 includes information for the profile DL/UL symbol configuration 1/13 that indicates a time slot is configured to have 1 downlink symbol and 13 uplink symbols (row 2412, column 2402 entry) which specifies that the profile may be expressed in terms of DL/UL symbol percentage as 10/90 (row 2412, column 2404 entry) and that the profile DL/UL symbol configuration 1/13 has 1 symbol configured for downlink usage (row 2412, column 2406 entry) and 13 symbols configured for uplink usage (row 2412, column 2406 entry). Row 2414, 2416, 2418, 2420, 2422, 2424, 2426, 2428, 2430, 2432, 2434 and 2436 including information for the profile DL/UL symbol configurations 2/12, 3/11, 4/10, 5/9, 6/8, 7/7, 8/6, 9/5, 10/4, 11/3, 12/2, and 13/1 respectively.

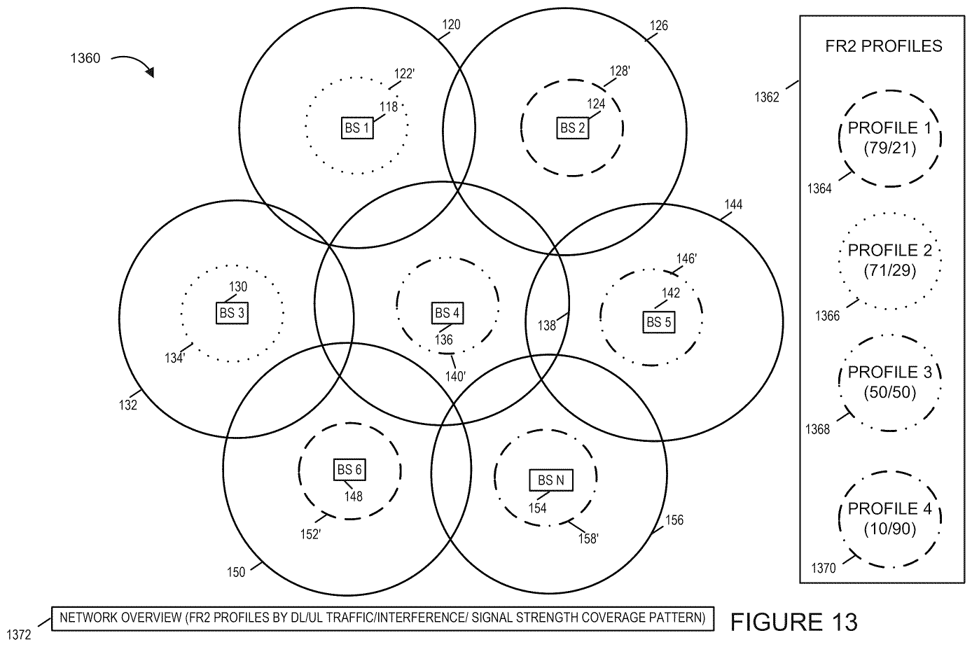

Diagram 1360 of FIG. 13 illustrates a network overview of the wireless system 100 base stations different FR2 cell configuration profiles which were determined based on downlink/uplink traffic demand, signal interference levels, and signal strength coverage patterns determined for each of the base stations as noted by the FIG. 13 title 1372 Network Overview (FR 2 Profiles by DL/UL Traffic/Interference/Signal Strength Coverage pattern). Elements or steps with the same reference numbers used in different figures are the same or similar and those elements or steps will not be described in detail again. Legend 1362 shows that there are 4 FR 2 base station configuration profiles which have been defined which include: (1) profile 1 (79/21 DL/UL symbols/slot configuration) 1364, (2) profile 2 (71/29 DL/UL symbols/slot configuration) 1366, (3) profile 3 (50/50 DL/UL symbols/slot configuration) 1368, (4) profile 4 (10/90 DL/UL symbols/slot configuration) 1370. The specific number of symbols per time slot for each of these profiles for a 5G NR wireless network symbols in which there are 14 OFDM symbols per time slot is shown in table 2400 of FIG. 24. BS 1 118 FR 2 cell has been configured in accordance with FR 2 profile 2 as shown by FR 2 base station cell coverage 122′. BS 2 124 FR 2 cell has been configured in accordance with FR 2 profile 4 as shown by FR 2 base station cell coverage 128′. BS 3 130 FR 2 cell has been configured in accordance with FR 2 profile 2 as shown by FR 2 base station cell coverage 134′. BS 4 136 FR 2 cell has been configured in accordance with FR 2 profile 3 as shown by FR 2 base station cell coverage 140′. BS 5 142 FR 2 cell has been configured in accordance with FR 2 profile 3 as shown by FR 2 base station cell coverage 146′. BS 6 148 FR 2 cell has been configured in accordance with FR 2 profile 1 as shown by FR 2 base station cell coverage 152′. BS N 154 FR 2 cell has been configured in accordance with FR profile 4 as shown by FR 2 base station cell coverage 158′. While the configuration of the base station with respect FR 1 cells is consistent across all base stations of the system, the FR 2 configurations (e.g., frame, slot, symbols/slot DL/UL configurations) of the base stations with respect to the FR 2 cells is determined and allocated to an individual base station basis independently from the FR 2 cell configuration of the other base stations of the system 100. In this way, downlink and uplink data throughput can be increased and/or maximized to make efficient use of the spectrum resources available to the base stations of the system.

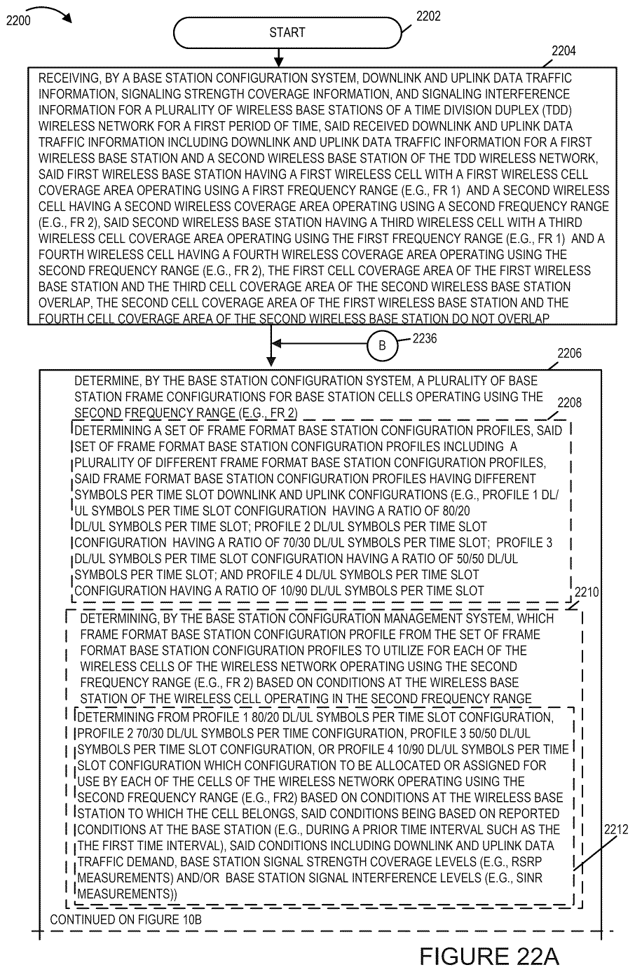

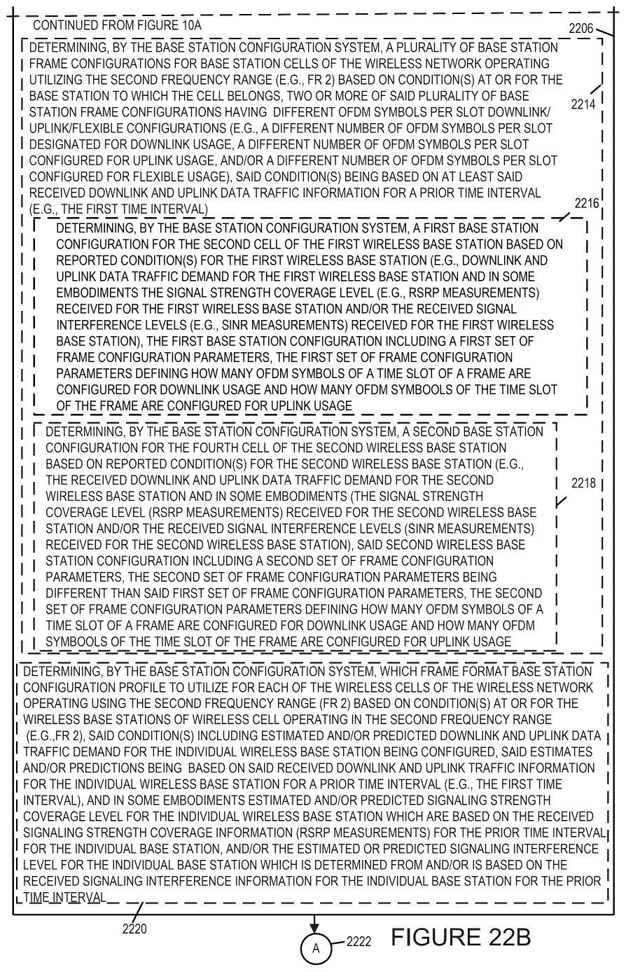

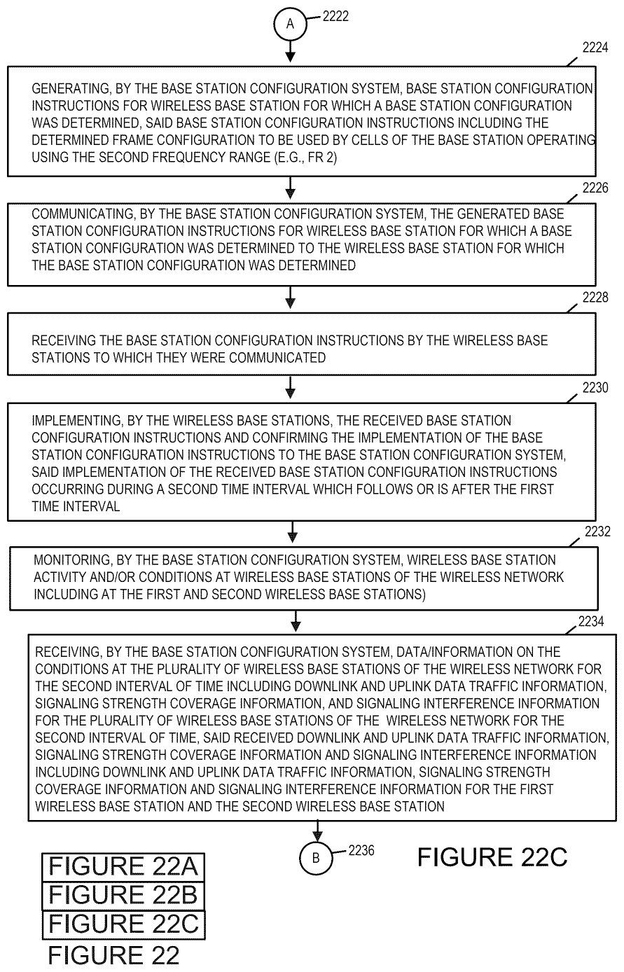

FIG. 22 comprises FIG. 22A, FIG. 22B, and FIG. 22C. FIG. 22A is a first part of an exemplary method in accordance with an embodiment of the present invention. FIG. 22B is a second part of an exemplary method in accordance with an embodiment of the present invention. FIG. 22C is a third part of an exemplary method in accordance with an embodiment of the present invention.

FIG. 22 illustrates a high level flowchart of an exemplary method 2200 in accordance with an embodiment of the present invention. While it will be readily understood that additional steps are performed in connection with communicating information, messages, and packets between devices, the method 2200 focuses on and discusses the steps for understanding the invention. The method 2200 will be discussed in connection with the exemplary system 100 but is not limited to being implemented on system 100 and can be implemented on other systems.

Method 2200 begins in start step 2202 shown on FIG. 22A. operation proceeds from step 2202 to step 2204.

In step 2204, a base station configuration management system (e.g., base station configuration management system 103 of system 100, receives downlink and uplink data traffic information, signaling strength coverage information, and signaling interference information for a plurality of wireless base stations (e.g., BS 1 118, BS 2 124, BS 3 130, BS 4 136, BS 5 142, BS 6 148, BS N 154) of a Time Division Duplex (TDD) wireless network system (e.g., system 100) for a first period of time (e.g., 15 minute interval, hour interval, day interval, week interval, etc.).

In some embodiments, the network monitoring server 104 of the base station configuration management system 103 receives some or all of the downlink and uplink data traffic information, signaling strength coverage information, and signaling interference information (e.g., from the plurality of base stations and/or the user equipment devices connected to the plurality of base stations).

The received downlink and uplink data traffic information includes downlink and uplink data traffic information for a first wireless base station (e.g., BS 1 118) and a second wireless base station (e.g., BS 2 124) of the TDD wireless network system. The first wireless base station having a first wireless cell with a first wireless cell coverage area (e.g., cell coverage area 120) operating using a first frequency range (e.g., FR 1). The first wireless base station also having a second wireless cell having a second wireless coverage area (e.g., cell coverage area 122) operating using a second frequency range (e.g., FR 2). The second wireless base station (e.g., BS 124) having a third wireless cell with a third wireless cell coverage area (e.g., cell coverage area 126) operating using the first frequency range (e.g., FR 1) and a fourth wireless cell having fourth wireless coverage area (e.g., cell coverage area 128) operating using the second frequency range (e.g., FR 2). The first cell coverage area (e.g., cell coverage area 120) of the first wireless base station (e.g., BS 1 118) and the third cell coverage area (e.g., cell coverage area 126) of the second wireless base station (e.g., BS 2 124) overlap. The second cell coverage area (e.g., cell coverage area 122) of the first wireless base station (e.g., BS 1 118) and the fourth cell coverage area (e.g., cell coverage area 128) of the second wireless base station do not overlap. In various embodiments, the second cell coverage area of the first wireless base station also does not overlap with the cell coverage areas of any neighboring base station cells operating using the second frequency range (e.g., FR 2). In various embodiments, the second wireless cell coverage of the first wireless base station does not overlap with the cell coverage area of any neighboring base station cells operating using the first frequency range (e.g., FR 1). In some embodiments, the second wireless cell coverage area of the first wireless base station is encompassed by the first wireless cell coverage area of the first wireless base station. For example, cell coverage area 122 of BS 1 118 is encompassed within the cell coverage area 120 of BS 1 118. In various embodiments, the received base station signaling strength coverage information and signaling interference information also includes such information for the first wireless base station and second wireless base station. Operation proceeds from step 2204 to step 2206.

In step 2206, the base station configuration management system determines a plurality of base station frame configurations for base station cells operating using the second frequency range (e.g., FR 2). In various embodiments, the base station configuration management system may also determine the base station frame configurations for base stations cells operating using the first frequency range (e.g., FR 1). The frame configurations for the base station cells of the TDD wireless network using the first frequency range (e.g., FR 1) will have the same or a consistent frame configuration using the same symbols per time slot configuration so as to minimize interference between cells with overlapping coverage areas (e.g., cell 1 of first base station and cell 3 of the second base station). In most, but not all embodiments, the frame symbols per time slot configuration is 50/50 downlink/uplink configuration in which 50% of the symbols per time slot are designated for downlink traffic usage and 50% of the symbols per time slot are designated for uplink traffic usage.

In some embodiments step 2206 includes one or more of the sub-steps 2208, 2210, 2214, and 2220.

In sub-step 2208, the base station configuration management system determines a set of frame format base station configuration profiles. The set of frame format base station configuration profiles include a plurality of different frame format base station configuration profiles. The different frame format base station configuration profiles having different symbols per time slot downlink and uplink symbol configurations. For example, profile 1 DL/UL symbols per time slot configuration having a ratio of 79/21 DL/UL symbols per time slot, profile 2 DL/UL symbols per time slot configuration having a ratio of 71/29 DL/UL symbols per time slot, profile 3 DL/UL symbols per time slot configuration having a ratio of 50/50 DL/UL symbols per time slot, profile 4 DL/UL symbols per time slot configuration having a ratio of 10/90 DL/UL symbols per time slot.

In sub-step 2210, the base station configuration management system determines which frame format base station configuration profiles to utilize for each of the wireless cells of the TDD wireless network system operating using the second frequency range based on conditions at the wireless base station of the wireless cell operating in the second frequency range. In various embodiments, the frame format base station configuration profile determination for the wireless cells operating using the second frequency range are made independent of the conditions at other wireless cells operating using the second frequency range at other base stations because the coverage areas of the cells operating using the second frequency range do not overlap or do not cause interference due to the distance between the cells. In some embodiments, sub-step 2210 includes sub-step 2212. In sub-step 2212, the base station configuration management system determines which configuration to allocate or assign for use by each of the cells of the wireless network operating using the second frequency range based on conditions at the wireless base station to which the cell belongs from a set of different profiles, the set of different profiles including for example the following: profile 1 79/21 DL/UL symbols per time slot configuration, profile 2 71/29 DL/UL symbols per time slot configuration, profile 3 50/50 DL/UL symbols per time slot configuration, profile 4 10/90 DL/UL symbols per time slot configuration. In some embodiments, the conditions at the wireless base station are based on reported and/or determined conditions (e.g., from a prior time interval or period during which data for the base stations was collected such as a first time interval). The conditions including downlink and uplink data traffic demand at the base station, and in some embodiments, base station signal strength coverage levels (e.g., measured RSRP levels across the coverage area of the base station—e.g., RSRP coverage distribution information for the base station) and/or base station signal interference levels (e.g., SINR measurements across the coverage area of the base station—e.g., SINR coverage distribution information for the base station).

Step 2206 is continued on FIG. 22B. In sub-step 2214, the base station configuration management system determines a plurality of base station frame configuration for base station cells of the wireless network system operating utilizing the second frequency range (e.g., FR 2) based on condition(s) at or for the base station which the cell belongs. Two or more of said plurality of base station frame configurations having different OFDM symbols per time slot downlink/uplink/flexible configurations (e.g., a different number of OFDM symbols per slot designated for downlink usage, a different number of OFDM symbols per slot configured for uplink usage, and/or a different number of OFDM symbols per slot configured for flexible usage). The symbols for flexible usage being designated for downlink usage or uplink usage before being implemented and utilized for communications being the base station and user equipment devices. In some embodiments, the different slot formats and symbol configurations are selected from formats shown in table 400 or 5G-NR slot formats defined in the 5G-NR standards. In some embodiments, symbols configuration slot format is defined specifically for the cell of the base station based on the conditions at the base station. In some embodiments, the conditions of the base station upon which the frame configuration and the symbols per time slot configuration of the frame configuration are based on include the received downlink and uplink data traffic flow information for a prior time interval (e.g., the first time interval). In some embodiments, the base station conditions further include the signaling strength coverage level and/or the signaling interference coverage level for the base station for a prior time interval (e.g., the first time interval). In some embodiments, the conditions at the estimated or predicted using the data and information collected during the prior time interval and a plurality of prior time intervals (e.g., historic information regarding the condition at the base station).

In some embodiments, sub-step 2214 includes one or more sub-steps 2216 and 2218. In sub-step 2216, the base station configuration management system determines a first base station configuration for the second cell of the first wireless base station based on reported condition(s) for the first wireless base station (e.g., downlink and uplink data traffic demand for the first wireless base station included in the received downlink and uplink data traffic information and in some embodiments the signal strength coverage level (e.g., RSRP measurements) received for the first wireless base station and/or the received signal interference levels (e.g., SINR measurements) received for the first wireless base station. The first base station configuration for the second cell of the first wireless base station including a first set of frame configuration parameters including the configuration of the OFDM symbols per slot (e.g., symbol configured for Downlink usage or Uplink usage). The first set of frame configuration parameters defining how many OFDM symbols of a time slot of a frame are configured for downlink usage and how many OFDM symbols of the time slot of the frame are configured for uplink usage. In some embodiments, the first set of frame configuration parameters include radio frame length, subframe length, number of OFDM symbols in a slot, number of slots in a subframe and the configuration of the OFDM symbols per slot for example as for Downlink usage or Uplink usage.

In sub-step 2218, the base station configuration management system determines a second base station configuration for the fourth cell of the second wireless base station based on reported condition(s) for the second wireless base station (e.g., downlink and uplink data traffic demand for the second wireless base station included in the received downlink and uplink data traffic information and in some embodiments the signal strength coverage level (e.g., RSRP measurements) received for the second wireless base station and/or the received signal interference levels (e.g., SINR measurements) received for the second wireless base station. The second base station configuration for the fourth cell of the second wireless base station including a second set of frame configuration parameters including the configuration of the OFDM symbols per slot (e.g., symbol configured for Downlink usage or Uplink usage). The set of frame configuration parameters being different than the first set of frame configuration parameters. The second set of frame configuration parameters defining how many OFDM symbols of a time slot of a frame are configured for downlink usage and how many OFDM symbols of the time slot of the frame are configured for uplink usage. In some embodiments, the second set of frame configuration parameters include radio frame length, subframe length, number of OFDM symbols in a slot, number of slots in a subframe and the configuration of the OFDM symbols per slot for example as for Downlink usage or Uplink usage. In various embodiments, the second set of frame configuration parameters have a different number of symbols per time slot of a frame configured for usage as downlink than the first set of frame configuration parameters. In various embodiments, the second set of frame configuration parameters have a different number of symbols per time slot of a frame configured for usage as uplink than the first set of frame configuration parameters. In various embodiments, the second set of frame configuration parameters have a different ratio of symbols per time slot of a frame configured for usage as downlink to uplink than the first set of frame configuration parameters (e.g., first set of frame configuration parameters has 14 symbols per time slot with 7 of symbols configured for downlink usage and 7 of the 14 symbols per time slot while the second set of frame configuration parameters has 14 symbols per time slot with 10 of the symbols configured for downlink usage and 4 of the symbols configured for uplink usage).

In sub-step 2220, the base station configuration management system, determines which frame format base station configuration profile to utilize for each of the wireless cells of the TDD wireless network system operating using the second frequency range (e.g., FR 2) based on condition(s) at or for the wireless base stations of the wireless cell operating using the second frequency range. The condition(s) include estimating and/or predicted downlink and uplink data traffic demand for the individual wireless base station being configured. The estimates and/or predictions are based on the received downlink and uplink traffic information for the individual wireless base station for a prior time interval (e.g., a first time interval). In some embodiments, the conditions further include: (i) the estimated and/or predicted signaling strength coverage level for the individual wireless base station which are based on the received signal strength coverage information (e.g., RSRP measurements) for the prior time interval for the individual wireless base station, and/or (ii) the estimated or predicted signaling interference level for the individual base station which is determined from and/or is based on the received signal interference information (e.g., SINR measurements) for the individual base station for the prior time interval.

Operation proceeds from step 2206 via connection node A 2222 to step 2224 shown on FIG. 22C.

In step 2224, the base station configuration management system generates base station configuration instructions for wireless base stations for which a base station configuration was determined. The base station configuration instructions include the determined frame configuration to be used by cells of the base station operating using the second frequency range. Operation proceeds from step 2224 to step 2226.

In step 2226, the base station configuration management system communicates the generated base station configuration instructions for the wireless base stations for which a base station configuration was determined to the wireless base station for which the base station configuration was determined. Operation proceeds from step 2226 to step 2228.

In step 2228, the wireless base stations to which the base station configuration instructions were communicated receive the communicated base station configuration instructions. Operation proceeds from step 2228 to step 2230.

In step 2230, the wireless base stations implement the received base station configuration instructions and confirm the implementation of the base station configuration instructions to the base station configuration management system. The implementation of the received base station configuration instructions occurring during a second time interval which follows or is after the prior time interval (e.g., first time interval) during which the downlink and uplink data traffic information, signaling strength coverage information and signaling interference information for the plurality of wireless base stations was obtained by UEs and wireless base stations of the wireless network system and communicated to and received by the base station configuration system in step 2204. Operation proceeds from step 2230 to step 2232.

In step 2232, the base station configuration management system monitors the wireless base station activity and/or conditions at wireless base stations of the wireless network system including at the first and second wireless base stations. Operation proceeds from step 2232 to step 2234.

In step 2234 the base station configuration management system receives data/information on the conditions at the plurality of wireless base stations of the wireless network system for the second interval of time including downlink and uplink data traffic information on a per base station bases, signaling strength coverage information (e.g., RSRP measurements) on a per base station bases, and signaling interference information (e.g., SINR measurements) on a per base station bases for the second time interval. The received downlink and uplink data traffic information including downlink and uplink data traffic information, signaling strength coverage information, and signaling interference information for the first wireless base station and the second wireless base station. In some embodiments, step 2234 is a sub-step of step 2232. Operation proceeds from step 2234 via connection node B 2236 to step 2206 where the steps of the method are repeated with the base station condition information provided for the second time interval. In this way the method 2200 provides for dynamically updating the configuration of wireless base station cells operating using the second frequency range of the TDD wireless network system. In various embodiments, system continues to maintain the configuration of wireless base station cells operating using first frequency range. The dynamic re-configuration of wireless cells operating using the second frequency range allows for configuring these cells to optimize use of the frequency spectrum available and fine tune the cells configuration for the conditions at the base station to which they belong. Because these cells coverage areas do not overlap with neighboring base station cells operating using the same frequency range, the re-configuration of the cells symbols per slot downlink and uplink configuration do not cause symbol interference problems. The use of the wireless base stations with two cells operating with different frequency ranges as shown in system 100 allows for the seamless network coverage using cells operating using the first frequency range while allowing for capacity to addressed via the cells of the base stations using second frequency range. The cells using the first frequency range are sometimes referred to as primary cells and the cells using the second frequency range are sometimes referred to second cells. With base stations of the wireless network system having a primary cell and a secondary cell. In some embodiments, one or more base stations of the wireless network system may only have a single cell which would be the primary cell operating using first frequency range. The first frequency range is the FR 1 range sometimes referred to as the sub-6 GHz range while the second frequency range is the FR 2 frequency range sometimes referred to as the mmWave range or >6 GHz range. The cells operate with assigned bandwidth (e.g., 100 MHz bandwidth) within the frequency range.

The steps of the method will continue to repeat with data being received for subsequent time intervals (e.g., after the second time interval, the method is repeated for a third time, etc.)

In some embodiments, prior to step 2206 the base station configuration system determines based on the received information about a base station's conditions how much resources (e.g., PRB) of the base station are being utilized (e.g., 75% of resources are being utilized) and based on the percentage of resources being utilized determines whether an updated base station frame configuration with different symbols per time slot configuration is required for the base station. For example, if more than a threshold level (e.g., 75%) of the base station resources are being used then operation proceeds to step 2206. In some embodiments, a similar determination is made in monitoring step 2232 and/or as part of step 2234. In such a system, the monitoring continues when the threshold level has not been exceeded until the threshold level of resources for the base station are being utilized for a time interval then steps for determining an updated base station frame configuration with different symbols per time slot configuration (e.g., number of symbols for downlink and uplink being adjusted to match the change in conditions at the base station (e.g., higher downlink than uplink data traffic demand).

FIG. 22 comprises FIG. 22A, FIG. 22B, and FIG. 22C. FIG. 22A is a first part of an exemplary method in accordance with an embodiment of the present invention. FIG. 22B is a second part of an exemplary method in accordance with an embodiment of the present invention. FIG. 22C is a third part of an exemplary method in accordance with an embodiment of the present invention.

FIG. 22 illustrates a high level flowchart of an exemplary method 2200 in accordance with an embodiment of the present invention. While it will be readily understood that additional steps are performed in connection with communicating information, messages, and packets between devices, the method 2200 focuses on and discusses the steps for understanding the invention. The method 2200 will be discussed in connection with the exemplary system 100 but is not limited to being implemented on system 100 and can be implemented on other systems.

Method 2200 begins in start step 2202. operation proceeds from step 2202 to step 2204.

In step 2204, a base station configuration management system (e.g., base station configuration management system 103 of system 100, receives downlink and uplink data traffic information, signaling strength coverage information, and signaling interference information for a plurality of wireless base stations (e.g., BS 1 118, BS 2 124, BS 3 130, BS 4 136, BS 5 142, BS 6 148, BS N 154) of a Time Division Duplex (TDD) wireless network system (e.g., system 100) for a first period of time (e.g., 15 minute interval, hour interval, day interval, week interval, etc.).

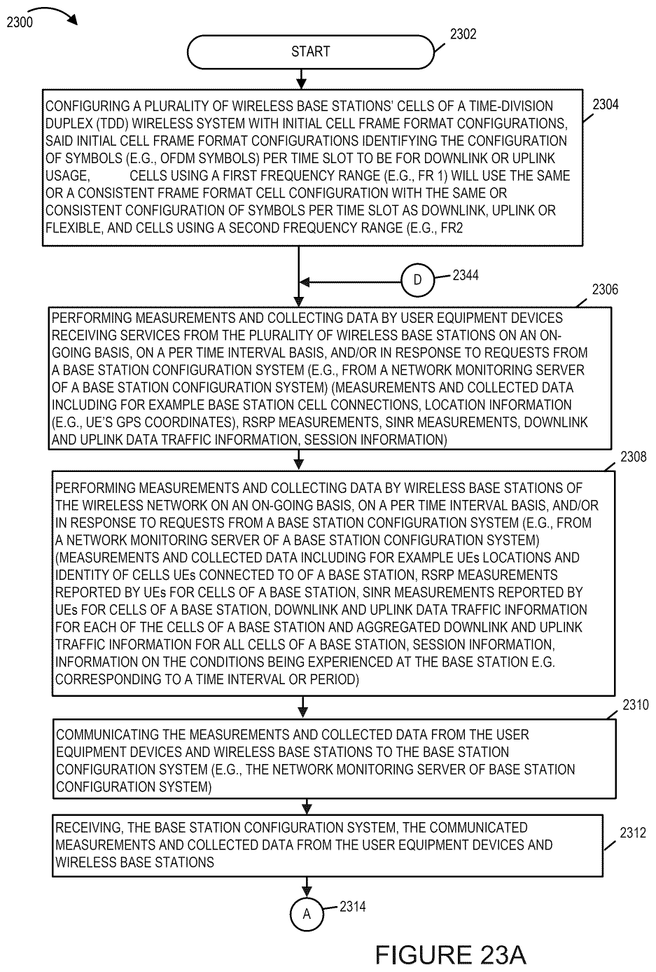

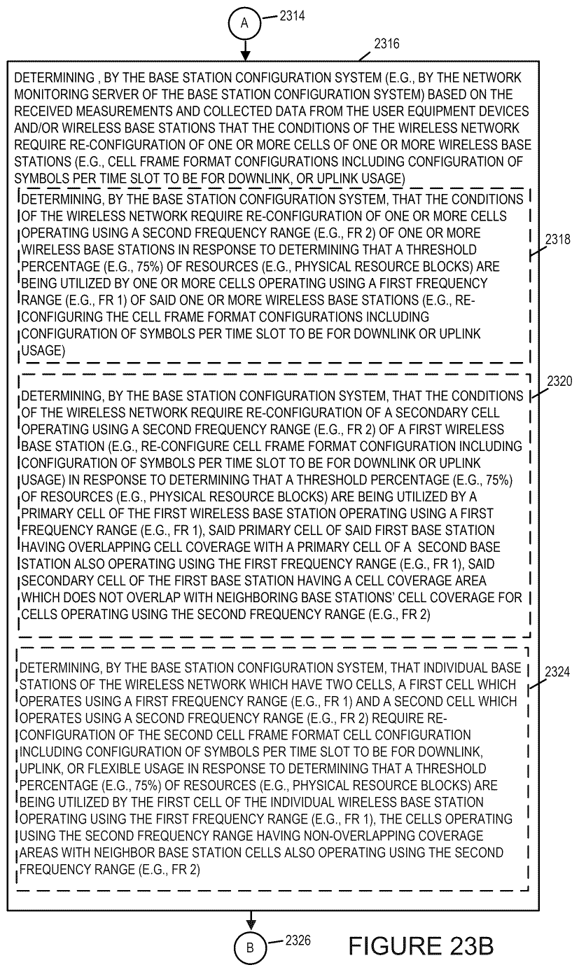

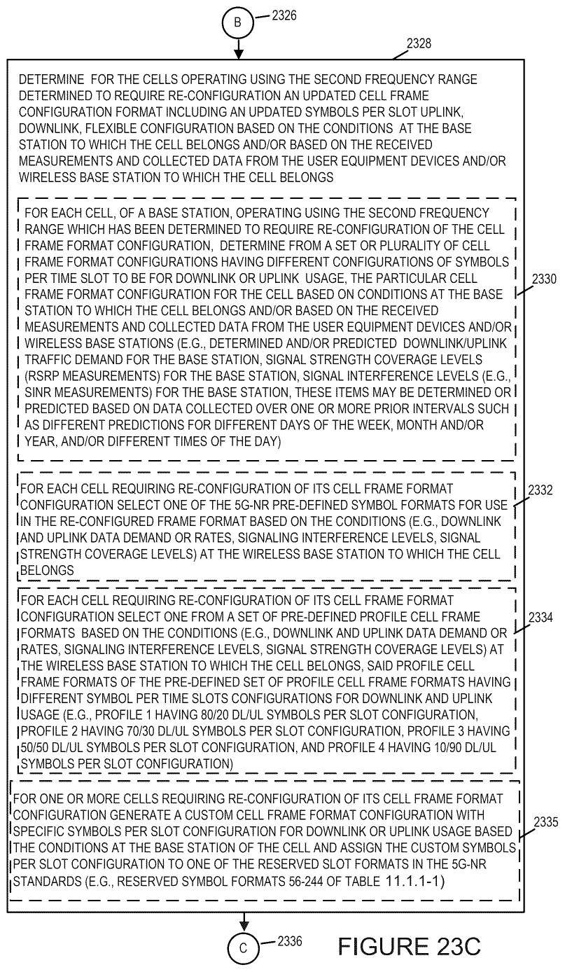

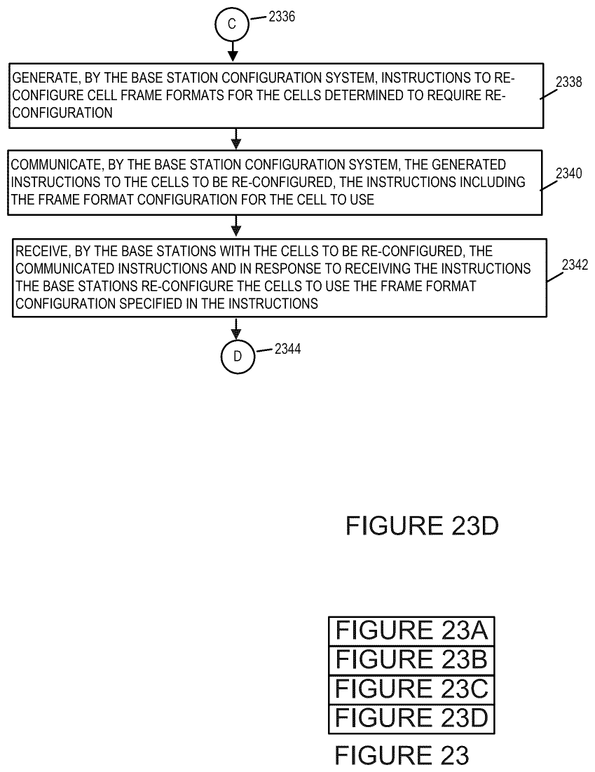

FIG. 23 comprises FIG. 23A, FIG. 23B, FIG. 23C and FIG. 23D. FIG. 23A is a first part of an exemplary method in accordance with an embodiment of the present invention. FIG. 23B is a second part of an exemplary method in accordance with an embodiment of the present invention. FIG. 23C is a third part of an exemplary method in accordance with an embodiment of the present invention. FIG. 23D is a fourth part of an exemplary method in accordance with an embodiment of the present invention.

FIG. 23 illustrates a high level flowchart of an exemplary method 2300 in accordance with an embodiment of the present invention. While it will be readily understood that additional steps are performed in connection with communicating information, messages, and packets between devices, the method 2300 focuses on and discusses the steps for understanding the invention. The method 2300 will be discussed in connection with the exemplary system 100 but is not limited to being implemented on system 100 and can be implemented on other systems.

Method 2300 begins in start step 2302 shown on FIG. 23A. operation proceeds from step 2302 to step 2304.

In step 2304, a plurality of wireless base stations' cells of a Time-Division Duplex (TDD) wireless system (e.g., system 100 of FIG. 1) are configured with initial cell frame format configurations. The initial cell frame format configurations identifying the configuration of symbols (e.g., OFDM symbols) per time slot be for downlink usage or uplink usage. Cells using a first frequency range (e.g., FR 1) being initially configured to use the same or a consistent cell frame format configuration with the same or consistent configuration of symbols per time slot as downlink or uplink (e.g., with 50% of symbols of a time slot being configured for downlink usage and 50% of symbols of a time slot being configured for uplink usage. Cells using a second frequency range (e.g., FR 2) being initially configured to use a cell frame format with 50% of symbols per time slot being configured for downlink usage and 50% being configured for uplink usage but not necessarily all cells having the same symbols per time slot arrangement. Operation proceeds from step 2304 to step 2306.

In step 2306, measurements are performed and data/information is collected by user equipment devices receiving wireless services from the plurality of wireless base stations on an on-going basis, on a per time interval basis, and/or in response to requests from a base station configuration system (e.g., from a network monitoring server 104 of a base station configuration management system 103 of system 100). The measurements and collected data including for example base station cell connections, location information (e.g., UE GPS coordinates), RSRP measurements, SINR measurements, downlink and uplink data traffic information, session information. In some embodiments, the information table 700 is collected wherein the base station ID is also supplemented with the cell Id so it identifies the base station and the particular cell of the base station (e.g., cell 1 of BS 1 operating using the FR 1 frequency range or cell 2 of BS 2 operating using the FR 2 frequency range). Operation proceeds from step 2306 to step 2308.

In step 2308, measurements are performed and data/information is collected by wireless base stations (e.g., BS 1, BS 2, BS 3, BS 4, BS 5, BS 6, BS N of system 100) of the wireless network system (e.g., system 100 of FIG. 1) on an on-going basis, on a per time interval basis, and/or in response to requests from a base station configuration system (e.g., from a network monitoring server 104 of a base station configuration management system 103 of system 100). The measurements and collected data including for example UE location information (e.g., UE GPS coordinates), identity of cells UEs are connected to of a base station, RSRP measurements reported by UEs for cells of a base station, SINR measurements reported by UEs for cells of a base station, downlink and uplink data traffic information for each of the cells of a base station and aggregated downlink and uplink traffic information for all cells of a base station, session information, information on the conditions being experienced at the base station (e.g., corresponding to a time interval or period). In some embodiments, the information table 700 is collected wherein the base station ID is also supplemented with the cell Id so it identifies the base station and the particular cell of the base station (e.g., cell 1 of BS 1 operating using the FR 1 frequency range or cell 2 of BS 2 operating using the FR 2 frequency range). Operation proceeds from step 2308 to step 2310.

In step 2310, the measurements and collected data from the user equipment devices and wireless base stations are communicated to the base station configuration system (e.g., the network monitoring system server of base station configuration system 103 of system 100 from which it is made available to the other servers of the base station configuration system 103). UEs in most embodiments communicate the measurements and collected to the base station configuration system via a base station. Operation proceeds from step 2310 to step 2312.

In step 2312, the base station configuration system (e.g., the network monitoring server of the base station configuration system) receives the communicated measurements and collected data from the user equipment devices and wireless base station. When the network monitoring server receives the measurements and data it makes the measurements and data available to the other servers of the base station configuration system. Operation proceeds from step 2312 via connection node A 2314 to step 2316 shown on FIG. 23B.

In step 2316, the base station configuration system determines based on the received measurements and collected data from the user equipment devices and/or wireless base stations that the conditions of the wireless network require re-configuration of one or more cells of one or more wireless network base stations (e.g., cell frame format configurations including configuration of symbols per time slot to be for downlink or uplink usage. In some embodiments, the network monitoring server performs step 2316. In some embodiments, step 2316 includes one or more sub-steps 2318, 2320, and 2324.

In sub-step 2318, the base station configuration system determines that the conditions of the wireless network require re-configuration of one or more cells operating using a second frequency range (e.g., FR 2) of one or more wireless base stations in response to determining that threshold percentage (e.g., 75%) of resources (e.g., Physical Block Resources (PRBs)) are being utilized by one or more cells operating using a first frequency range (e.g., FR 1) of said one or more wireless base stations (e.g., re-configuring the cell frame format configurations including configuration of symbols per time slot to be for downlink or uplink usage).

In sub-step 2320, the base station configuration system determines that the conditions of the wireless network require re-configuration of a secondary cell operating using a second frequency range (e.g., FR 2) of a first wireless base station (e.g., re-configure cell frame format configuration including configuration of symbols per time slot to be for downlink or uplink usage) in response to determining that a threshold percentage (e.g., 75%) of resources (e.g., physical resource blocks) are being utilized by a primary cell of the first wireless base station operating using a first frequency range (e.g., FR 1). The primary cell of said first base station having an overlapping cell coverage area with a primary cell of a second base station which is also operating using the first frequency range (e.g., FR 1). For example, cell coverage area 120 of wireless base station 1 118 overlapping with cell coverage area 126 of wireless base station 2 124 of system 100. The second cell of the first wireless base station having a cell coverage area which does not overlap with neighboring base stations' cell coverage areas for cells operating using the second frequency range (e.g., FR 2). For example, the BS 1 cell coverage area 122 does not overlap with neighboring base station cell coverage area 128 of BS 2 124, neighboring base station cell coverage area 134 of BS 3 130, neighboring base station cell coverage area 134 of BS 4 130 each of said cell coverage areas corresponding to a secondary cell of a base station operating in the secondary frequency range.

In sub-step 2324, the base station configuration system determines that individual base stations of the wireless network system which have two cells, a first cell which operates using a first frequency range (e.g., FR 1) and a second cell which operates using a second frequency range (e.g., FR 2) requires re-configuration of the second cell's frame format configuration including configuration of the symbols per time slot to be for downlink or uplink usage in response to determining that a threshold percentage (e.g., 75%) of resources (e.g., physical resource blocks) are being utilized by the first cell of the individual wireless base station operating using the first frequency range. The cells operating using the second frequency range having non-overlapping coverage areas with neighboring base station cells also operating using the second frequency range.

In some embodiments, the 75% threshold of resource utilization is applied to the entire base station as opposed to just the cells of a base station operating using the first frequency range. The 75% threshold lever of resource utilization is only exemplary and other threshold values may be, and in some embodiments are, used such as for example 70% or 80%. This threshold level may be in many embodiments is configurable and also may configured to be different for different wireless base stations (e.g., a base station with a first threshold number (e.g., 100) of reported UEs within its coverage area may utilize a lower threshold percentage for determining re-configuration than a base station with less than the first threshold number of UEs (e.g., 90 UEs) as the higher number of UEs may correlate with a potential higher traffic demand which may overload the base station's ability to provide services at particular Quality of Service). Operation proceeds from step 2316 via connection node 2326 to step 2328 shown on FIG. 23C.

In step 2328, the base station configuration system determines for the cells operating using the second frequency range determined to require re-configuration an updated cell frame configuration format including an updated symbols per time slot downlink and uplink configuration based on conditions at the base station to which the cell belongs and/or based on the received measurements and collected data from the user equipment devices and/or wireless base station to which the cell belongs. In some embodiments, a demand data calculator server (e.g., demand data calculator server 106 of system 100) of the base station configuration system determines downlink and uplink data demand conditions (e.g., estimated or predicted downlink and uplink data demand based on historical information) for a base station based on the measurements and data collected and reported to base station configuration system. In some embodiments, a coverage and interference review server (e.g., coverage and interference review server 110 of system 100) determines the signal strength coverage level conditions for a base station based on the reported RSRP measurements and collected data communicated to the base station configuration system. In some embodiments, this includes determining the distribution of the RSRP coverage for the base station. In some embodiments, this includes determining a RSRP value representative of the coverage area (e.g., RSRP mean value or a centroid value of a cluster of RSRP measurements which exclude outlier measurements having a value more than X standard deviations from the mean, X being an integer for example 2). In some embodiments, it includes determining whether the signal strength coverage level is above a threshold or below a threshold to determine whether the signal strength coverage level is good or poor. In some embodiments, the configuration estimator server and/or the configuration management server of the base station configuration system perform step 2328 or one or more of its sub-steps.

In some embodiments, a coverage and interference review server (e.g., coverage and interference review server 110 of system 100) determines the signal interference level conditions for a base station based on the reported SINR measurements and collected data communicated to the base station configuration system. In some embodiments, this includes determining the distribution of the SINR levels for the base station. In some embodiments, this includes determining a SINR value representative of the base station over its coverage area (e.g., SINR mean value or a centroid value of a cluster of SINR measurements which exclude outlier measurements having a value more than X standard deviations from the mean, X being an integer for example 2). In some embodiments, it includes determining whether the signal interference level is above a threshold or below a threshold to determine whether the signal interference level is good or poor. In some embodiments, percentage thresholds functions or routines are used to remove outliers of the data set when determining representative values for signal strength coverage levels and signal interference levels.

In some embodiments, step 2328 includes one or more sub-steps 2330, 2332, 2334, and 2335.

In sub-step 2330, for each cell, of a base station, operating using the second frequency range which has been determined to require re-configuration of the cell frame format configuration, determine from a set or plurality of cell frame format configurations having different configurations of symbols per time slot to be for downlink or uplink usage, the particular cell frame format configuration for the cell based on conditions at the base station to which the cell belongs and/or based on the received measurements and collected data from the user equipment devices and/or wireless base stations (e.g., determined and/or predicted downlink/uplink traffic demand for the base station, signal strength coverage levels (e.g., RSRP measurements) for the base station, signal interference levels (e.g., SINR measurements) for the base station. In some embodiments, these conditions are determined or predicted based on measurements and/or data collected over one or more prior time intervals or periods such as for example different predictions for different days of the week, month and/or year, and/or different times of the day.

In sub-step 2332, for each cell requiring re-configuration of its cell frame format configuration select one of the 5G NR pre-defined symbol formats for use in the re-configured frame format based on the conditions at the wireless base station to which the cell to be re-configured belongs. The conditions at the base station including for example, the downlink and uplink data demand or rates (e.g., calculated, estimated or predicted by the demand data calculator server 106 based on the received reported measurements and data), the signaling strength coverage levels determined by the coverage and interference review server 110 from the reported measurements and data, and the signaling interference levels determined by the coverage and interference review server from the reported measurements and data.

In sub-step 2334, for each cell requiring re-configuration of its cell frame format configuration select one from a set of pre-defined profile cell frame formats based on the conditions (e.g., downlink and uplink data demand or rates, signaling interference levels, signaling strength coverage levels) at the wireless base station to which the cell belongs. The profile cell frame formats of the pre-defined set of profile cell frame formats having different symbol per time slots configurations for downlink and uplink usage (e.g., profile 1 having 79/21 DL/UL symbols per slot configuration, profile 2 having 71/29 DL/UL symbols per slot configuration, profile 3 having 50/50 DL/UL symbols per slot configuration, profile 4 having 10/90 DL/UL symbols per slot configuration. The pre-defined profiles having been determined and defined by the base station configuration management system based on historical measurements and data collected for base stations of the wireless network and the base stations performance under various conditions and downlink and uplink symbol per slot configurations. The pre-defined profiles in various embodiments being a limited set of profiles to which base station conditions have been determined and mapped such as for example in table 1200 of FIG. 12, table 2000 of FIG. 20, and table 2100 of FIG. 21. Table 2400 of FIG. 24 illustrates potential profile DL/UL configuration of 5G NR system having 14 symbols per time slot. It should be further noted that further configuration parameters include which of the 14 symbols are configured for downlink usage and which are configured for uplink usage as shown and discussed in connection with table 400 shown in FIG. 4 and PRB 508 of FIG. 5 which shows the 14 different symbols per a time slot (e.g., symbols 0 to 6 can be configured for DL usage and symbols 7 to 14 for uplink usage for a first 50/50 downlink/uplink symbol configuration while for a second 50/50 downlink/uplink symbol configuration symbols 7 to 14 can be configured for DL usage and symbols 0 to 6 for uplink usage with various other permutations possible.) Symbols designated as F in the table 400 are flexible and be designated/used for downlink or uplink.

In sub-step 2335, for one or more cells requiring re-configuration of its cell frame format configuration generate a custom cell frame format configuration with specific symbols per slot configuration for downlink and uplink usage based on the conditions at the base station of the cell and assign the customer symbols per slot configuration format to one of the reserved slot formats in the 5G-NR standards (e.g., reserved symbols formats 56-244 of Table 11.1.1-1 of the 5G-NR 3GPP TS 38.213 V18.0.0 specification.

Operation proceeds from step 2328 via connection node C 2336 to step 2338 shown in FIG. 23D.

In step 2338, the base station configuration system generates instructions to re-configure cell frame formats for the cells determined to require re-configuration. In some embodiments, the network instructor server 114 of base station configuration management system 100 performs this step. Operation proceeds from step 2338 to step 2340.

In step 2340, the base station configuration system communicates the generated instructions to the cells to be re-configured. The instructions include the frame format configuration to be used by the cell for which the instructions where generated. In some embodiments, the network instructor server 114 of the base station configuration system communicates the generated instructions to the base stations to which the cells to be re-configured belong. In some embodiments, the configuration management server 116 of the base station configuration server communicate the instructions to the base stations to which the cells to be re-configured belong. Operation proceeds from step 2340 to step 2342.

In step 2342, the base stations which include the cells to be re-configured receive the communicated instructions and in response to receiving the communicated instructions re-configure the cells to use the frame format configuration specified in the instructions for the particular cell being re-configured. Operation proceeds from step 2342 via connection node D 2344 to step 2306 where the steps of the method are repeated. The method 2300 provides for dynamic re-configuration of base station cells' frame configuration and in particular the symbols per time slot configuration as downlink or uplink for base stations cells' with non-overlapping coverage areas (e.g., those base station cells of system 100 which have non-overlapping coverage areas operating using a second frequency range). The method 2300 also provides for a coverage layer throughout the wireless network system provided by the base stations cells of the wireless network operating using the first frequency range which have overlapping coverage areas. These cells have the same or a consistent frame configuration with the same configuration of symbols per time slot downlink and uplink usage designation so as to minimize interference. In most embodiments, the base station cells utilizing the first frequency range having a static frame configuration or when the frame configuration is changed it is changed for all of the cells using the first frequency range. The method 2300 provides for dynamic re-configuration of cells to increase the spectral efficiency of the base stations and increase the amount of uplink and downlink traffic that the base station can process by configuring base station cells for the predicted or estimated downlink and uplink traffic demand and the conditions at the base station which will affect the wireless transmission of data within the base station's coverage area (e.g., the signaling strength coverage and signaling interference levels). The re-configuration of cells of a base station allow for the cells operating using the first frequency range (e.g., primary cells) to overload traffic to cells of the same base station operating using the second frequency range (cells of the same base station operating in the first frequency range and second frequency range having overlapping coverage areas). In such instances, UEs remain connected to the same base station but switch from the primary cell to the secondary cell. This is possible because the UEs are dual frequency range devices which can operate in both the first frequency range and the second frequency range.

The methods 2200 and 2300 when implemented on system 100 provide system 100 with a coverage layer using a first frequency range such as the FR 1 range and a capacity layer using a second frequency range such as the FR 2 range. The bandwidth assigned to cells using the first frequency range typically comes from spectrum below 6 GHz and the bandwidth assigned to cells using the second frequency range come from the mmWave spectrum or spectrum above 6 GHz.

In various embodiments of the invention, the time intervals for which measurements and data is collected can be varied. For example, in some embodiments measurements and data are collected for base stations for a period of a month every 15 minutes. The data can be analyzed and estimates and/or predictions made with respect to traffic downlink and uplink demand and base station conditions for based on the collected measurements and data. For example, every work day between 7:00 a.m. and 9:00 a.m. various base stations along a highway may have heavy traffic while on the weekends the traffic is light. The base stations configurations can be re-configured based on the estimated and/or predicted traffic demand and/or conditions. While in other embodiments, the base stations can be re-configured based on the collected measurements and data from the preceding 15 minutes interval, 30 minute interval, 45 minute interval, or 60 minute interval, etc.

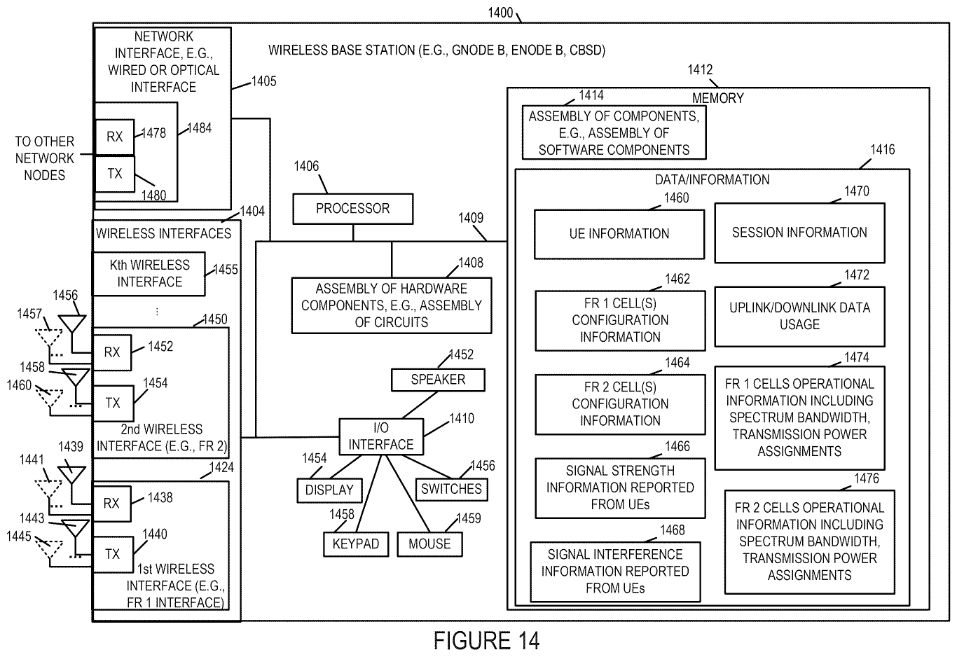

FIG. 14 is a drawing of an exemplary wireless base station 1400 in accordance with an exemplary embodiment. The wireless base station 1400 may be, and in some embodiments is an eNodeB, gNodeB, Citizens Broadband Radio Service Device (CBSD), or 5G NR base station 1400, in accordance with an exemplary embodiment. Exemplary wireless base station 1400 includes a wireless interfaces 1404, a network interface 1405, e.g., a wired or optical interface, a processor 1406, e.g., a CPU, an assembly of hardware components 1408, e.g., an assembly of circuits, and I/O interface 1410, and memory 1412 coupled together via a bus 1409 over which the various elements may interchange data and information. Wireless base station 1400 further includes a speaker 1452, a display 1454, switches 1456, keypad 1458 and mouse 1459 coupled to I/O interface 1410, via which the various I/O devices (1452, 1454, 1456, 1458, 1459) may communicate with other elements (1404, 1405, 1406, 1408, 1412) of the wireless base station 1400. Network interface 1405 includes a receiver 1478 and a transmitter 1480. In some embodiments, receiver 1478 and transmitter 1480 are part of a transceiver 1484. Wireless interfaces 1404 include a plurality of wireless interfaces including first wireless interface 1424 (e.g., an FR 1 wireless interface), second wireless interface 1450 (e.g., FR 2 wireless interface), . . . , Kth wireless interface 455, K being an integer greater than 2. The wireless interfaces are used to communicate with the wireless devices, e.g., user equipment device, e.g., Dual Frequency user equipment devices. The first wireless interface 1424 is used for example to communicate with a user equipment device using a first spectrum band (e.g., FR 1 spectrum band (e.g., a spectrum band below 6 GHz)). The second wireless interface can be used to communicate with a user equipment device using a second spectrum band (e.g., FR 2 spectrum band e.g., a spectrum band above 6 GHz). The first wireless interface 1424 includes wireless receiver 1438 and a wireless transmitter 1440. In some embodiments, receiver 1438 and transmitter 1440 are part of a transceiver. In various embodiments, the first wireless interface 1424 includes a plurality of wireless receivers and a plurality of wireless transmitters. Wireless receiver 1438 is coupled to a plurality of receive antennas (receive antenna 1 1439, . . . , receive antenna M 1441), via which wireless base station 1400 can receive wireless signals from other wireless communications devices including a second wireless communications device, e.g., a user equipment device. Wireless transmitter 1440 is coupled to a plurality of wireless transmit antennas (transmit antenna 1 1443, . . . , transmit antenna N 1445) via which the wireless base station 1400 can transmit signals to other wireless communications devices including a second wireless communications device, e.g., a user equipment device.

The second wireless interface 1450 includes wireless receiver 1452 and a wireless transmitter 1454. In some embodiments, receiver 1452 and transmitter 1454 are part of a transceiver. In various embodiments, the second wireless interface 1450 includes a plurality of wireless receivers and a plurality of wireless transmitters. Wireless receiver 1452 is coupled to one or more receive antennas (receive antenna 1 1456, . . . , receive antenna M 1457), via which wireless base station 1400 can receive wireless signals from other wireless communications devices including a second wireless communications device, e.g., a UE device, using the same or a different wireless protocol than the first wireless interface. Wireless transmitter 1454 is coupled to one or more wireless transmit antennas (transmit antenna 1 1458, . . . , transmit antenna N 1460) via which the wireless base station 1400 can transmit signals to other wireless communications devices including a second wireless communications device, e.g., UE device. The wireless base station network interface 1405 may be coupled to an OSS, network monitoring server, cable modem, a core network, other networks, e.g., internet, or other wireless base stations.

Memory 1412 includes an assembly of components 1414, e.g., an assembly of software components, and data/information 1416. Data/information 1416 includes UE information 1460, FR 1 cell(s) configuration information 1462 (e.g., symbols/slot downlink/uplink configuration information and/or slot symbol format information), FR 2 cell(s) configuration information 1464 (e.g., symbols/slot downlink/uplink configuration information and/or slot symbol format information), signal strength information (e.g., RSRP information) reported from UEs 1466, Signal interference information (e.g., SINR information) reported from UEs 1468, session information 1470 (e.g., session Id, time of session, location of UE during session, amount of uplink data and downlink data traffic consumed by the session, identity of the UE or UEs which were connected to the base station for the session, base station cell ID and whether it is a FR 1 or FR 2 cell), uplink and downlink data usage 1472 (e.g., amount of uplink and downlink wireless traffic and/or uplink and downlink traffic data rate for traffic the wireless base station provided services over a period of time and/or amount of uplink and downlink traffic per cell of the base station (e.g., FR 1 cell and FR 2 cell uplink and downlink traffic). In some embodiments, the UE information 1460 includes for the UEs in the base station's coverage: UE identification information, UE location information (e.g., UE GPS coordinates), UE device type information, UE category information, UE capabilities, UE session information such as session state information, session initiation request information, session type information, UE uplink and downlink traffic over a period of time or interval. The data/information 1416 also includes FR 1 cell(s) operational information including spectrum bandwidth and transmission power assignments 1474 and FR 2 cell(s) operational information including spectrum bandwidth and transmission power assignments 1476. The FR 1 cell operational information may specify a 20 MHz bandwidth in the 900 MHz band of FR 1. The FR 2 cell operational information may specify a 100 MHz band in the 37 GHz band (MM Wave Frequency Range 2).

While the details of the first and second wireless interfaces are shown, the other wireless interfaces of the wireless base station, e.g., wireless interface K where K is an integer greater than 2 also include multiple receivers and transmitters so that the wireless base station 1400 can provide wireless services to for example a plurality of wireless devices such as user equipment devices. In some embodiments, one or more of the wireless interfaces 1, 2, . . . , K can transmit and receive signals on two different frequency bands (e.g., the FR 1 and FR 2 frequency bands). In various embodiments, the base station 1400 in operation generates at least two cells (a FR 1 cell and a FR 2 cell) wherein the FR 2 cell does not have a coverage area that overlaps with any neighboring base station coverage area but does have a coverage area that overlaps with the FR 1 cell coverage of the same base station and the FR 1 cell coverage area of the wireless base station overlaps with an FR 1 coverage area of a neighboring base station. In some embodiments, one or more of the wireless base stations discussed and/or shown in the Figures and/or in connection with the methods discussed herein are implemented in accordance with the wireless base station 1400. For example, the base stations of system 100 of FIG. 1 are implemented in accordance with wireless base station 1400.

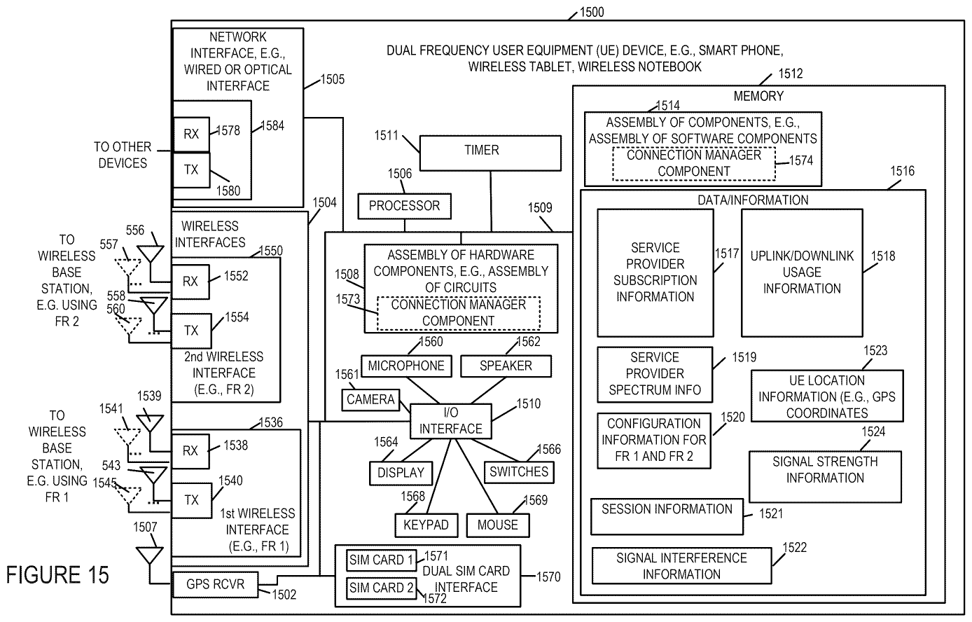

FIG. 15 is a drawing of an exemplary user equipment (UE) device 1500 in accordance with an exemplary embodiment. UE device 1500 is, e.g., a wireless device, e.g., a mobile device such as a cell phone, a smart phone, wireless tablet or wireless notebook. UE device 1500 is a dual frequency wireless device that is enabled to communicate using with a base station using two different wireless frequency spectrum ranges (e.g., FR 1 frequency band spectrum or FR 2 frequency band spectrum) and/or wireless protocols, e.g., 5G wireless protocol, CBRS wireless protocol or cellular wireless protocol. Exemplary UE device 1500 includes wireless interfaces 1504, a network interface 1505, a processor 1506, e.g., a CPU, an assembly of hardware components 1508, e.g., an assembly of circuits, and I/O interface 1510, a GPS receiver 1502 coupled to GPS receive antenna 1507, a timer 1511, e.g., a reference clock, a SIM card interface 1570 including a first SIM card, SIM card 1 1571, corresponding a first service provider, and an optional second SIM card, SIM card 2 1572 corresponding to a second service provider, and memory 1512 coupled together via a bus 1509 over which the various elements may interchange data and information. UE device 1500 further includes a microphone 1560, camera 1561, speaker 1562, a display 1564, e.g., a touch screen display, switches 1566, keypad 1568 and mouse 1569 coupled to I/O interface 1510, via which the various I/O devices (1560, 1561, 1562, 1564, 1566, 1568, 1569) may communicate with other elements (1502, 1504, 1505, 1506, 1508, 1512, 1570) of the UE device. Network interface 1505 includes a receiver 1578 and a transmitter 1580. The network interface 1505 can be coupled to routers within a home or a customer premises or to wired (e.g., cable) or optical (e.g., fiber-optic) networks. In some embodiments, receiver 1578 and transmitter 1580 are part of a transceiver 1584. In some embodiments, the assembly of hardware components 1508 includes a connection manager component 1573.

Wireless interfaces 1504 include a plurality of wireless interfaces including first wireless interface 1536 (e.g., a FR 1 wireless interface) and a second wireless interface 1550 (e.g., an FR 2 wireless interface). The first wireless interface 1536 is, e.g., used to communicate with a wireless base station, e.g., using a first range of spectrum (e.g., FR 1 frequency spectrum). The second wireless interface 1550 is, e.g., used to communicate with a wireless base station using a second range of spectrum (e.g., FR 2 frequency spectrum). The first wireless interface 1536 includes wireless receiver 1538 and a wireless transmitter 1540. In some embodiments, receiver 1538 and transmitter 1540 are part of a transceiver. In various embodiments, the first wireless interface 1536 includes a plurality of wireless receivers and a plurality of wireless transmitters. Wireless receiver 1538 is coupled to a plurality of receive antennas (receive antenna 1 1539, . . . , receive antenna M 1541), via which user equipment device 1500 can receive wireless signals from other wireless communications devices including a wireless base station, e.g., a 5G NR wireless base station. Wireless transmitter 1540 is coupled to a plurality of wireless transmit antennas (transmit antenna 1 1543, . . . , transmit antenna N 1545) via which the user equipment device 1500 can transmit signals to other wireless communications devices including a 5G NR wireless base station. The antennas 1539, . . . , 1541 and 1543, . . . , 1545 are typically mounted inside the housing of the wireless device but in some embodiments are located outside the user equipment device housing. In some embodiments the various antennas form an antenna array with the antennas pointing in different directions. In some embodiments, one or more of the antennas are included inside the housing of the user equipment device and the user equipment device includes one or more connections to which exterior antennas may be connected.

The second wireless interface 1550 includes wireless receiver 1552 and a wireless transmitter 1554. In some embodiments, receiver 1552 and transmitter 1554 are part of a transceiver. In various embodiments, the second wireless interface 1550 includes a plurality of wireless receivers and a plurality of wireless transmitters. Wireless receiver 1552 is coupled to one or more receive antennas (receive antenna 1 1556, . . . , receive antenna M 1557), via which user device 1500 can receive wireless signals from other wireless communications devices including, e.g. a 5G NR base station. Wireless transmitter 1554 is coupled to one or more wireless transmit antennas (transmit antenna 1 1558, . . . , transmit antenna N 1560) via which the user equipment device 1500 can transmit signals to other wireless communications devices including, e.g. a 5G NR wireless base station. The user equipment device network interface 1505 may be coupled to LAN or WAN networks or routers so that the user equipment device can also obtain services via a hardwired connection in addition to through the wireless interfaces, e.g. when the UE device 1500 is at a location where such a connection is possible. In some embodiments, one or more of the wireless interfaces 1536 and 1550 are capable of communicating using different spectrum frequency ranges (e.g., frequency in FR 1 spectrum range and/or frequency in FR 2 spectrum range).

Memory 1512 includes an assembly of components 1514, e.g., an assembly of software components, and data/information 1516. In some embodiments, the assembly of software components 1514 includes a connection manager component 1574 which determines to which base station and/or which cell (e.g., FR 1 cell or FR 2 cell) of a base station the user equipment device 1500 is to connect. Data/information 1516 includes service provider subscription information 1517, e.g. credentials and NAI realm information corresponding to a first service provider, and optional service provider 2 subscription information, e.g. credentials and NAI realm information corresponding to a second service provider. Data/information 1516 further includes Uplink/Downlink usage information 1518 (e.g., uplink and downlink data demand for sessions (e.g., within a time interval or period). Data/information 1516 further includes service provider spectrum information 1519 (e.g., FR 1 spectrum frequency band and FR 2 spectrum frequency band on which the service provider operates). Data/information 1516 further includes configuration information for communicating using FR 1 and FR 2 spectrum 1520 (e.g., frame, time slot, symbols/timeslot Downlink or Uplink configuration information, handover parameters, connection decision parameters). Data/information 1516 further includes session information 1521 (e.g., session ID information uplink and downlink data used for a session, location of UE for session), signal interference information 1522 (e.g., SNIR measurements), UE location information (e.g., GPS coordinates) 1523, and signal strength information 1524 (e.g., RSRP measurements).

In some embodiments, the user equipment devices discussed in the Figures and/or in connection with the embodiments of the present invention are implemented in accordance with user equipment device 1500. For example, UE 1 162, UE 2 164, UE 3 166, UE 4 168, UE 5 170, UE 6 172, UE 7 174, UE 8 176, UE 9 178, UE 10 180, UE 11 182, UE 12 184, UE 13 186, UE 14 188, . . . , UE X 190 of system 100 shown in FIG. 1 may be, and in some embodiments are, implemented in accordance with user equipment device 1500.

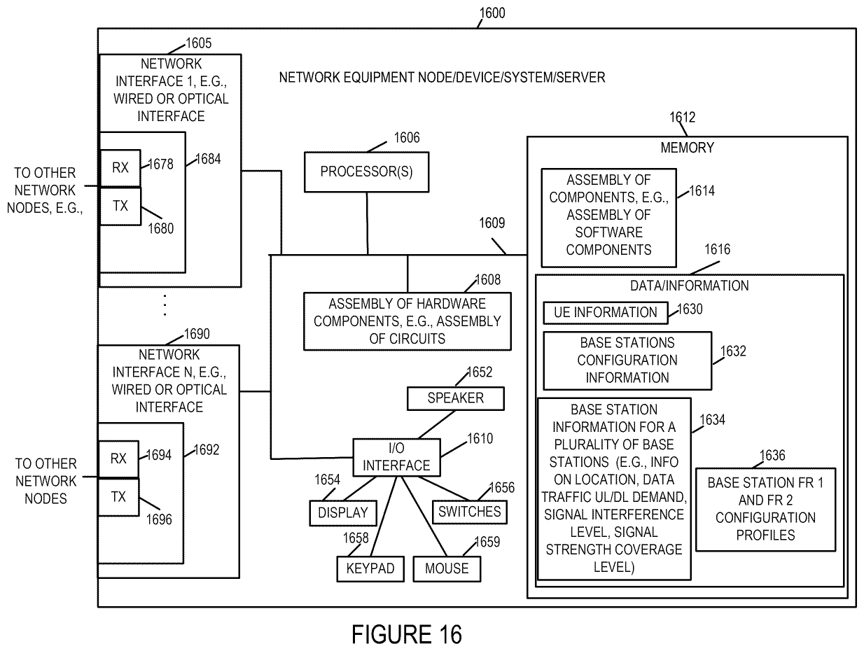

FIG. 16 is a drawing of an exemplary network equipment node, device, system, or server 1600 (e.g., an operations support system, base station configuration system, a base station configuration management system, a network monitoring device, a demand data calculator server, a user locations server, a coverage and interference review server, a configuration estimator server, a network instructor server 114, a configuration management server) in accordance with an exemplary embodiment. The network equipment node, device, system, or server 1600 will be referred to herein as a network equipment device. The network equipment device 1600 includes a plurality of network interfaces 1605, . . . , 1690, e.g., a wired or optical interface, a processor(s) 1606 (e.g., one or more processors), e.g., a CPU, an assembly of hardware components 1608, e.g., an assembly of circuits, and I/O interface 1610 and memory 1612 coupled together via a bus 1609 over which the various elements may interchange data and information. The network equipment device 1600 further includes a speaker 1652, a display 1654, switches 1656, keypad 1658 and mouse 1659 coupled to I/O interface 1610, via which the various I/O devices (1652, 1654, 1656, 1658, 1659) may communicate with other elements (1605, . . . , 1690, 1606, 1608, 1612) of the network equipment device 1600. Network interface 1605 includes a receiver 1678 and a transmitter 1680. The network interface 1605 is typically used to communicate with other devices, e.g., a wireless base station, core network equipment, network monitoring server, demand data calculator server, user locations server, coverage and interference review server, configuration estimator server, configuration management server. In some embodiments, receiver 1678 and transmitter 1680 are part of a transceiver 1684. Network interface 1690 includes a receiver 1694 and a transmitter 1696. The network interface 1690 is typically used to communicate with other devices, e.g., base stations, other network nodes, OSS, servers, systems or nodes, or equipment in the network core, etc. In some embodiments, receiver 1694 and transmitter 1696 are part of a transceiver 1692. Memory 1612 includes an assembly of component 1614, e.g., an assembly of software components, and data/information 1616. Data/information 1616 includes UE information 1630, configuration information for base stations 1632 (e.g., symbols/slot downlink/uplink parameter configuration, base station information for a plurality of base stations 1634 (e.g., information on location of the base station, data traffic uplink and downlink demand information for the base station, signal interference level information for the base station, signal strength coverage level information for the base station, signal interference distribution for the base station, signal strength distribution for the base station, user equipment location information for the base station), and base station FR 1 and FR 2 cell configuration profile information 1636 (e.g., FR 1 and FR 2 cell symbols/slot configuration and frame, slot, and modulation information).

The specific information included in data/information 1616 depends on the specific network equipment device implemented. For example, if the network equipment device 1600 is implemented as a user locations server the data/information 116 will include information on the specific locations of UEs in the coverage area of a wireless network and its movements while such information would not be included in data/information 1616 when the network equipment device 1600 is implemented a network instructor server. However, when the network equipment device 1600 is implemented as a network instructor server the data/information 1616 will include instructions to implement configuration changes for one or more base stations which would not be included in a user locations server data/information 1616 memory.

In some embodiments, the network equipment devices discussed in the Figures and/or in connection with the embodiments of the present invention described are implemented in accordance with network equipment device 600. For example, OSS 102, base station configuration management system 103, network monitoring server 104, the demand data calculator server 106, the user locations server 108, the coverage and interference review server 110, the configuration estimator server 112, the network instructor server 114, the configuration management server 116 in FIG. 1 may be, and in some embodiments are, implemented in accordance with the network equipment device 1600.

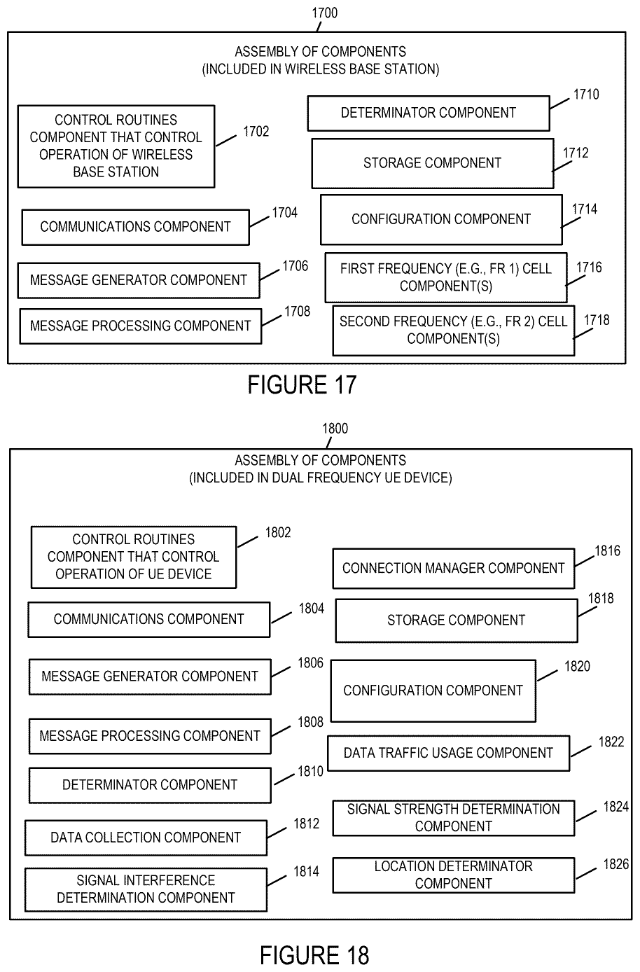

FIG. 17 is a drawing of an exemplary assembly of components 1700 which may be included in an exemplary wireless base station (e.g., exemplary wireless base station 1400 of FIG. 14), in accordance with an exemplary embodiment. The components in the assembly of components 1700 can, and in some embodiments are, implemented fully in hardware within a processor, e.g., processor 1406, e.g., as individual circuits. The components in the assembly of components 1700 can, and in some embodiments are, implemented fully in hardware within the assembly of hardware components 1408, e.g., as individual circuits corresponding to the different components. In other embodiments some of the components are implemented, e.g., as circuits, within processor 1406 with other components being implemented, e.g., as circuits within assembly of components 1408, external to and coupled to the processor 1406. As should be appreciated the level of integration of components on the processor and/or with some components being external to the processor may be one of design choice. Alternatively, rather than being implemented as circuits, all or some of the components may be implemented in software and stored in the memory 1412 of the wireless base station 1400, with the components controlling operation of wireless base station device 1400 to implement the functions corresponding to the components when the components are executed by a processor e.g., processor 1406. In some such embodiments, the assembly of components 1700 is included in the memory 1412 as assembly of software components 1414. In still other embodiments, various components in assembly of components 1700 are implemented as a combination of hardware and software, e.g., with another circuit external to the processor providing input to the processor which then under software control operates to perform a portion of a component's function.

When implemented in software the components include code, which when executed by a processor, e.g., processor 1406, configure the processor to implement the function corresponding to the component. In embodiments where the assembly of components 1700 is stored in the memory 1412, the memory 1412 is a computer program product comprising a computer readable medium comprising code, e.g., individual code for each component, for causing at least one computer, e.g., processor 406, to implement the functions to which the components correspond.

Completely hardware based or completely software based components may be used. However, it should be appreciated that any combination of software and hardware, e.g., circuit implemented components may be used to implement the functions. As should be appreciated, the components illustrated in FIG. 17 control and/or configure the wireless base station 1400 or elements therein such as the processor 1406, to perform the functions of corresponding steps illustrated and/or described in the method of one or more of the flowcharts, signaling diagrams and/or described with respect to any of the Figures. Thus the assembly of components 1700 includes various components that perform functions of corresponding one or more described and/or illustrated steps of an exemplary method.

Assembly of components 1700 includes a control routines component 1702, a communications component 1704, a message generator component 1706, a message processing component 1708, a determinator component 1710, and a storage component 1712, a configuration component 1714, a FR 1 cell(s) component 1716 and a FR 2 cell(s) component 1718.

The control routines component 1702 is configured to control operation of the wireless base station (e.g., gNodeB, eNodeB, or a CBSD).

The communication component 1704 is configured to handle communications, e.g., transmission and reception of messages, and protocol signaling for the wireless base station (e.g., communications with user equipment devices and components, functions, devices, and servers in its core network).

The message generator component 1706 is configured to generate messages for transmission to other devices, e.g., request messages, response messages, notification messages, messages for sharing information (such as for example, UE identification, location and session information, signal strength coverage information, signaling interference coverage information, downlink/uplink traffic demand information), communications messages with network equipment devices, and communications messages with user equipment devices (e.g., symbols/slot configuration information). In some embodiments, the message generator component 1706 is a sub-component of the communications component 1704.

The message processing component 1708 is configured to process messages received from other devices and implement operations in response to instructions and/or information included in the processed message, e.g., processing and implementing operations in connection with messages from user equipment devices, messages from network equipment devices/servers/OSS. In some embodiments, the message processing component 1708 is a sub-component of the communications component 1704.

The determinator component 1710 is configured to make determinations and decisions for the wireless base station including for example: determining what UE information (e.g., location information, session information, Uplink/Downlink data usage and/or demand, signal strength information, signal interference information) to communicate to the other devices (e.g., OSS or servers) and when to communicate the information (e.g., in compliance with a reporting schedule or at the expiration of time intervals or time periods) or in response to requests; determining signal strength information for the base stations coverage area and/or for each cell's coverage (e.g., from UE reported information); determining UE location information (e.g., from UE reported information); determining signal interference information (e.g., from UE reported information); determining Uplink and downlink traffic demand (e.g., by cell and/or location) over a time period or interval, determining aggregated uplink and downlink traffic demand for the entire base station over a time period or interval.

The storage component 1712 is configured to manage the storage, and retrieval of data and/or instructions to/and from memory, buffers in memory, hardware buffers and/or storage device coupled and/or connected to the wireless base station.

The configuration component 1714 is configured to manage the implementation of the base stations configuration including implementing configuration instructions (e.g., frame, sub-frame, modulation, slot and symbols/slot downlink/uplink configuration instructions received at the base station (e.g., from a network instructor server or a configuration manager server or the network core).

First frequency range (e.g., FR 1) cell component(s) 1716 is one or more cell components that are configured to provide wireless services using bandwidth from a first frequency range such as FR 1. The first cell of the base stations of the system 100 which operate using a first frequency range (e.g., FR 1) may be and in some embodiments are implemented as a first frequency cell component.

The second frequency range (e.g., FR 2) cell component(s) 1718 is one or more cell components that are configured to provide wireless services using a second frequency range such as FR 2. The second cell of the base stations of the system 100 which operate using a second frequency range (e.g., FR 2) may be and in some embodiments are implemented as a second frequency cell component.

FIG. 18 is a drawing of an exemplary assembly of components 1800 which may be included in an exemplary user equipment (UE) device, e.g., UE device 1500 of FIG. 15, in accordance with an exemplary embodiment. The components in the assembly of components 1800 can, and in some embodiments are, implemented fully in hardware within a processor, e.g., processor 1506, e.g., as individual circuits. The components in the assembly of components 1800 can, and in some embodiments are, implemented fully in hardware within the assembly of hardware components 1508, e.g., as individual circuits corresponding to the different components. In other embodiments some of the components are implemented, e.g., as circuits, within processor 1506 with other components being implemented, e.g., as circuits within assembly of components 1508, external to and coupled to the processor 1506. As should be appreciated the level of integration of components on the processor and/or with some components being external to the processor may be one of design choice. Alternatively, rather than being implemented as circuits, all or some of the components may be implemented in software and stored in the memory 1512 of the UE device 1500, with the components controlling operation of UE device 1500 to implement the functions corresponding to the components when the components are executed by a processor e.g., processor 1506. In some such embodiments, the assembly of components 1800 is included in the memory 1512 as assembly of software components 1514. In still other embodiments, various components in assembly of components 1800 are implemented as a combination of hardware and software, e.g., with another circuit external to the processor providing input to the processor which then under software control operates to perform a portion of a component's function. When implemented in software the components include code, which when executed by a processor, e.g., processor 1506, configure the processor to implement the function corresponding to the component. In embodiments where the assembly of components 800 is stored in the memory 1512, the memory 1512 is a computer program product comprising a computer readable medium comprising code, e.g., individual code for each component, for causing at least one computer, e.g., processor 1506, to implement the functions to which the components correspond.

Completely hardware based or completely software based components may be used. However, it should be appreciated that any combination of software and hardware, e.g., circuit implemented components may be used to implement the functions. As should be appreciated, the components illustrated in FIG. 18 control and/or configure the UE device 1500 or elements therein such as the processor 1506, to perform the functions of corresponding steps illustrated and/or described in the method of one or more of the flowcharts, signaling diagrams and/or described with respect to any of the Figures. Thus the assembly of components 1800 includes various components that perform functions of corresponding one or more described and/or illustrated steps of an exemplary method.

Assembly of components 1800 includes a control routines component 1802, a communications component 1804, a message generator component 1806, a message processing component 1808, a determinator component 1810, a data collection component 1812, a signal interference determination component 1814, a connection manager component 1816, a storage component 1818, a configuration component 1820, a data traffic usage component 1822, signal strength determination component 1824, location determinator component 1826.

The control routines component 1802 is configured to control operation of the UE. The communications component 1804 is configured to handle communications, e.g., receipt and transmission of signals and provide protocol signal processing for one or protocols for the UE.

The message generator component 1806 is configured to generate messages for transmission to wireless base stations (e.g., 5G NR base stations, CBSD devices, gNodeBs, eNodeBs) such as messages including request and response messages, etc. In some embodiments, the message generator component 1806 is a sub-component of the communications component 1804.

The message processing component 1808 processes received messages, e.g., requests for information. In some embodiments, the message processing component 1808 is a sub-component of the communications component 1804.

The determinator component 1810 makes determination for the user equipment devices such as for example, determining GPS coordinates for the UE, determining uplink and downlink data traffic demand, determining signaling interference levels, determining signaling strength levels, determining to report UE information (e.g., signaling strength, UE location, uplink and downlink traffic demand, signaling interference measurements) to the wireless base station to which it is connected.

The data collection component 1812 collects data (e.g., uplink and downlink traffic demand data, signaling interference data, signaling strength data, location data) to be reported to the base station, OSS, network monitoring server or another server or device.

The signaling interference component 1812 measures and/or determines signaling interference levels (e.g., SINR measurements) at various locations.

The connection manager component 1816 is configured to manage the communications between the user equipment device and one or more base stations (e.g., including coordinating the off-load and/or handoff of calls or sessions from one network to another network and/or handoffs between a FR 1 cell and a FR 2 cell of the same network).

The storage component 1818 is configured to perform all operations in storing and retrieving information (e.g., credential information, location information, signaling interference data, signaling strength data, uplink and downlink traffic demand data, UE location information, spectrum information, configuration information (e.g., symbols/slot UL/DL configuration information), transmission power level instructions, session information) from memory and/or storage devices (e.g., SIMs) located in the user equipment device.

The configuration component 1820 configures the user equipment device based on instructions received from the base station including configuration of symbols/slot uplink and downlink configuration for each cell of the base station.

The data traffic usage component 1822 is configured to determine uplink and downlink data traffic demand for the UE for a time interval or period and/or session.

The signal strength determination component 1824 determines the signal strength at various locations when connected to a base station for example by measuring Reference Signal Received Power signal received from a base station.

The location determinator component 1826 determines the location (e.g., GPS coordinates) of the user equipment device.

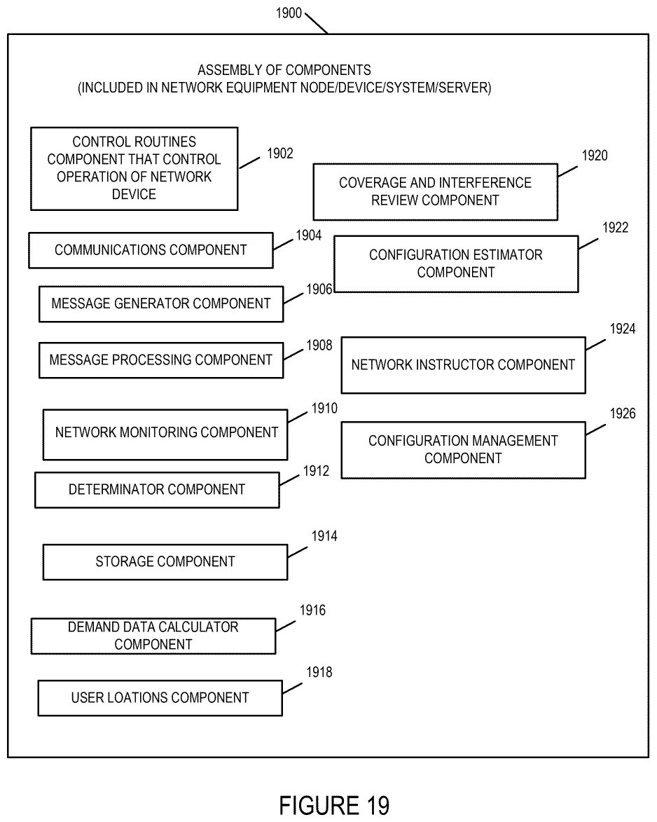

FIG. 19 is a drawing of an exemplary assembly of components 1900 which may be included in a network equipment device 1600 of FIG. 16, in accordance with an exemplary embodiment. The components in the assembly of components 1900 can, and in some embodiments are, implemented fully in hardware within a processor or one or more processors, e.g., processor(s) 1606, e.g., as individual circuits. The components in the assembly of components 1900 can, and in some embodiments are, implemented fully in hardware within the assembly of hardware components 1608, e.g., as individual circuits corresponding to the different components. In other embodiments some of the components are implemented, e.g., as circuits, within processor(s) 1606 with other components being implemented, e.g., as circuits within assembly of components 1608, external to and coupled to the processor(s) 1606. As should be appreciated the level of integration of components on the processor and/or with some components being external to the processor may be one of design choice. Alternatively, rather than being implemented as circuits, all or some of the components may be implemented in software and stored in the memory 1612 of the network equipment device 1600, with the components controlling operation of the network equipment device 1600 to implement the functions corresponding to the components when the components are executed by a processor e.g., processor 1606. In some such embodiments, the assembly of components 1900 is included in the memory 1612 as assembly of software components 1614. In still other embodiments, various components in assembly of components 1900 are implemented as a combination of hardware and software, e.g., with another circuit external to the processor providing input to the processor which then under software control operates to perform a portion of a component's function.

When implemented in software the components include code, which when executed by a processor or one or more processors, e.g., processor(s) 1606, configure the processor(s) to implement the function corresponding to the component. In embodiments where the assembly of components 1900 is stored in the memory 1612, the memory 1612 is a computer program product comprising a computer readable medium comprising code, e.g., individual code for each component, for causing at least one computer, e.g., processor 1606, to implement the functions to which the components correspond.

Completely hardware based or completely software based components may be used. However, it should be appreciated that any combination of software and hardware, e.g., circuit implemented components may be used to implement the functions. As should be appreciated, the components illustrated in FIG. 19 control and/or configure the network equipment device 1600 or elements therein such as the processor(s) 1606, to perform the functions of corresponding steps illustrated and/or described in the method of one or more of the flowcharts, signaling diagrams and/or described with respect to any of the Figures. Thus the assembly of components 1900 includes various components that perform functions of corresponding one or more described and/or illustrated steps of an exemplary method.

Assembly of components 1900 includes a control routines component 1902, a communications component 1904, a message generator component 1906, a message processing component 1908, a network monitoring component 1910, determinator component 1912, a storage component 1914, a demand data calculator component 1916, a user location component 1918, a coverage and interference component 1920, a network instructor component 1922, and a configuration management component 1924. The control routines component 1902 is configured to control operation of the network equipment device. The communication component 1904 is configured to handle communications, e.g., transmission and reception of messages, and protocol signaling for the network equipment device.

The message generator component 1906 is configured to generate messages for transmission to other devices. The message processing component 1908 is configured to process messages and implement procedures/operations in response to messages or based on the contents of messages. This includes messages received from other devices, e.g., messages from wireless base stations, core network.

The network monitoring component 1910 is configured to monitor the base stations of the network and receive information from the user equipment devices and base stations of the network and provide that information to other components and/or devices.

The determinator component 1912 is configured to make determinations and decisions for the network equipment device including for example determining which configuration profile to allocate to a base station based on estimated uplink and downlink data demand at the base station and signaling strength coverage levels and signaling interference levels of the base station.

The storage component 1914 is configured to manage the storage, and retrieval of data and/or instructions to/and from memory, and/or storage devices coupled and/or connected to the network equipment device.

The demand data calculator component 1916 is configured to determine and/or calculate the uplink and downlink data traffic demand for the wireless network/system including for each base station, the cells of each base station, the aggregation of uplink and downlink data traffic demand for all base stations, estimated traffic demands by data bins by base station and/or locations. The demand data calculator component 1916 is also configured to perform the operations described for the demand data calculator server 106 in connection with system 100.

The user locations component 1918 is configured to determine the location of the UE (e.g., GPS coordinates of the UE). The user locations component 1916 is also configured to perform the operations described for the user locations server 108 in connection with system 100.

The coverage and interference review component 1920 is configured to receive and process the signal strength information reported by the user equipment devices to determine base station signal strength coverage and signal strength coverage distribution for each of the base stations of the wireless network/system. The coverage and interference review component 1920 is also configured to receive and process the signal interference information reported by user equipment devices to determine base station signal interference levels and signal interference distribution for each of the base stations of the wireless network/system. The coverage and interference review component 1920 is also configured to perform the operations of the coverage and interference review server 110 of system 100.

The configuration estimator component 1922 is configured to determine how a base station is to be configured including symbols/slot uplink and downlink configuration. The configuration estimator component 1922 is also configured to determine which configuration profile a base station corresponds to. The configuration estimator component 1922 is also configured to perform the operations of the configuration estimator server 112 of system 100. In some embodiments, the configuration estimator component 1922 also generates a plurality of different base station configuration profiles based on the estimated uplink and downlink traffic demand, signal interference levels and signal strength levels reported by user equipment devices.

The network instructor component 1924 is configured to provide instructions on how one or more base stations are to be configured (e.g., symbols/slot uplink and downlink configurations for FR 2 cells). The network instructor component 1924 is also configured to perform the operations of the network instructor server 114 of system 100.

The configuration management component 1926 is configured to send instructions to configure a base station (e.g., symbols/slot uplink and downlink configuration for FR 2 cells) and confirm that the base station has updated its configuration per the instructions. The configuration management component 1926 is also configured to perform the operation of the configuration management server 116 of system 100.

The specific components of the assembly of components 1900 included in any particular network equipment device may, and typically does vary depending on the specific network equipment device and the functionality required for the device and/or the operations the network equipment device is responsible for performing.

In an exemplary embodiment, the base station configuration management system 103 of system 100, monitors and collects data on the conditions of the base stations of the base stations of system 100 including BS 1, BS 2, BS 3, BS 4, BS 5, BS 6, BS N. The data collected includes SINR signaling interference measurements and Reference Signal Received Power (RSRP) measurements made by the user equipment devices (e.g., UE 1, UE 2, UE 3, UE 4, UE 5, UE 6, UE 7, UE 8, UE 9, UE 10, UE 11, UE 12, UE 13, UE 14, . . . ) of the wireless network system 100 for each of the base stations. The data collected also includes traffic information including the amount of uplink and downlink traffic demand for each base station. The data is collected over a time period (e.g., 15 minute interval, hour interval, day interval, week, etc.) and analyzed by the base station configuration management system 103. The base station configuration management system 103 determines based on the reported data the conditions at the wireless base stations of the network and determines which base stations of network require base station cell re-configuration. The determination being made based on the determined conditions. In some embodiments, the determination is made based on the amount of wireless resources (e.g., PRBs) being consumed by the base station's first or primary cell operating using the first frequency range (e.g., FR 1) and/or the second or secondary cell operating using the second frequency range (e.g., FR 2). For example if the resource utilization exceeds a threshold amount (e.g., 75% of available resources), the base station configuration management system makes the determination that the base station second or secondary cell operating using the second frequency range is to be re-configured. In addition or alternatively, the downlink and uplink conditions at the base station can be evaluated and compared to the downlink and uplink frame configuration for the secondary or second cell of the base station. Based on the comparison a determination can be made as to whether the base station's secondary or second cell operating using the second frequency range is to be re-configured. For example if the base station downlink/uplink traffic demand is 80/20 but the base station second cell is configured for downlink/uplink traffic demand which greater than a percentage deviation such as a deviation of greater than 30% deviation than the base station configuration management system determines that the base station second cell is to be re-configured and when the DL/UL traffic demand ratio does not exceed a 30% deviation than a determination is made that no re-configuration is required. For example, with a DL/UL ratio of 50/50 determined as the condition at the base station and configuration for the second cell of the base station being 10/90 DL/UL, the base station configuration management system 103 compares the DL/UL ratios and determines that there is a deviation between the configured DL/UL ratio and the determined DL/UL ratio which exceeds 30% and thus the second cell of the base station should be configured. The base station configuration management system 103, will then chose a symbol format from the table 400 which provides a 50/50 DL/UL symbols per time slot configuration in which 7 of the 14 symbols of the time slot are defined for downlink and 7 symbols of the time slot are defined for uplink. If no such configuration exists, the format in the table with the closest DL/UL percentage to 50/50 will be selected. In some embodiments, a customized symbol configuration format will be defined and implemented as one of the reserved format in the 5G-NR standards, e.g., a format 56 can be customized to be defined as 50/50 DL/UL as previously discussed. The base station management system 103 generated instructions to implement the selected symbol configuration format (e.g., custom defined format 56 or one of the other formats of table 400) on the second cell operating using the second frequency range and communicates these instructions to the base station which implements the instructions. The base station second cell begins operating and communicating with UEs using the selected symbol per tune slot format including the symbol configuration (e.g., symbol configuration format 56 or one of the other formats of table 400). The format for these 14 OFDM symbols (e.g., format 56 or another format from table 400 such as format 46) is then used for the slots of the frame. The 12 different subcarriers of the PRB (as shown in FIG. 5) will each have the same symbol format configuration. As the symbol configuration for each time slot now has 50/50 distribution if the customized format 56 configuration is utilized then the base station cell 2 configuration will match the downlink and uplink traffic demand conditions determined for the base station and provide better utilization of the frequency spectrum allowing for additional capacity by freeing up resources (e.g., symbols of time slots which are designated for uplink but for which there is no uplink traffic).

In some embodiments, the use of the format 2 is used which has all 14 OFDM symbols which are defined as flexible F so that they can be dynamically changed to the correct downlink/uplink configuration to match base stations downlink/uplink data demand conditions. As signaling strength and signaling interference conditions also affect the ability to communication downlink and uplink wireless data between base stations and UEs and the rate at which the data can be communicated, these conditions at the base station are also in some embodiments taken into account when the base station configuration system determines the downlink/uplink data traffic demand for a base station and the how the base station's second cell should be configured. The first or primary cell of the base stations of the system 100 operate using the first frequency range as there cell coverage areas overlap there symbol configurations per time slot are static and not changed so as to avoid interference. Cells of system 100 using the first frequency range utilize a common or consistent symbol configuration format per time slot.

Various exemplary numbered embodiments illustrating different features of the present invention will now be discussed. The various features discussed may be used in variety of different combinations. It should be appreciated that not necessarily all embodiments include the same features and some of the features described below are not necessary but can be desirable in some embodiments. The numbered embodiments are only exemplary and are not meant to be limiting to the scope of the invention. The various method embodiments may be, and in some embodiments are, implemented on system 100 of FIG. 1.

### List of Exemplary Numbered Method Embodiments

Method Embodiment 1. A method comprising: receiving downlink and uplink data traffic information for a first wireless base station, said first wireless base station being one of a plurality of wireless base stations of a Time Division Duplex (TDD) wireless network, said first wireless base station including: a first wireless cell operating using a first frequency spectrum range (e.g., FR 1 frequency spectrum range) and a second wireless cell operating using a second frequency spectrum range (e.g., FR 2 frequency spectrum range), said plurality of wireless base stations of the wireless network including a second wireless base station, said second wireless base station having a third wireless cell operating using the first frequency spectrum range (e.g., FR 1 frequency spectrum range) and a fourth wireless cell operating using the second frequency spectrum range (e.g., FR 2 frequency spectrum range), said first wireless cell of the first wireless base station having a first wireless cell coverage area overlapping with a third wireless cell coverage area of the third wireless cell of the second wireless base station, said second wireless cell of the first wireless base station having a second wireless cell coverage area which does not overlap with a fourth cell coverage area of the fourth wireless cell of the second wireless base station; and determining a first base station configuration for the second cell of the first wireless base station based on the received downlink and uplink traffic information for the first wireless base station, said first base station configuration including a first set of frame configuration parameters.

Method Embodiment 2. The method of Method Embodiment 1, wherein the first set of frame configuration parameters define how many orthogonal frequency-division multiplexing (OFDM) symbols of a time slot of a frame are configured for downlink usage and how many OFDM symbols of the time slot of the frame are configured for uplink usage.

Method Embodiment 2A. The method of Method Embodiment 1, wherein the first set of frame configuration parameters define how many orthogonal frequency-division multiplexing (OFDM) symbols of a time slot of a frame are configured for downlink usage, how many OFDM symbols of the time slot of the frame are configured for uplink usage, and how many OFDM symbols of the time slot of the frame are configured for flexible usage.

Method Embodiment 2B. The method of Method Embodiment 2, wherein the first set of frame configuration parameters define how many orthogonal frequency-division multiplexing (OFDM) symbols of a time slot of a frame are configured for downlink usage and how many OFDM symbols of the time slot of the frame are configured for uplink usage; and wherein the ratio of the number of OFDM symbols of the time slot defined for downlink usage to the number of OFDM symbols of the time slot defined for uplink usage is equal to a ratio of downlink data traffic to uplink data traffic included in the downlink and uplink traffic information for the first base station.

Method Embodiment 2C. The method of Method Embodiment 2, wherein the first set of frame configuration parameters define how many orthogonal frequency-division multiplexing (OFDM) symbols of a time slot of a frame are configured for downlink usage and how many OFDM symbols of the time slot of the frame are configured for uplink usage; and wherein the ratio of the number of OFDM symbols of the time slot defined for downlink usage to the number of OFDM symbols of the time slot defined for uplink usage is within a threshold percentage (e.g., X %, where X is value such as 2, 5, or 10) of a ratio of downlink data traffic to uplink data traffic included in the downlink and uplink traffic information for the first base station.

Method Embodiment 3. The method of Method Embodiment 2, receiving downlink and uplink data traffic information for the second wireless base station; and determining a second base station configuration for the fourth cell of the second wireless base station based on the received downlink and uplink traffic information for the second wireless base station, said second base station configuration including a second set of frame configuration parameters, said second set of frame configuration parameters being different than said first set of frame configuration parameters.

Method Embodiment 4. The method of Method Embodiment 3, wherein the second set of frame configuration parameters define how many OFDM symbols of a time slot of a frame are configured for downlink usage and how many OFDM symbols of the time slot of the frame are configured for uplink usage; and wherein the number of OFDM symbols defined for uplink usage in a time slot for the second set of frame configuration parameters is different than the number of OFDM symbols defined for uplink usage in a time slot for the first set of frame configuration parameters.

Method Embodiment 4A. The method of Method Embodiment 3, wherein said determining a first base station configuration for the second cell of the first wireless base station based on the received downlink and uplink traffic information includes: determining an estimated downlink traffic demand for the first wireless base station based on the received downlink and uplink traffic information for the first wireless base station; determining an estimated uplink traffic demand for the first wireless base station based on the received downlink and uplink traffic information for the first wireless base station; determining how many OFDM symbols of the time slot of the frame are to be configured for uplink usage based on the estimated uplink traffic demand for the first wireless base station; and determining how many OFDM symbols of the time slot of the frame are to be configured for downlink usage based on the estimated downlink traffic demand for the first wireless base station.

Method Embodiment 4B. The method of Method Embodiment 4A, further comprising: receiving signal strength coverage information for first wireless base station; and wherein determining how many OFDM symbols of the time slot of the frame are to be configured for uplink usage is further based on the received signal strength coverage information for the first wireless base station; and wherein determining how many OFDM symbols of the time slot of the frame are to be configured for downlink usage is further based on the received signal strength coverage information for the first wireless base station.

Method Embodiment 4C. The method of Method Embodiment 4B, further comprising: receiving signal interference information for first wireless base station; and wherein determining how many OFDM symbols of the time slot of the frame are to be configured for uplink usage is further based on the received signal interference information for the first wireless base station; and wherein determining how many OFDM symbols of the time slot of the frame are to be configured for downlink usage is further based on the received signal interference information for the first wireless base station.

Method Embodiment 4D. The method of Method Embodiment 4C, wherein the received downlink and uplink traffic information is for a first time interval; wherein the received signal strength coverage information for the first wireless base station is for the first time interval; wherein the received signal interference information for the first wireless base station is for the first time interval; wherein said first set of frame configuration parameters is used by the first wireless base station during a second time interval, said second time interval occurring after said first time interval; and wherein the method further comprises: receiving downlink and uplink data traffic information for the first wireless base station for the second time interval; receiving signal strength coverage information for the first wireless base station for the second time interval; receiving signal interference information for the first wireless base station for the second time interval; dynamically determining an updated first base station configuration for the second cell of the first wireless base station based on: (i) said received downlink and uplink data traffic information for the first base station for the second time interval, (ii) said received signal strength coverage information for the first wireless base station for the second time interval, and (iii) said received signal interference information for the first wireless base station for the second time interval; sending instructions to the first wireless base station to dynamically re-configure to use the updated base station configuration for the second cell of the first wireless base station (e.g., during a third time interval occurring after said second time interval) ; and wherein said updated first base station configuration includes an updated set of frame configuration parameters, said updated set of frame configuration parameters re-defining how many orthogonal frequency-division multiplexing (OFDM) symbols of a time slot of a frame are configured for downlink usage and how many OFDM symbols of the time slot of the frame are configured for uplink usage.

Method Embodiment 4E. The method of Method Embodiment 4D, wherein the downlink and uplink data traffic information for the first wireless base station for the first time interval is generated by aggregating the downlink and uplink data traffic for all cells of the first wireless base station during the first time interval (e.g., the first base station download data demand for the first time interval is calculated by adding the downlink data demand of the first cell of the first wireless base station during the first time interval to the downlink data demand of the second cell of the first wireless base station during the first time interval, and the first base station uplink data demand for the first time interval is calculated by adding the uplink data demand of the first cell of the first wireless base station during the first time interval to the uplink data demand of the second cell of the first wireless base station during the first time interval); wherein the received signal strength coverage information for the first wireless base station for the first time interval includes signal strength coverage information for all cells of the first wireless base station during the first time interval (e.g., first cell of the first wireless base station signal strength coverage information for the first time interval and second cell of the first wireless base station signal strength coverage information for the first time interval); wherein the received signal interference information for the first wireless base station for the first time interval includes signal interference information for all cells of the first wireless base station (e.g., first cell of the first wireless base station signal interference information for the first time interval and second cell of the first wireless base station signal interference information for the first time interval); wherein the updated downlink and uplink data traffic information for the first wireless base station for the second time interval is generated by aggregating the downlink and uplink data traffic for all cells of the first wireless base station during the second time interval (e.g., the first base station download data demand for the second time interval is calculated by adding the downlink data demand of the first cell of the first wireless base station during the second time interval to the downlink data demand of the second cell of the first wireless base station during the second time interval, and the first base station uplink data demand for the second time interval is calculated by adding the uplink data demand of the first cell of the first wireless base station during the second time interval to the uplink data demand of the second cell of the first wireless base station during the second time interval); wherein the received updated signal strength coverage information for the first wireless base station for the second time interval includes signal strength coverage information for all cells of the first wireless base station during the second time interval (e.g., first cell of the first wireless base station signal strength coverage information for the second time interval and second cell of the first wireless base station signal strength coverage information for the second time interval); and wherein the received signal interference information for the first wireless base station for the second time interval includes signal interference information for all cells of the first wireless base station (e.g., first cell of the first wireless base station signal interference information for the second time interval and second cell of the first wireless base station signal interference information for the second time interval).

Method Embodiment 5. The method of Method Embodiment 3, wherein the second set of frame configuration parameters define how many OFDM symbols of a time slot of a frame are configured for downlink usage and how many OFDM symbols of the time slot of the frame are configured for uplink usage; and wherein the number of OFDM symbols defined for downlink usage in a time slot for the second set of frame configuration parameters is different than the number of OFDM symbols defined for downlink usage in a time slot for the first set of frame configuration parameters.

Method Embodiment 6. The method of Method Embodiment 1, wherein said determining a first base station configuration for the second cell of the first wireless base station based on the received downlink and uplink data traffic information for the first wireless base station includes: determining a first symbols per time slot format for time slots of frames used for wireless communications by the second cell of the first wireless base station; and wherein the first symbols per time slot format is different than a second symbols per time slot format used by the fourth cell of the second wireless base station.

Method Embodiment 7. The method of Method Embodiment 6, wherein the first cell of the first base station and the third cell of the second base station utilize a third symbols per time slot format.

Method Embodiment 8. The method of Method Embodiment 7, wherein the third symbols per time slot format is different than the first symbols per time slot format; and wherein the third symbols per time slot format is different than the second symbols per time slot format.

Method Embodiment 9. The method of Method Embodiment 1, wherein each of the plurality of wireless base stations of the TDD wireless network include at least one wireless cell operating using the first frequency range, each of said wireless cells of the TDD wireless network utilizing a symbols per time slot format for time slots of frames which is the same; and wherein two or more of the wireless base stations of the TDD wireless network include at least one wireless cell operating using the second frequency range, said wireless cells operating using the second frequency range having non-overlapping cell coverage.

Method Embodiment 10.The method of Method Embodiment 9, further comprising: determining a set of frame format base station configuration profiles, said set of frame format base station configuration profiles including a plurality of different frame format base station configuration profiles, each of said frame format base station configuration profiles having a different symbols per time slot uplink and downlink configuration; and determining which frame format base station configuration profile to utilize for each of the wireless cells of the wireless network operating using the second frequency range based on conditions at the wireless base station of the wireless cell operating in the second frequency range.

Method Embodiment 11. The method of Method Embodiment 10, wherein the conditions at the wireless base station of the wireless cell operating in the second frequency range include: (i) estimated downlink and uplink data traffic demand at the wireless base station, (ii) base station signal strength coverage levels, and (iii) base station signal interference levels.

Method Embodiment 12. The method of Method Embodiment 11, further comprising: receiving downlink and uplink data traffic demand for each of the plurality of wireless base stations from the wireless base stations for a first time interval; and determining an estimated downlink and uplink data traffic demand for a second time interval for wireless base stations having cells operating using the second frequency range based on the received downlink and uplink data traffic demand for the first time interval.

Method Embodiment 13. The method of Method Embodiment 11, wherein said base station signal strength coverage levels are Reference Signal Received Power (RSRP) measurements corresponding to a base station, said RSRP measurements being generated by user equipment devices in the coverage area of the base station to which the RSRP measurements correspond; and wherein said base station signal interference levels are Signal to Interference Noise Ratio (SINR) measurements corresponding to a base station, said SINR measurements being generated by user equipment devices in the coverage area of the base station to which the RSRP measurements correspond.

Method Embodiment 14. The method of Method Embodiment 13, further comprising: receiving RSRP measurements for each of the plurality of wireless base stations from the wireless base stations for the first time interval; determining signal strength coverage levels predicted for wireless base stations with cells operating using the second frequency range for the second time interval based on the received RSRP measurements for the first time interval; receiving SINR measurements for each of the plurality of wireless base stations for the first time interval; and determining predicted signal interference levels at wireless base stations with cells operating using the second frequency range for the second time interval based on the received SINR measurements for the first time interval; and wherein determining which frame format base station configuration profile to utilize for each of the wireless cells of the wireless network operating using the second frequency range based on conditions at the wireless base station of the wireless cell operating in the second frequency range includes: determining the frame format base station configuration profile to utilize for second time interval for each of the wireless cells of the network operating using the second frequency range based on: (i) the predicted downlink and uplink data traffic demand at the wireless base station for the second time interval, (ii) the predicted signal strength coverage level at the wireless base station for the second time interval, and (iii) the predicted signal interference levels at the wireless base station for the second time interval.

Method Embodiment 15. The method of Method Embodiment 1, wherein the first frequency range is Frequency Range 1 and includes frequency bands from 450 MHz to 6 GHz; and wherein the second frequency range is Frequency Range 2 and includes frequency bands from 24.25 GHz to 52.6 GHz.

Method Embodiment 16. The method of Method Embodiment 1, wherein the first frequency range is the sub-6 GHz frequency range; and wherein the second frequency range is the mmWave spectrum frequency range.

### List of Exemplary Numbered System Embodiments

System Embodiment 1. A base station configuration management system comprising: memory; and a first processor that controls the base station configuration management system to perform the following operations: receiving downlink and uplink data traffic information for a first wireless base station, said first wireless base station being one of a plurality of wireless base stations of a Time Division Duplex (TDD) wireless network, said first wireless base station including: a first wireless cell operating using a first frequency spectrum range (FR 1 frequency spectrum range) and a second wireless cell operating using a second frequency spectrum range (FR 2 frequency spectrum range), said plurality of wireless base stations of the wireless network including a second wireless base station, said second wireless base station having a third wireless cell operating using the first frequency spectrum range (FR 1 frequency spectrum range) and a fourth wireless cell operating using the second frequency spectrum range (FR 2 frequency spectrum range), said first wireless cell of the first wireless base station having a first wireless cell coverage area overlapping with a third wireless cell coverage area of the third wireless cell of the second wireless base station, said second wireless cell of the first wireless base station having a second wireless cell coverage area which does not overlap with a fourth cell coverage area of the fourth wireless cell of the second wireless base station; and determining a first base station configuration for the second cell of the first wireless base station based on the received downlink and uplink data traffic information for the first wireless base station, said first base station configuration including a first set of frame configuration parameters.

System Embodiment 2. The base station configuration management system of System Embodiment 1, wherein the first set of frame configuration parameters define how many orthogonal frequency-division multiplexing (OFDM) symbols of a time slot of a frame are configured for downlink usage and how many OFDM symbols of the time slot of the frame are configured for uplink usage.

System Embodiment 2A. The base station configuration management system of System Embodiment 1, wherein the first set of frame configuration parameters define how many orthogonal frequency-division multiplexing (OFDM) symbols of a time slot of a frame are configured for downlink usage, how many OFDM symbols of the time slot of the frame are configured for uplink usage, and how many OFDM symbols of the time slot of the frame are configured for flexible usage.

System Embodiment 2B. The base station configuration management system of System Embodiment 2, wherein the first set of frame configuration parameters define how many orthogonal frequency-division multiplexing (OFDM) symbols of a time slot of a frame are configured for downlink usage and how many OFDM symbols of the time slot of the frame are configured for uplink usage; and wherein the ratio of the number of OFDM symbols of the time slot defined for downlink usage to the number of OFDM symbols of the time slot defined for uplink usage is equal to a ratio of downlink data traffic to uplink data traffic included in the downlink and uplink data traffic information for the first base station.

System Embodiment 2C. The base station configuration management system of System Embodiment 2, wherein the first set of frame configuration parameters define how many orthogonal frequency-division multiplexing (OFDM) symbols of a time slot of a frame are configured for downlink usage and how many OFDM symbols of the time slot of the frame are configured for uplink usage; and wherein the ratio of the number of OFDM symbols of the time slot defined for downlink usage to the number of OFDM symbols of the time slot defined for uplink usage is within a threshold percentage (e.g., X %, where X is value such as 2, 5, or 10) of a ratio of downlink data traffic to uplink data traffic included in the downlink and uplink data traffic information for the first base station.

System Embodiment 3. The base station configuration management system of System Embodiment 2, wherein the first processor further controls the base station configuration management system to perform the following additional operations: receiving downlink and uplink data traffic information for the second wireless base station; and determining a second base station configuration for the fourth cell of the second wireless base station based on the received downlink and uplink data traffic information for the second wireless base station, said second base station configuration including a second set of frame configuration parameters, said second set of frame configuration parameters being different than said first set of frame configuration parameters.

System Embodiment 4. The base station configuration management system of System Embodiment 3, wherein the second set of frame configuration parameters define how many OFDM symbols of a time slot of a frame are configured for downlink usage and how many OFDM symbols of the time slot of the frame are configured for uplink usage; and wherein the number of OFDM symbols defined for uplink usage in a time slot for the second set of frame configuration parameters is different than the number of OFDM symbols defined for uplink usage in a time slot for the first set of frame configuration parameters.

System Embodiment 4A. The base station configuration management system of System Embodiment 3, wherein said determining a first base station configuration for the second cell of the first wireless base station based on the received downlink and uplink data traffic information includes: determining an estimated downlink traffic demand for the first wireless base station based on the received downlink and uplink data traffic information for the first wireless base station; determining an estimated uplink traffic demand for the first wireless base station based on the received downlink and uplink data traffic information for the first wireless base station; determining how many OFDM symbols of the time slot of the frame are to be configured for uplink usage based on the estimated uplink traffic demand for the first wireless base station; and determining how many OFDM symbols of the time slot of the frame are to be configured for downlink usage based on the estimated downlink traffic demand for the first wireless base station.

System Embodiment 4B. The base station configuration management system of System Embodiment 4A, wherein the first processor further controls the base station configuration management system to perform the following additional operations: receiving signal strength coverage information for first wireless base station; and wherein determining how many OFDM symbols of the time slot of the frame are to be configured for uplink usage is further based on the received signal strength coverage information for the first wireless base station; and wherein determining how many OFDM symbols of the time slot of the frame are to be configured for downlink usage is further based on the received signal strength coverage information for the first wireless base station.

System Embodiment 4C. The base station configuration management system of System Embodiment 4B, wherein the first processor further controls the base station configuration management system to perform the following additional operations: receiving signal interference information for first wireless base station; and wherein determining how many OFDM symbols of the time slot of the frame are to be configured for uplink usage is further based on the received signal interference information for the first wireless base station; and wherein determining how many OFDM symbols of the time slot of the frame are to be configured for downlink usage is further based on the received signal interference information for the first wireless base station.

System Embodiment 4D. The base station configuration management system of System Embodiment 4C, wherein the received downlink and uplink data traffic information is for a first time interval; wherein the received signal strength coverage information for the first wireless base station is for the first time interval; wherein the received signal interference information for the first wireless base station is for the first time interval; wherein said first set of frame configuration parameters is used by the first wireless base station during a second time interval, said second time interval occurring after said first time interval; and wherein the first processor further controls the base station configuration management system to perform the following additional operations: receiving downlink and uplink data traffic information for the first wireless base station for the second time interval; receiving signal strength coverage information for the first wireless base station for the second time interval; receiving signal interference information for the first wireless base station for the second time interval; dynamically determining an updated first base station configuration for the second cell of the first wireless base station based on: (i) said received downlink and uplink data traffic information for the first base station for the second time interval, (ii) said received signal strength coverage information for the first wireless base station for the second time interval, and (iii) said received signal interference information for the first wireless base station for the second time interval; sending instructions to the first wireless base station to dynamically re-configure to use the updated base station configuration for the second cell of the first wireless base station (e.g., during a third time interval occurring after said second time interval); and wherein said updated first base station configuration includes an updated set of frame configuration parameters, said updated set of frame configuration parameters re-defining how many orthogonal frequency-division multiplexing (OFDM) symbols of a time slot of a frame are configured for downlink usage and how many OFDM symbols of the time slot of the frame are configured for uplink usage.

System Embodiment 5. The base station configuration management system of System Embodiment 3, wherein the second set of frame configuration parameters define how many OFDM symbols of a time slot of a frame are configured for downlink usage and how many OFDM symbols of the time slot of the frame are configured for uplink usage; and wherein the number of OFDM symbols defined for downlink usage in a time slot for the second set of frame configuration parameters is different than the number of OFDM symbols defined for downlink usage in a time slot for the first set of frame configuration parameters.

System Embodiment 6. The base station configuration management system of System Embodiment 1, wherein said determining a first base station configuration for the second cell of the first wireless base station based on the received downlink and uplink data traffic information for the first wireless base station includes: determining a first symbols per time slot format for time slots of frames used for wireless communications by the second cell of the first wireless base station; and wherein the first symbols per time slot format is different than a second symbols per time slot format used by the fourth cell of the second wireless base station.

System Embodiment 7. The base station configuration management system of System Embodiment 6, wherein the first cell of the first base station and the third cell of the second base station utilize a third symbols per time slot format.

System Embodiment 8. The base station configuration management system of System Embodiment 7, wherein the third symbols per time slot format is different than the first symbols per time slot format; and wherein the third symbols per time slot format is different than the second symbols per time slot format.

System Embodiment 9. The base station configuration management system of System Embodiment 1, wherein each of the plurality of wireless base stations of the TDD wireless network include at least one wireless cell operating using the first frequency range, each of said wireless cells of the TDD wireless network utilizing a symbols per time slot format for time slots of frames which is the same; and wherein two or more of the wireless base stations of the TDD wireless network include at least one wireless cell operating using the second frequency range, said wireless cells operating using the second frequency range having non-overlapping cell coverage.

System Embodiment 10. The base station configuration management system of System Embodiment 9, wherein the first processor further controls the base station configuration management system to perform the following additional operations: determining a set of frame format base station configuration profiles, said set of frame format base station configuration profiles including a plurality of different frame format base station configuration profiles, each of said frame format base station configuration profiles having a different symbols per time slot uplink and downlink configuration; and determining which frame format base station configuration profile to utilize for each of the wireless cells of the wireless network operating using the second frequency range based on conditions at the wireless base station of the wireless cell operating in the second frequency range.

System Embodiment 11. The base station configuration management system of System Embodiment 10, wherein the conditions at the wireless base station of the wireless cell operating in the second frequency range include: (i) actual or estimated downlink and uplink data traffic demand at the wireless base station, (ii) base station signal strength coverage levels, and (iii) base station signal interference levels.

System Embodiment 12. The base station configuration management system of System Embodiment 11, wherein the first processor further controls the base station configuration management system to perform the following additional operations: receiving downlink and uplink data traffic demand for each of the plurality of wireless base stations from the wireless base stations for a first time interval; and determining an estimated downlink and uplink data traffic demand for a second time interval for wireless base stations having cells operating using the second frequency range based on the received downlink and uplink data traffic demand for the first time interval.

System Embodiment 13. The base station configuration management system of System Embodiment 11, wherein said base station signal strength coverage levels are Reference Signal Received Power (RSRP) measurements corresponding to a base station, said RSRP measurements being generated by user equipment devices in the coverage area of the base station to which the RSRP measurements correspond; and wherein said base station signal interference levels are Signal to Interference Noise Ratio (SINR) measurements corresponding to a base station, said SINR measurements being generated by user equipment devices in the coverage area of the base station to which the RSRP measurements correspond.

System Embodiment 14. The base station configuration management system of System Embodiment 13, receiving RSRP measurements for each of the plurality of wireless base stations from the wireless base stations for the first time interval; determining signal strength coverage levels predicted for wireless base stations with cells operating using the second frequency range for the second time interval based on the received RSRP measurements for the first time interval; receiving SINR measurements for each of the plurality of wireless base stations for the first time interval; and determining predicted signal interference levels at wireless base stations with cells operating using the second frequency range for the second time interval based on the received SINR measurements for the first time interval; and wherein determining which frame format base station configuration profile to utilize for each of the wireless cells of the wireless network operating using the second frequency range based on conditions at the wireless base station of the wireless cell operating in the second frequency range includes: determining the frame format base station configuration profile to utilize for second time interval for each of the wireless cells of the network operating using the second frequency range based on: (i) the predicted downlink and uplink data traffic demand at the wireless base station for the second time interval, (ii) the predicted signal strength coverage level at the wireless base station for the second time interval, and (iii) the predicted signal interference levels at the wireless base station for the second time interval.

System Embodiment 14. The base station configuration management system of System Embodiment 1, wherein the first frequency range is Frequency Range 1 and includes frequency bands from 450 MHz to 6 GHz; and wherein the second frequency range is Frequency Range 2 and includes frequency bands from 24.25 GHz to 52.6 GHz.

System Embodiment 15. The base station configuration management system of System Embodiment 1, wherein the first frequency range is the sub-6 GHz frequency range; and wherein the second frequency range is the mmWave spectrum frequency range.

System Embodiment 16. A wireless communications system including: a plurality of wireless base stations, said plurality of wireless base stations including a first wireless base station and a second wireless base, said first wireless base stations having a primary cell with a primary cell coverage area and a secondary cell with a secondary cell coverage area, said second wireless base station having a primary cell having a primary cell coverage area and a secondary cell having a secondary cell coverage area, said primary cell coverage area of the first base station primary cell overlapping with the primary cell coverage area of the second base station primary cell, said secondary cell coverage area of the secondary cell not overlapping with the secondary cell coverage area of the second base station secondary cell, said first base station primary cell and second base station primary cell both operating using a first frequency range (e.g., FR 1) and said first base station secondary cell and second base station secondary cell both operating using a second frequency range (e.g., FR 2); a plurality of dual frequency user equipment devices which operating using the first frequency range and the second frequency range; a base station configuration management device that includes memory and a processor, said processor controlling the base station configuration management device to perform the following operations: receive data from the user equipment devices and the plurality of base stations, said data providing information on the condition of the base stations of the wireless communications system for a first time interval; determining the condition of the first base station and the second base station from the received data for the first time interval; and determine a first symbols per time slot configuration for the first base station secondary cell based on the determined condition of the first base station for the first time interval; determine a second symbols per time slot configuration for the second base station secondary cell based on the determined conditions of the first base station for the first time interval, said first and second symbols per time slot configurations being different (e.g., different number of symbols configured for downlink and/or uplink usage); implementing, by the first base station secondary cell, the first symbols per time slot configuration; implementing, by the second base station secondary cell, the second symbols per time configuration.

System Embodiment 17. The system of System Embodiment 16, wherein the primary cells of the first and second base stations both use the same symbols per slot configuration.

System Embodiment 18. The system of System Embodiment 17, wherein the processor of the base station configuration management device controls the base station configuration management device to perform the following additional operations: receiving data from the user equipment devices and the plurality of base stations, said data providing information on the condition of the base stations of the wireless communications system for a second time interval, said second time interval occurring after the implementation by the first base station secondary cell of the first symbols per time slot configuration and after the implementation by the second base station secondary cell of the second symbols per time configuration; determining the condition of the first base station and the second base station from the received data for the second time interval; and dynamically determining a third symbols per time slot configuration for the first base station secondary cell based on the determined condition of the first base station for the second time interval; dynamically determining a fourth symbols per time slot configuration for the second base station secondary cell based on the determined conditions of the first base station for the second time interval; implementing, by the first base station secondary cell, the third symbols per time slot configuration; implementing, by the second base station secondary cell, the fourth symbols per time slot configuration.

System Embodiment 19. The system of System Embodiment 18, wherein the primary cells of the first and second base stations continue to both use the same symbols per slot configuration with which they were previously configured (i.e., there symbols per slot configuration remains static).

System Embodiment 20. The system of System Embodiment 18, wherein the data from the user equipment devices and the plurality of base stations for the first time interval includes downlink traffic information and uplink traffic information on a per base station basis for the first time interval, signaling strength coverage level measurements (e.g., RSRP measurements) on a per base station basis for the first time interval, and signaling interference level measurements (e.g., SINR measurements) on per base station basis for the first time interval, user equipment device location information for the first time interval, and user equipment uplink data usage and downlink data usage for the first time interval; and wherein the data from the user equipment devices and the plurality of base station for the second time interval includes the same type of data as for the first time interval.

### List of Exemplary Numbered Non-transitory Computer Readable Medium Embodiments

Non-transitory Computer Readable Medium Embodiment 1. A non-transitory computer readable medium including a first set of computer executable instructions which when executed by a processor of a base station configuration management system cause the base station configuration management system to perform the steps of: receiving downlink and uplink data traffic information for a first wireless base station, said first wireless base station being one of a plurality of wireless base stations of a Time Division Duplex (TDD) wireless network, said first wireless base station including: a first wireless cell operating using a first frequency spectrum range (e.g., FR 1 frequency spectrum range) and a second wireless cell operating using a second frequency spectrum range (e.g., FR 2 frequency spectrum range), said plurality of wireless base stations of the wireless network including a second wireless base station, said second wireless base station having a third wireless cell operating using the first frequency spectrum range (e.g., FR 1 frequency spectrum range) and a fourth wireless cell operating using the second frequency spectrum range (e.g., FR 2 frequency spectrum range), said first wireless cell of the first wireless base station having a first wireless cell coverage area overlapping with a third wireless cell coverage area of the third wireless cell of the second wireless base station, said second wireless cell of the first wireless base station having a second wireless cell coverage area which does not overlap with a fourth cell coverage area of the fourth wireless cell of the second wireless base station; and determining a first base station configuration for the second cell of the first wireless base station based on the received downlink and uplink data traffic information for the first wireless base station, said first base station configuration including a first set of frame configuration parameters.

Non-transitory Computer Readable Medium Embodiment 2. The non-transitory computer readable medium of Non-transitory Computer Readable Medium Embodiment 1, wherein the first set of frame configuration parameters define how many orthogonal frequency-division multiplexing (OFDM) symbols of a time slot of a frame are configured for downlink usage and how many OFDM symbols of the time slot of the frame are configured for uplink usage.

The techniques of various embodiments may be implemented using software, hardware and/or a combination of software and hardware. Various embodiments are directed to apparatus, e.g., wireless base stations, wireless devices, mobile terminals, network equipment, eNBs, gNBs, CBSDs, CBRS tower base stations, 5G New Radio-wireless base stations, smart devices, user equipment devices, user devices, computers, smartphones, subscriber devices, OSS, base station configuration management systems, network monitoring servers, demand data calculator server, user locations server, coverage and interference review server, configuration estimator server, network instructor server, configuration management server, servers, nodes, and/or elements. Various embodiments are also directed to methods, e.g., method of controlling and/or operating wireless base stations, wireless devices, mobile terminals, network equipment, eNBs, gNBs, CBSDs, CBRS tower base stations, 5G New Radio-wireless base stations, smart devices, user equipment devices, user devices, computers, smartphones, subscriber devices, OSS, base station configuration management systems, network monitoring servers, demand data calculator server, user locations server, coverage and interference review server, configuration estimator server, network instructor server, configuration management server, servers, nodes, and/or elements. Various embodiments are also directed to machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order, and are not meant to be limited to the specific order or hierarchy presented. In some embodiments, one or more processors are used to carry out one or more steps of the each of the described methods.

In various embodiments each of the steps or elements of a method are implemented using one or more processors. In some embodiments, each of elements or steps are implemented using hardware circuitry.

In various embodiments devices, e.g., wireless base stations, wireless devices, mobile terminals, network equipment, eNBs, gNBs, CBSDs, CBRS tower base stations, 5G New Radio-wireless base stations, smart devices, user equipment devices, user devices, computers, smartphones, subscriber devices, OSS, base station configuration management systems, network monitoring servers, demand data calculator server, user locations server, coverage and interference review server, configuration estimator server, network instructor server, configuration management server, servers, nodes, and/or elements described herein are implemented using one or more components to perform the steps corresponding to one or more methods, for example, generating or creating base station configurations, messages, connections, message reception, message transmission, switching modes, signal processing, sending, comparing, determining and/or transmission steps. Thus, in some embodiments various features are implemented using components or in some embodiments logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more devices, servers, nodes and/or elements. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a controller, including a processor configured to implement one, multiple or all of the steps of one or more methods of the invention.

In some embodiments, the processor or processors, e.g., CPUs, of one or more devices, e.g., wireless base stations, wireless devices, mobile terminals, network equipment, eNBs, gNBs, CBSDs, CBRS tower base stations, 5G New Radio-wireless base stations, smart devices, user equipment devices, user devices, computers, smartphones, subscriber devices, OSS, base station configuration management systems, network monitoring servers, demand data calculator server, user locations server, coverage and interference review server, configuration estimator server, network instructor server, configuration management server, servers, nodes, and/or elements. The configuration of the processor may be achieved by using one or more components, e.g., software components, to control processor configuration and/or by including hardware in the processor, e.g., hardware components, to perform the recited steps and/or control processor configuration. Accordingly, some but not all embodiments are directed to a device, e.g., wireless base stations, wireless devices, mobile terminals, network equipment, eNBs, gNBs, CBSDs, CBRS tower base stations, 5G New Radio-wireless base stations, smart devices, user equipment devices, user devices, computers, smartphones, subscriber devices, OSS, base station configuration management systems, network monitoring servers, demand data calculator server, user locations server, coverage and interference review server, configuration estimator server, network instructor server, configuration management server, servers, nodes, and/or elements, with a processor which includes a component corresponding to each of the steps of the various described methods performed by the device in which the processor is included. In some but not all embodiments a device, e.g., wireless base stations, wireless devices, mobile terminals, network equipment, eNBs, gNBs, CBSDs, CBRS tower base stations, 5G New Radio-wireless base stations, smart devices, user equipment devices, user devices, computers, smartphones, subscriber devices, OSS, base station configuration management systems, network monitoring servers, demand data calculator server, user locations server, coverage and interference review server, configuration estimator server, network instructor server, configuration management server, servers, nodes, and/or elements, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above. Depending on the embodiment, the computer program product can, and sometimes does, include different code for each step to be performed. Thus, the computer program product may, and sometimes does, include code for each individual step of a method, e.g., a method of controlling a device, e.g., wireless base stations, wireless devices, mobile terminals, network equipment, eNBs, gNBs, CBSDs, CBRS tower base stations, 5G New Radio-wireless base stations, smart devices, user equipment devices, user devices, computers, smartphones, subscriber devices, OSS, base station configuration management systems, network monitoring servers, demand data calculator server, user locations server, coverage and interference review server, configuration estimator server, network instructor server, configuration management server, servers, nodes, and/or elements. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device such as a wireless base stations, wireless devices, mobile terminals, network equipment, eNBs, gNBs, CBSDs, CBRS tower base stations, 5G New Radio-wireless base stations, smart devices, user equipment devices, user devices, computers, smartphones, subscriber devices, OSS, base station configuration management systems, network monitoring servers, demand data calculator server, user locations server, coverage and interference review server, configuration estimator server, network instructor server, configuration management server, servers, nodes, and/or elements or other device described in the present application.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A method comprising:
receiving downlink and uplink data traffic information for a first wireless base station, said first wireless base station being one of a plurality of wireless base stations of a Time Division Duplex (TDD) wireless network, said first wireless base station including: a first wireless cell operating using a first frequency spectrum range and a second wireless cell operating using a second frequency spectrum range, said plurality of wireless base stations of the wireless network including a second wireless base station, said second wireless base station having a third wireless cell operating using the first frequency spectrum range and a fourth wireless cell operating using the second frequency spectrum range, said first wireless cell of the first wireless base station having a first wireless cell coverage area overlapping with a third wireless cell coverage area of the third wireless cell of the second wireless base station, said second wireless cell of the first wireless base station having a second wireless cell coverage area which does not overlap with a fourth cell coverage area of the fourth wireless cell of the second wireless base station; and
determining a first base station configuration for the second cell of the first wireless base station based on the received downlink and uplink traffic information for the first wireless base station, said first base station configuration including a first set of frame configuration parameters.

2. The method of claim 1,
wherein the first set of frame configuration parameters define how many orthogonal frequency-division multiplexing (OFDM) symbols of a time slot of a frame are configured for downlink usage and how many OFDM symbols of the time slot of the frame are configured for uplink usage.

3. The method of claim 2,
receiving downlink and uplink data traffic information for the second wireless base station; and
determining a second base station configuration for the fourth cell of the second wireless base station based on the received downlink and uplink traffic information for the second wireless base station, said second base station configuration including a second set of frame configuration parameters, said second set of frame configuration parameters being different than said first set of frame configuration parameters.

4. The method of claim 3,
wherein the second set of frame configuration parameters define how many OFDM symbols of a time slot of a frame are configured for downlink usage and how many OFDM symbols of the time slot of the frame are configured for uplink usage; and
wherein the number of OFDM symbols defined for uplink usage in a time slot for the second set of frame configuration parameters is different than the number of OFDM symbols defined for uplink usage in a time slot for the first set of frame configuration parameters.

5. The method of claim 3,
wherein the second set of frame configuration parameters define how many OFDM symbols of a time slot of a frame are configured for downlink usage and how many OFDM symbols of the time slot of the frame are configured for uplink usage; and
wherein the number of OFDM symbols defined for downlink usage in a time slot for the second set of frame configuration parameters is different than the number of OFDM symbols defined for downlink usage in a time slot for the first set of frame configuration parameters.

6. The method of claim 1,
wherein said determining a first base station configuration for the second cell of the first wireless base station based on the received downlink and uplink data traffic information for the first wireless base station includes: determining a first symbols per time slot format for time slots of frames used for wireless communications by the second cell of the first wireless base station; and
wherein the first symbols per time slot format is different than a second symbols per time slot format used by the fourth cell of the second wireless base station.

7. The method of claim 6,
wherein the first cell of the first base station and the third cell of the second base station utilize a third symbols per time slot format.

8. The method of claim 7,
wherein the third symbols per time slot format is different than the first symbols per time slot format; and
wherein the third symbols per time slot format is different than the second symbols per time slot format.

9. The method of claim 1,
wherein each of the plurality of wireless base stations of the TDD wireless network include at least one wireless cell operating using the first frequency range, each of said wireless cells of the TDD wireless network utilizing a symbols per time slot format for time slots of frames which is the same; and
wherein two or more of the wireless base stations of the TDD wireless network include at least one wireless cell operating using the second frequency range, said wireless cells operating using the second frequency range having non-overlapping cell coverage.

10. The method of claim 9, further comprising:
determining a set of frame format base station configuration profiles, said set of frame format base station configuration profiles including a plurality of different frame format base station configuration profiles, each of said frame format base station configuration profiles having a different symbols per time slot uplink and downlink configuration; and
determining which frame format base station configuration profile to utilize for each of the wireless cells of the wireless network operating using the second frequency range based on conditions at the wireless base station of the wireless cell operating in the second frequency range.

11. The method of claim 10,
wherein the conditions at the wireless base station of the wireless cell operating in the second frequency range include: (i) estimated downlink and uplink data traffic demand at the wireless base station, (ii) base station signal strength coverage levels, and (iii) base station signal interference levels.

12. The method of claim 1,
wherein the first frequency range is Frequency Range 1 and includes frequency bands from 450 MHz to 6 GHz; and
wherein the second frequency range is Frequency Range 2 and includes frequency bands from 24.25 GHz to 52.6 GHz.

13. A base station configuration management system comprising:
memory; and
a first processor that controls the base station configuration management system to perform the following operations:
receiving downlink and uplink data traffic information for a first wireless base station, said first wireless base station being one of a plurality of wireless base stations of a Time Division Duplex (TDD) wireless network, said first wireless base station including: a first wireless cell operating using a first frequency spectrum range and a second wireless cell operating using a second frequency spectrum range, said plurality of wireless base stations of the wireless network including a second wireless base station, said second wireless base station having a third wireless cell operating using the first frequency spectrum range and a fourth wireless cell operating using the second frequency spectrum range, said first wireless cell of the first wireless base station having a first wireless cell coverage area overlapping with a third wireless cell coverage area of the third wireless cell of the second wireless base station, said second wireless cell of the first wireless base station having a second wireless cell coverage area which does not overlap with a fourth cell coverage area of the fourth wireless cell of the second wireless base station; and
determining a first base station configuration for the second cell of the first wireless base station based on the received downlink and uplink data traffic information for the first wireless base station, said first base station configuration including a first set of frame configuration parameters.

14. The base station configuration management system of claim 13,
wherein the first set of frame configuration parameters define how many orthogonal frequency-division multiplexing (OFDM) symbols of a time slot of a frame are configured for downlink usage and how many OFDM symbols of the time slot of the frame are configured for uplink usage.

15. The base station configuration management system of claim 14, wherein the first processor further controls the base station configuration management system to perform the following additional operations:
receiving downlink and uplink data traffic information for the second wireless base station; and
determining a second base station configuration for the fourth cell of the second wireless base station based on the received downlink and uplink data traffic information for the second wireless base station, said second base station configuration including a second set of frame configuration parameters, said second set of frame configuration parameters being different than said first set of frame configuration parameters.

16. The base station configuration management system of claim 15,
wherein the second set of frame configuration parameters define how many OFDM symbols of a time slot of a frame are configured for downlink usage and how many OFDM symbols of the time slot of the frame are configured for uplink usage; and
wherein the number of OFDM symbols defined for uplink usage in a time slot for the second set of frame configuration parameters is different than the number of OFDM symbols defined for uplink usage in a time slot for the first set of frame configuration parameters.

17. The base station configuration management system of claim 15,
wherein the second set of frame configuration parameters define how many OFDM symbols of a time slot of a frame are configured for downlink usage and how many OFDM symbols of the time slot of the frame are configured for uplink usage; and
wherein the number of OFDM symbols defined for downlink usage in a time slot for the second set of frame configuration parameters is different than the number of OFDM symbols defined for downlink usage in a time slot for the first set of frame configuration parameters.

18. The base station configuration management system of claim 13,
wherein said determining a first base station configuration for the second cell of the first wireless base station based on the received downlink and uplink data traffic information for the first wireless base station includes: determining a first symbols per time slot format for time slots of frames used for wireless communications by the second cell of the first wireless base station; and
wherein the first symbols per time slot format is different than a second symbols per time slot format used by the fourth cell of the second wireless base station.

19. The base station configuration management system of claim 13,
wherein each of the plurality of wireless base stations of the TDD wireless network include at least one wireless cell operating using the first frequency range, each of said wireless cells of the TDD wireless network utilizing a symbols per time slot format for time slots of frames which is the same; and
wherein two or more of the wireless base stations of the TDD wireless network include at least one wireless cell operating using the second frequency range, said wireless cells operating using the second frequency range having non-overlapping cell coverage.

20. A non-transitory computer readable medium including a first set of computer executable instructions which when executed by a processor of a base station configuration management system cause the base station configuration management system to perform the steps of:
receiving downlink and uplink data traffic information for a first wireless base station, said first wireless base station being one of a plurality of wireless base stations of a Time Division Duplex (TDD) wireless network, said first wireless base station including: a first wireless cell operating using a first frequency spectrum range and a second wireless cell operating using a second frequency spectrum range, said plurality of wireless base stations of the wireless network including a second wireless base station, said second wireless base station having a third wireless cell operating using the first frequency spectrum range and a fourth wireless cell operating using the second frequency spectrum range, said first wireless cell of the first wireless base station having a first wireless cell coverage area overlapping with a third wireless cell coverage area of the third wireless cell of the second wireless base station, said second wireless cell of the first wireless base station having a second wireless cell coverage area which does not overlap with a fourth cell coverage area of the fourth wireless cell of the second wireless base station; and
determining a first base station configuration for the second cell of the first wireless base station based on the received downlink and uplink data traffic information for the first wireless base station, said first base station configuration including a first set of frame configuration parameters.
